(19) United States
(12) Patent Application Publication
(10) Pub. No.: US 2026/0056030 A1
(43) Pub. Date: Feb. 26, 2026

(54) ROUTELESS AV DRIVING AND AUGMENTED DRIVABLE PATHS

(71) Applicant: Mobileye Vision Technologies Ltd., Jerusalem (IL)

(72) Inventors: Bnaya CASPI, Jerusalem (IL); Yoram GDALYAHU, Jerusalem (IL); Tal KIANI, Yehud-Monosson (IL)

(21) Appl. No.: 19/303,798

(22) Filed: Aug. 19, 2025

Related U.S. Application Data
(60) Provisional application No. 63/685,024, filed on Aug. 20, 2024.

(51) Int. Cl. G01C 21/00

(52) U.S. Cl. CPC G01C 21/3815; G01C 21/3841; G01C 21/3885

(57) ABSTRACT

In one implementation, a system generates a map for use in navigating a host vehicle relative to a road segment. The system may receive drive information from each of a plurality of vehicles that traversed the road segment. The system may aggregate indicators representative of road topography features and generate a representation of road topography of the road segment based on the aggregated indicators; provide the representation of road topography of the road segment as input to at least one trained model configured to generate, in response to the provided input, an output including a target trajectory for at least a first portion of the road segment; aggregate the actual trajectory information included in the drive information received from the plurality of vehicles that traversed the road segment; generate a crowdsourced trajectory for at least a second portion of the road segment based on the aggregated actual trajectory information; combine the target trajectory and the crowdsourced trajectory to generate a hybrid trajectory associated with the road segment; store the hybrid trajectory in the map; and provide the map to at least one host vehicle navigation system.

### CROSS-REFERENCE TO RELATED APPLICATION

This application claims the benefit of priority to U.S. Provisional Patent Application No. 63/685,024, filed on Aug. 20, 2024, the entire contents of which are incorporated herein by reference.

### BACKGROUND

### Technical Field

The present disclosure relates generally to vehicle navigation and, more specifically, to systems and methods for network generation of mapped drivable paths.

### Background Information

As technology continues to advance, the goal of a fully autonomous vehicle that is capable of navigating on roadways is on the horizon. Autonomous vehicles may need to take into account a variety of factors and make appropriate decisions based on those factors to safely and accurately reach an intended destination. For example, an autonomous vehicle may need to process and interpret visual information (e.g., information captured from a camera) and may also use information obtained from other sources (e.g., from a GPS device, a speed sensor, an accelerometer, a suspension sensor, etc.). At the same time, in order to navigate to a destination, an autonomous vehicle may also need to identify its location within a particular roadway (e.g., a specific lane within a multi-lane road), navigate alongside other vehicles, avoid obstacles and pedestrians, observe traffic signals and signs, and travel from one road to another road at appropriate intersections or interchanges. Harnessing and interpreting vast volumes of information collected by an autonomous vehicle as the vehicle travels to its destination poses a multitude of design challenges. The sheer quantity of data (e.g., captured image data, map data, GPS data, sensor data, etc.) that an autonomous vehicle may need to analyze, access, and/or store poses challenges that can in fact limit or even adversely affect autonomous navigation. Furthermore, if an autonomous vehicle relies on traditional mapping technology to navigate, the sheer volume of data needed to store and update the map poses daunting challenges.

### SUMMARY

Embodiments consistent with the present disclosure provide systems and methods for vehicle navigation.

In an embodiment, a system for generating map information for use in navigating a host vehicle relative to a road segment may include at least one processor comprising circuitry and a memory. The memory includes instructions that when executed by the circuitry cause the at least one processor to receive drive information from each of a plurality of vehicles that traversed a road segment. The drive information includes indicators representative of road topography features associated with the road segment. The indicators representative of road topography features are aggregated, and an image representation of road topography of the road segment based on the aggregated indicators is generated. The image representation of road topography of the road segment is provided as input to at least one trained model configured to generate, in response to the provided input, an output including at least one target trajectory for the road segment. The at least one target trajectory is stored in a map.

The map may be provided to at least one host vehicle navigation system for use in navigating the host vehicle relative to the at least one target trajectory of the road segment.

In an embodiment, a system is presented for generating a map for use in navigating a host vehicle relative to a road segment. The system may comprise at least one processor comprising circuitry and a memory. The memory may include instructions that when executed by the circuitry cause the at least one processor to identify an intersection between at least a first target trajectory and a second target trajectory associated with the road segment. At least a first exit trajectory and a second exit trajectory may extend from the intersection along respective directions of travel. The processor may also automatically determine which of the at least a first exit trajectory and the second exit trajectory represents a stand-on trajectory relative to the intersection between the at least a first target trajectory and the second target trajectory. The processor may also store in the map an identifier associated with the determined stand-on trajectory. Additionally, the processor may provide the map to at least one host vehicle navigation system for use in navigating the host vehicle along the road segment and relative to the intersection between the at least a first target trajectory and the second target trajectory.

In an embodiment, a navigation system is presented for navigating a host vehicle relative to a road segment. The system may comprise at least one processor comprising circuitry and a memory. The memory may include instructions that when executed by the circuitry cause the at least one processor to receive a map associated with the road segment. The map may include an intersection between at least a first target trajectory and a second target trajectory associated with the road segment. At least a first exit trajectory and a second exit trajectory may extend from the intersection along respective directions of travel, and wherein an identifier stored in the map designates one of the at least a first exit trajectory and the second exit trajectory as a stand-on trajectory. The processor may determine a navigational action for the host vehicle based on the stored identifier. The navigational action may be configured to cause the host vehicle to follow the stand-on trajectory after passing the intersection between the at least a first target trajectory and the second target trajectory. The processor may also implement the navigational action by causing at least one actuator associated with host vehicle to activate.

In an embodiment, a system for generating a map for use in navigating a host vehicle, is provided. The system is configured to receive drive information from each of a plurality of vehicles that traversed a road segment, wherein the drive information includes indicators representative of road topography features associated with the road segment, and wherein the drive information also includes actual trajectory information including one or more indicators of an actual trajectory traveled by one or more of the plurality of vehicles; aggregate the indicators representative of road topography features and generate a representation of road topography of the road segment based on the aggregated indicators; provide the representation of road topography of the road segment as input to at least one trained model configured to generate, in response to the provided input, an output including at a target trajectory for at least a first portion of the road segment; aggregate the actual trajectory information included in the drive information received from the plurality of vehicles that traversed the road segment; generate a crowdsourced trajectory for at least a second portion of the road segment based on the aggregated actual trajectory information; combine the target trajectory and the crowdsourced trajectory to generate a hybrid trajectory associated with the road segment; store the hybrid trajectory in the map; and provide the map to at least one host vehicle navigation system for use in navigating the host vehicle relative to the hybrid trajectory associated with the road segment.

The disclosed embodiments also include a system for generating a map for use in navigating a host vehicle relative to a road segment a host vehicle relative to a road segment. The system comprises: at least one processor comprising circuitry and a memory, wherein the memory includes instructions that when executed by the circuitry cause the at least one processor to: receive drive information from each of a plurality of vehicles that traversed a road segment, wherein the drive information includes indicators representative of road topography features associated with the road segment; aggregate the indicators representative of road topography features and generate a representation of road topography of the road segment based on the aggregated indicators; provide the representation of road topography of the road segment as input to at least one trained model configured to generate, in response to the provided input, an output including a target trajectory for the road segment; aggregate actual trajectory information included in the drive information received from each of the plurality of vehicles that traversed the road segment; generate a crowdsourced trajectory for the feature of road segment based on the aggregated actual trajectory information; store both the crowdsourced trajectory and target trajectory in in the map; and provide the map to at least one host vehicle navigation system for use in navigating the host vehicle relative to one or more of the target trajectory or the crowdsourced trajectory of the road segment.

The disclosed embodiments also include a navigation system for navigating a host vehicle relative to a road segment. The system comprises: at least one processor comprising circuitry and a memory, wherein the memory includes instructions that when executed by the circuitry cause the at least one processor to: receive a map associated with the road segment, wherein the map includes at least one target trajectory automatically generated based on analysis of at least one road topography feature associated with the road segment, and the map also includes at least one crowdsourced trajectory generated by aggregating actual trajectory information received from a plurality of vehicles that previously traversed the road segment; determine a navigational action for the host vehicle based on a combination of the at least one target trajectory and the at least one crowdsourced trajectory; and implement the navigational action by causing at least one actuator associated with host vehicle to activate.

Consistent with other disclosed embodiments, non-transitory computer readable storage media may store program instructions, which are executed by at least one processor and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 is a diagrammatic representation of an exemplary system consistent with the disclosed embodiments.

FIG. 2A is a diagrammatic side view representation of an exemplary vehicle including a system consistent with the disclosed embodiments.

FIG. 2B is a diagrammatic top view representation of the vehicle and system shown in FIG. 2A consistent with the disclosed embodiments.

FIG. 2C is a diagrammatic top view representation of another embodiment of a vehicle including a system consistent with the disclosed embodiments.

FIG. 2D is a diagrammatic top view representation of yet another embodiment of a vehicle including a system consistent with the disclosed embodiments.

FIG. 2E is a diagrammatic top view representation of yet another embodiment of a vehicle including a system consistent with the disclosed embodiments.

FIG. 2F is a diagrammatic representation of exemplary vehicle control systems consistent with the disclosed embodiments.

FIG. 3A is a diagrammatic representation of an interior of a vehicle including a rearview mirror and a user interface for a vehicle imaging system consistent with the disclosed embodiments.

FIG. 3B is an illustration of an example of a camera mount that is configured to be positioned behind a rearview mirror and against a vehicle windshield consistent with the disclosed embodiments.

FIG. 3C is an illustration of the camera mount shown in FIG. 3B from a different perspective consistent with the disclosed embodiments.

FIG. 3D is an illustration of an example of a camera mount that is configured to be positioned behind a rearview mirror and against a vehicle windshield consistent with the disclosed embodiments.

FIG. 4 is an exemplary block diagram of a memory configured to store instructions for performing one or more operations consistent with the disclosed embodiments.

FIG. 5A is a flowchart showing an exemplary process for causing one or more navigational responses based on monocular image analysis consistent with disclosed embodiments.

FIG. 5B is a flowchart showing an exemplary process for detecting one or more vehicles and/or pedestrians in a set of images consistent with the disclosed embodiments.

FIG. 5C is a flowchart showing an exemplary process for detecting road marks and/or lane geometry information in a set of images consistent with the disclosed embodiments.

FIG. 5D is a flowchart showing an exemplary process for detecting traffic lights in a set of images consistent with the disclosed embodiments.

FIG. 5E is a flowchart showing an exemplary process for causing one or more navigational responses based on a vehicle path consistent with the disclosed embodiments.

FIG. 5F is a flowchart showing an exemplary process for determining whether a leading vehicle is changing lanes consistent with the disclosed embodiments.

FIG. 6 is a flowchart showing an exemplary process for causing one or more navigational responses based on stereo image analysis consistent with the disclosed embodiments.

FIG. 7 is a flowchart showing an exemplary process for causing one or more navigational responses based on an analysis of three sets of images consistent with the disclosed embodiments.

FIG. 8 shows a sparse map for providing autonomous vehicle navigation, consistent with the disclosed embodiments.

FIG. 9A illustrates a polynomial representation of a portions of a road segment consistent with the disclosed embodiments.

FIG. 9B illustrates a curve in three-dimensional space representing a target trajectory of a vehicle, for a particular road segment, included in a sparse map consistent with the disclosed embodiments.

FIG. 10 illustrates example landmarks that may be included in sparse map consistent with the disclosed embodiments.

FIG. 11A shows polynomial representations of trajectories consistent with the disclosed embodiments.

FIGS. 11B and 11C show target trajectories along a multi-lane road consistent with disclosed embodiments.

FIG. 11D shows an example road signature profile consistent with disclosed embodiments.

FIG. 12 is a schematic illustration of a system that uses crowd sourcing data received from a plurality of vehicles for autonomous vehicle navigation, consistent with the disclosed embodiments.

FIG. 13 illustrates an example autonomous vehicle road navigation model represented by a plurality of three-dimensional splines, consistent with the disclosed embodiments.

FIG. 14 shows a map skeleton generated from combining location information from many drives, consistent with the disclosed embodiments.

FIG. 15 shows an example of a longitudinal alignment of two drives with example signs as landmarks, consistent with the disclosed embodiments.

FIG. 16 shows an example of a longitudinal alignment of many drives with an example sign as a landmark, consistent with the disclosed embodiments.

FIG. 17 is a schematic illustration of a system for generating drive data using a camera, a vehicle, and a server, consistent with the disclosed embodiments.

FIG. 18 is a schematic illustration of a system for crowdsourcing a sparse map, consistent with the disclosed embodiments.

FIG. 19 is a flowchart showing an exemplary process for generating a sparse map for autonomous vehicle navigation along a road segment, consistent with the disclosed embodiments.

FIG. 20 illustrates a block diagram of a server consistent with the disclosed embodiments.

FIG. 21 illustrates a block diagram of a memory consistent with the disclosed embodiments.

FIG. 22 illustrates a process of clustering vehicle trajectories associated with vehicles, consistent with the disclosed embodiments.

FIG. 23 illustrates a navigation system for a vehicle, which may be used for autonomous navigation, consistent with the disclosed embodiments.

FIGS. 24A, 24B, 24C, and 24D illustrate exemplary lane marks that may be detected consistent with the disclosed embodiments.

FIG. 24E shows exemplary mapped lane marks consistent with the disclosed embodiments.

FIG. 24F shows an exemplary anomaly associated with detecting a lane mark consistent with the disclosed embodiments.

FIG. 25A shows an exemplary image of a vehicle's surrounding environment for navigation based on the mapped lane marks consistent with the disclosed embodiments.

FIG. 25B illustrates a lateral localization correction of a vehicle based on mapped lane marks in a road navigation model consistent with the disclosed embodiments.

FIGS. 25C and 25D provide conceptual representations of a localization technique for locating a host vehicle along a target trajectory using mapped features included in a sparse map.

FIG. 26A is a flowchart showing an exemplary process for mapping a lane mark for use in autonomous vehicle navigation consistent with disclosed embodiments.

FIG. 26B is a flowchart showing an exemplary process for autonomously navigating a host vehicle along a road segment using mapped lane marks consistent with disclosed embodiments.

FIG. 27 is a flowchart showing a process for generating a target trajectory from indicators of road topography features, consistent with the disclosed embodiments.

FIG. 28A illustrates road topography features associated with a road segment for which a target trajectory is not available, consistent with the disclosed embodiments.

FIG. 28B illustrates at least one target trajectory based on indicators of road topography features, consistent with the disclosed embodiments.

FIG. 28C illustrates new road topography features associated with a road segment for which a target trajectory based on those features is not available, consistent with the disclosed embodiments.

FIG. 28D illustrates a target trajectory based on indicators of new road topography features associated with a road segment, consistent with the disclosed embodiments.

FIG. 29 depicts a block diagram for an exemplary process for providing target trajectories calculated from aggregated indicators to a host vehicle for navigation.

FIG. 30 is a flowchart of an exemplary process to provide a map for navigating a host vehicle through an intersection in a road segment.

FIG. 31 is a set of diagrams depicting illustrative intersection types that may occur along a road segment.

FIG. 32 is a block diagram of a process to enable a navigation system to navigate a host vehicle through one or more intersections.

FIG. 33 shows a flowchart illustrating a process of target trajectory generation, according to some embodiments.

FIG. 34A shows a flowchart summarizing an illustrative target trajectory refinement process, according to some embodiments.

FIG. 34B shows an example of refined target trajectory as described in FIG. 34A.

FIG. 35A shows a schematic diagram of outlining steps in creating of combined drive trajectory, according to some embodiments.

FIG. 35B shows the effect of illustrative weighting factors on the combined drive trajectory of a vehicle for a road segment.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

### Autonomous Vehicle (AV) Overview

As used throughout this disclosure, the term “autonomous vehicle” refers to a vehicle capable of implementing at least one navigational change without driver input. A “navigational change” refers to a change in one or more of steering, braking, or acceleration of the vehicle. To be autonomous, a vehicle need not be fully automatic (e.g., fully operation without a driver or without driver input). Rather, an autonomous vehicle includes those that can operate under driver control during certain time periods and without driver control during other time periods. Autonomous vehicles may also include vehicles that control only some aspects of vehicle navigation, such as steering (e.g., to maintain a vehicle course between vehicle lane constraints), but may leave other aspects to the driver (e.g., braking). In some cases, autonomous vehicles may handle some or all aspects of braking, speed control, and/or steering of the vehicle.

As human drivers typically rely on visual cues and observations to control a vehicle, transportation infrastructures are built accordingly, with lane markings, traffic signs, and traffic lights are all designed to provide visual information to drivers. In view of these design characteristics of transportation infrastructures, an autonomous vehicle may include a camera and a processing unit that analyzes visual information captured from the environment of the vehicle. The visual information may include, for example, components of the transportation infrastructure (e.g., lane markings, traffic signs, traffic lights, etc.) that are observable by drivers and other obstacles (e.g., other vehicles, pedestrians, debris, etc.). Additionally, an autonomous vehicle may also use stored information, such as information that provides a model of the vehicle's environment when navigating. For example, the vehicle may use GPS data, sensor data (e.g., from an accelerometer, a speed sensor, a suspension sensor, etc.), and/or other map data to provide information related to its environment while the vehicle is traveling, and the vehicle (as well as other vehicles) may use the information to localize itself on the model.

In some embodiments in this disclosure, an autonomous vehicle may use information obtained while navigating (e.g., from a camera, GPS device, an accelerometer, a speed sensor, a suspension sensor, etc.). In other embodiments, an autonomous vehicle may use information obtained from past navigations by the vehicle (or by other vehicles) while navigating. In yet other embodiments, an autonomous vehicle may use a combination of information obtained while navigating and information obtained from past navigations. The following sections provide an overview of a system consistent with the disclosed embodiments, followed by an overview of a forward-facing imaging system and methods consistent with the system. The sections that follow disclose systems and methods for constructing, using, and updating a sparse map for autonomous vehicle navigation.

### System Overview

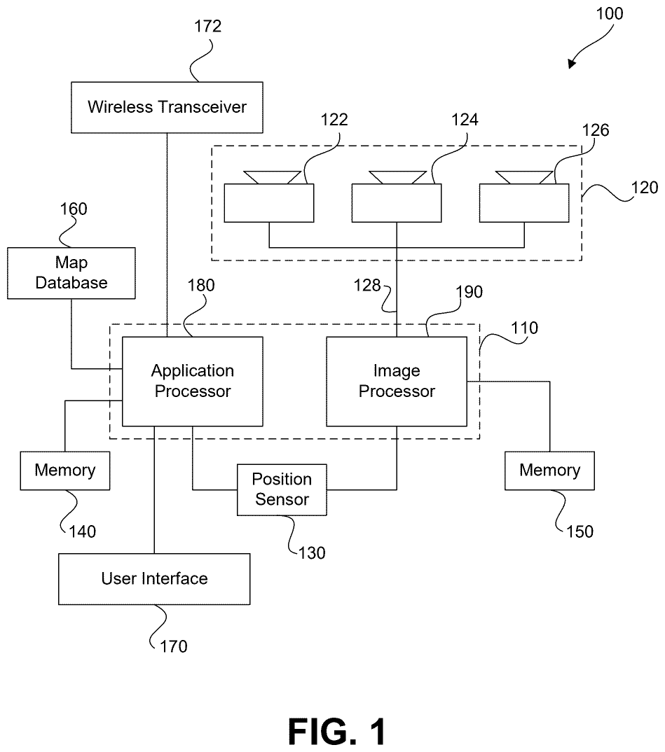

FIG. 1 is a block diagram representation of a system 100 consistent with the exemplary disclosed embodiments. System 100 may include various components depending on the requirements of a particular implementation. In some embodiments, system 100 may include a processing unit 110, an image acquisition unit 120, a position sensor 130, one or more memory units 140, 150, a map database 160, a user interface 170, and a wireless transceiver 172. Processing unit 110 may include one or more processing devices. In some embodiments, processing unit 110 may include an applications processor 180, an image processor 190, or any other suitable processing device. Similarly, image acquisition unit 120 may include any number of image acquisition devices and components depending on the requirements of a particular application. In some embodiments, image acquisition unit 120 may include one or more image capture devices (e.g., cameras), such as image capture device 122, image capture device 124, and image capture device 126. System 100 may also include a data interface 128 communicatively connecting processing device 110 to image acquisition device 120. For example, data interface 128 may include any wired and/or wireless link or links for transmitting image data acquired by image accusation device 120 to processing unit 110.

Wireless transceiver 172 may include one or more devices configured to exchange transmissions over an air interface to one or more networks (e.g., cellular, the Internet, etc.) by use of a radio frequency, infrared frequency, magnetic field, or an electric field. Wireless transceiver 172 may use any known standard to transmit and/or receive data (e.g., Wi-Fi, Bluetooth®, Bluetooth Smart, 802.15.4, ZigBee, etc.). Such transmissions can include communications from the host vehicle to one or more remotely located servers. Such transmissions may also include communications (one-way or two-way) between the host vehicle and one or more target vehicles in an environment of the host vehicle (e.g., to facilitate coordination of navigation of the host vehicle in view of or together with target vehicles in the environment of the host vehicle), or even a broadcast transmission to unspecified recipients in a vicinity of the transmitting vehicle.

Both applications processor 180 and image processor 190 may include various types of processing devices. For example, either or both of applications processor 180 and image processor 190 may include a microprocessor, preprocessors (such as an image preprocessor), a graphics processing unit (GPU), a central processing unit (CPU), support circuits, digital signal processors, integrated circuits, memory, or any other types of devices suitable for running applications and for image processing and analysis. In some embodiments, applications processor 180 and/or image processor 190 may include any type of single or multi-core processor, mobile device microcontroller, central processing unit, etc. Various processing devices may be used, including, for example, processors available from manufacturers such as Intel®, AMD®, etc., or GPUs available from manufacturers such as NVIDIA®, ATI®, etc. and may include various architectures (e.g., x86 processor, ARM®, etc.).

In some embodiments, applications processor 180 and/or image processor 190 may include any of the EyeQ series of processor chips available from Mobileye®. These processor designs each include multiple processing units with local memory and instruction sets. Such processors may include video inputs for receiving image data from multiple image sensors and may also include video out capabilities. In one example, the EyeQ2® uses 90 nm-micron technology operating at 332 Mhz. The EyeQ2® architecture consists of two floating point, hyper-thread 32-bit RISC CPUs (MIPS32® 34K® cores), five Vision Computing Engines (VCE), three Vector Microcode Processors (VMP®), Denali 64-bit Mobile DDR Controller, 128-bit internal Sonics Interconnect, dual 16-bit Video input and 18-bit Video output controllers, 16 channels DMA and several peripherals. The MIPS34K CPU manages the five VCEs, three VMP™ and the DMA, the second MIPS34K CPU and the multi-channel DMA as well as the other peripherals. The five VCEs, three VMP® and the MIPS34K CPU can perform intensive vision computations required by multi-function bundle applications. In another example, the EyeQ3®, which is a third generation processor and is six times more powerful that the EyeQ2®, may be used in the disclosed embodiments. In other examples, the EyeQ4® and/or the EyeQ5® may be used in the disclosed embodiments. Of course, any newer or future EyeQ processing devices may also be used together with the disclosed embodiments.

Any of the processing devices disclosed herein may be configured to perform certain functions. Configuring a processing device, such as any of the described EyeQ processors or other controller or microprocessor, to perform certain functions may include programming of computer executable instructions and making those instructions available to the processing device for execution during operation of the processing device. In some embodiments, configuring a processing device may include programming the processing device directly with architectural instructions. For example, processing devices such as field-programmable gate arrays (FPGAs), application-specific integrated circuits (ASICs), and the like may be configured using, for example, one or more hardware description languages (HDLs).

In other embodiments, configuring a processing device may include storing executable instructions on a memory that is accessible to the processing device during operation. For example, the processing device may access the memory to obtain and execute the stored instructions during operation. In either case, the processing device configured to perform the sensing, image analysis, and/or navigational functions disclosed herein represents a specialized hardware-based system in control of multiple hardware based components of a host vehicle.

While FIG. 1 depicts two separate processing devices included in processing unit 110, more or fewer processing devices may be used. For example, in some embodiments, a single processing device may be used to accomplish the tasks of applications processor 180 and image processor 190. In other embodiments, these tasks may be performed by more than two processing devices. Further, in some embodiments, system 100 may include one or more of processing unit 110 without including other components, such as image acquisition unit 120.

Processing unit 110 may comprise various types of devices. For example, processing unit 110 may include various devices, such as a controller, an image preprocessor, a central processing unit (CPU), a graphics processing unit (GPU), support circuits, digital signal processors, integrated circuits, memory, or any other types of devices for image processing and analysis. The image preprocessor may include a video processor for capturing, digitizing and processing the imagery from the image sensors. The CPU may comprise any number of microcontrollers or microprocessors. The GPU may also comprise any number of microcontrollers or microprocessors. The support circuits may be any number of circuits generally well known in the art, including cache, power supply, clock and input-output circuits. The memory may store software that, when executed by the processor, controls the operation of the system. The memory may include databases and image processing software. The memory may comprise any number of random access memories, read only memories, flash memories, disk drives, optical storage, tape storage, removable storage and other types of storage. In one instance, the memory may be separate from the processing unit 110. In another instance, the memory may be integrated into the processing unit 110.

Each memory 140, 150 may include software instructions that when executed by a processor (e.g., applications processor 180 and/or image processor 190), may control operation of various aspects of system 100. These memory units may include various databases and image processing software, as well as a trained system, such as a neural network, or a deep neural network, for example. The memory units may include random access memory (RAM), read only memory (ROM), flash memory, disk drives, optical storage, tape storage, removable storage and/or any other types of storage. In some embodiments, memory units 140, 150 may be separate from the applications processor 180 and/or image processor 190. In other embodiments, these memory units may be integrated into applications processor 180 and/or image processor 190.

Position sensor 130 may include any type of device suitable for determining a location associated with at least one component of system 100. In some embodiments, position sensor 130 may include a GPS receiver. Such receivers can determine a user position and velocity by processing signals broadcasted by global positioning system satellites. Position information from position sensor 130 may be made available to applications processor 180 and/or image processor 190.

In some embodiments, system 100 may include components such as a speed sensor (e.g., a tachometer, a speedometer) for measuring a speed of vehicle 200 and/or an accelerometer (either single axis or multiaxis) for measuring acceleration of vehicle 200.

User interface 170 may include any device suitable for providing information to or for receiving inputs from one or more users of system 100. In some embodiments, user interface 170 may include user input devices, including, for example, a touchscreen, microphone, keyboard, pointer devices, track wheels, cameras, knobs, buttons, etc. With such input devices, a user may be able to provide information inputs or commands to system 100 by typing instructions or information, providing voice commands, selecting menu options on a screen using buttons, pointers, or eye-tracking capabilities, or through any other suitable techniques for communicating information to system 100.

User interface 170 may be equipped with one or more processing devices configured to provide and receive information to or from a user and process that information for use by, for example, applications processor 180. In some embodiments, such processing devices may execute instructions for recognizing and tracking eye movements, receiving and interpreting voice commands, recognizing and interpreting touches and/or gestures made on a touchscreen, responding to keyboard entries or menu selections, etc. In some embodiments, user interface 170 may include a display, speaker, tactile device, and/or any other devices for providing output information to a user.

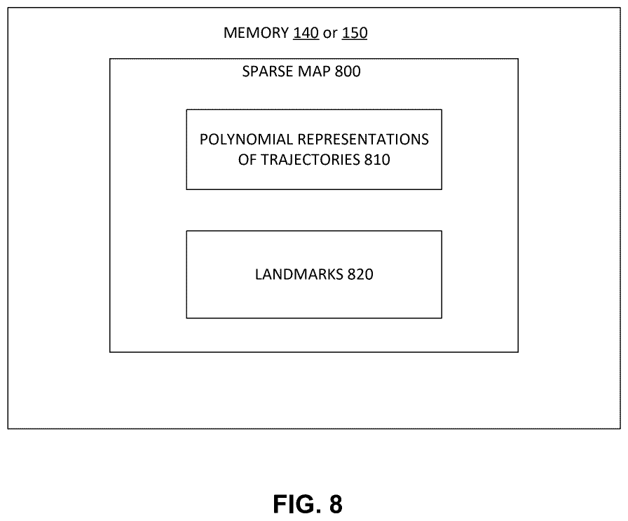

Map database 160 may include any type of database for storing map data useful to system 100. In some embodiments, map database 160 may include data relating to the position, in a reference coordinate system, of various items, including roads, water features, geographic features, businesses, points of interest, restaurants, gas stations, etc. Map database 160 may store not only the locations of such items, but also descriptors relating to those items, including, for example, names associated with any of the stored features. In some embodiments, map database 160 may be physically located with other components of system 100. Alternatively or additionally, map database 160 or a portion thereof may be located remotely with respect to other components of system 100 (e.g., processing unit 110). In such embodiments, information from map database 160 may be downloaded over a wired or wireless data connection to a network (e.g., over a cellular network and/or the Internet, etc.). In some cases, map database 160 may store a sparse data model including polynomial representations of certain road features (e.g., lane markings) or target trajectories for the host vehicle. Systems and methods of generating such a map are discussed below with references to FIGS. 8-19.

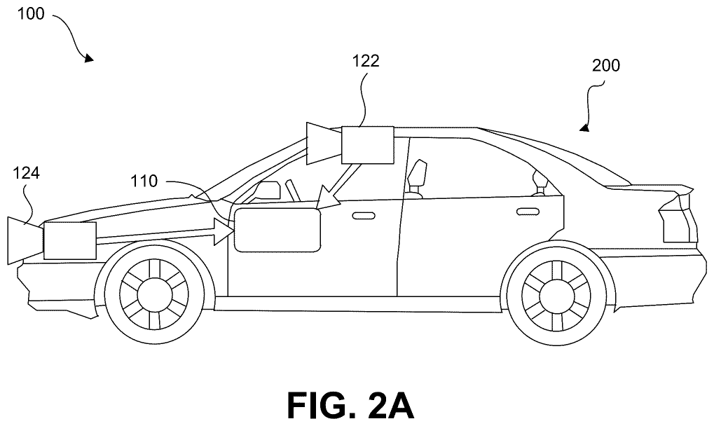

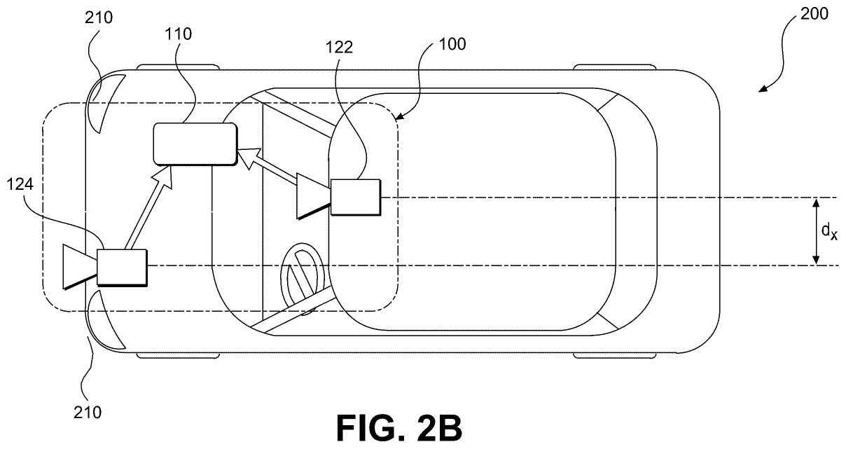

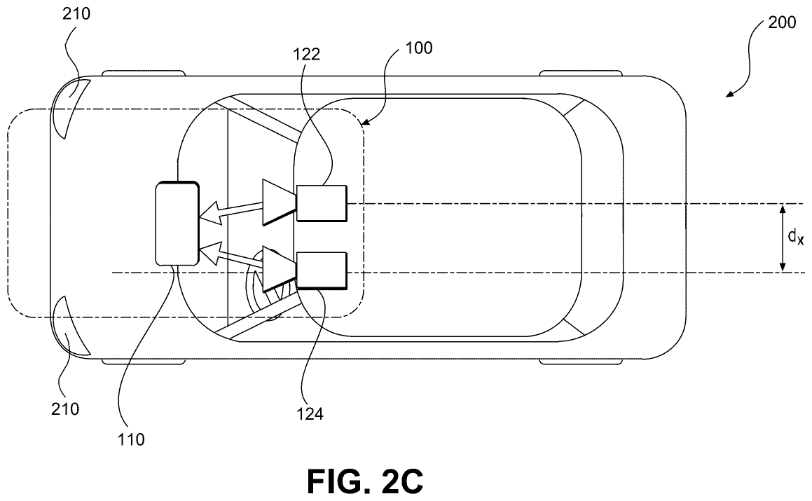

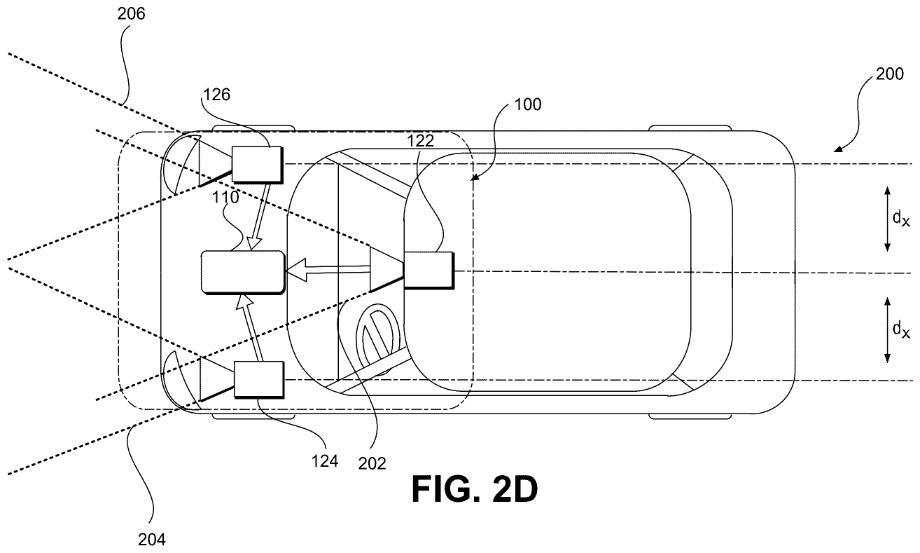

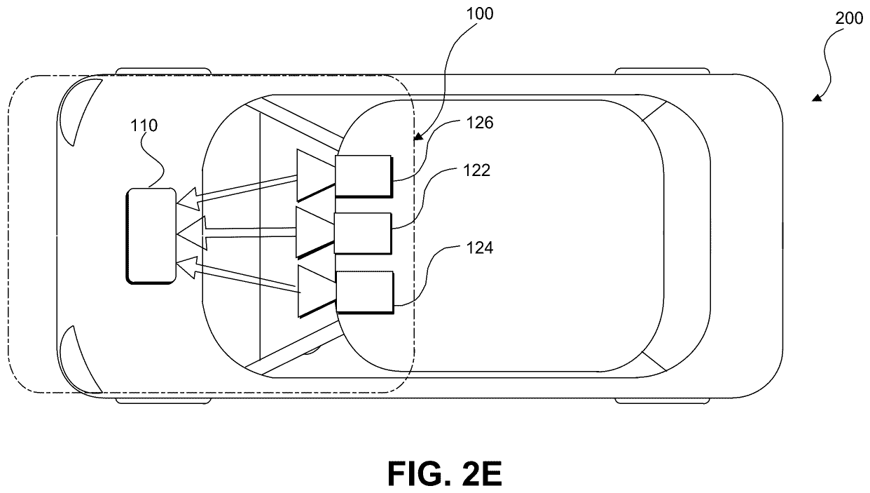

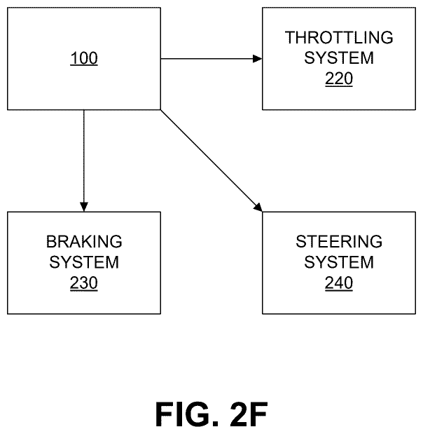

Image capture devices 122, 124, and 126 may each include any type of device suitable for capturing at least one image from an environment. Moreover, any number of image capture devices may be used to acquire images for input to the image processor. Some embodiments may include only a single image capture device, while other embodiments may include two, three, or even four or more image capture devices. Image capture devices 122, 124, and 126 will be further described with reference to FIGS. 2B-2E, below.

System 100, or various components thereof, may be incorporated into various different platforms. In some embodiments, system 100 may be included on a vehicle 200, as shown in FIG. 2A. For example, vehicle 200 may be equipped with a processing unit 110 and any of the other components of system 100, as described above relative to FIG. 1. While in some embodiments vehicle 200 may be equipped with only a single image capture device (e.g., camera), in other embodiments, such as those discussed in connection with FIGS. 2B-2E, multiple image capture devices may be used. For example, either of image capture devices 122 and 124 of vehicle 200, as shown in FIG. 2A, may be part of an ADAS (Advanced Driver Assistance Systems) imaging set.

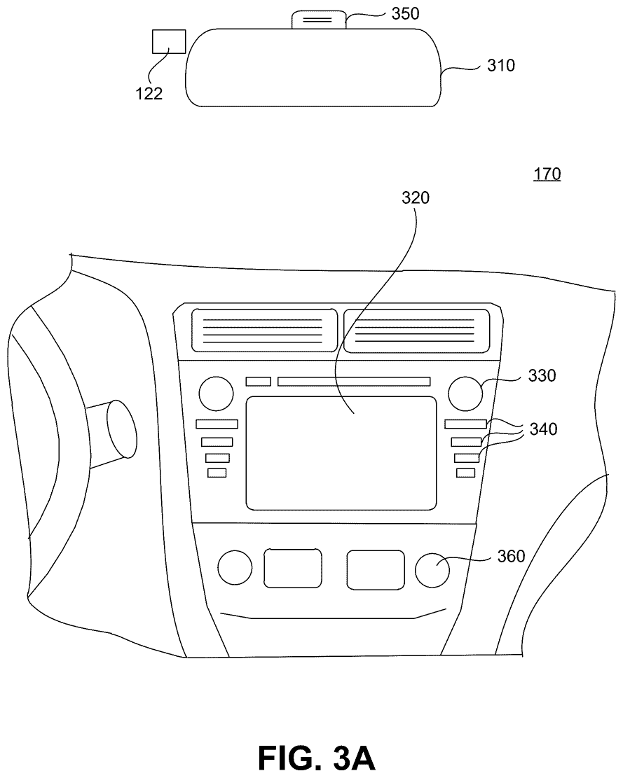

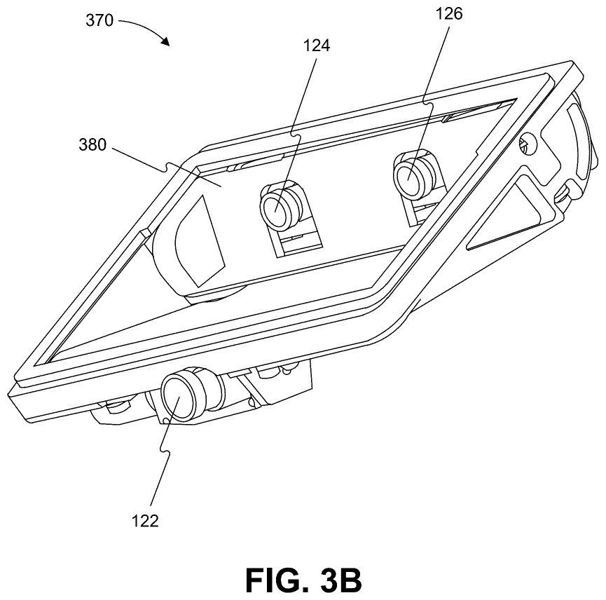

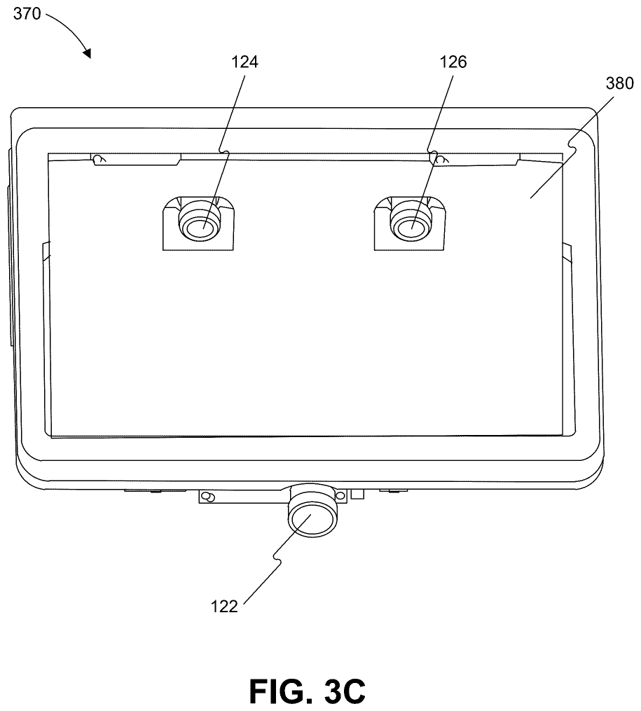

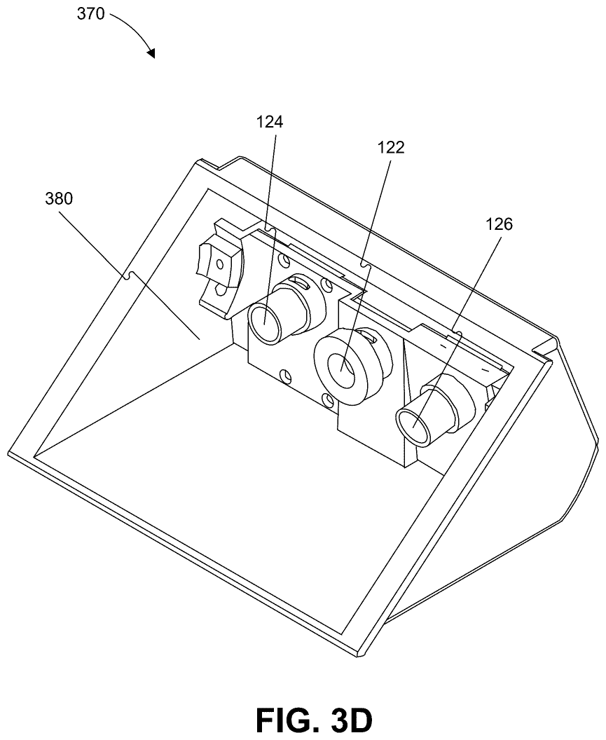

The image capture devices included on vehicle 200 as part of the image acquisition unit 120 may be positioned at any suitable location. In some embodiments, as shown in FIGS. 2A-2E and 3A-3C, image capture device 122 may be located in the vicinity of the rearview mirror. This position may provide a line of sight similar to that of the driver of vehicle 200, which may aid in determining what is and is not visible to the driver. Image capture device 122 may be positioned at any location near the rearview mirror, but placing image capture device 122 on the driver side of the mirror may further aid in obtaining images representative of the driver's field of view and/or line of sight.

Other locations for the image capture devices of image acquisition unit 120 may also be used. For example, image capture device 124 may be located on or in a bumper of vehicle 200. Such a location may be especially suitable for image capture devices having a wide field of view. The line of sight of bumper-located image capture devices can be different from that of the driver and, therefore, the bumper image capture device and driver may not always see the same objects. The image capture devices (e.g., image capture devices 122, 124, and 126) may also be located in other locations. For example, the image capture devices may be located on or in one or both of the side mirrors of vehicle 200, on the roof of vehicle 200, on the hood of vehicle 200, on the trunk of vehicle 200, on the sides of vehicle 200, mounted on, positioned behind, or positioned in front of any of the windows of vehicle 200, and mounted in or near light figures on the front and/or back of vehicle 200, etc.

In addition to image capture devices, vehicle 200 may include various other components of system 100. For example, processing unit 110 may be included on vehicle 200 either integrated with or separate from an engine control unit (ECU) of the vehicle. Vehicle 200 may also be equipped with a position sensor 130, such as a GPS receiver and may also include a map database 160 and memory units 140 and 150.

As discussed earlier, wireless transceiver 172 may and/or receive data over one or more networks (e.g., cellular networks, the Internet, etc.). For example, wireless transceiver 172 may upload data collected by system 100 to one or more servers, and download data from the one or more servers. Via wireless transceiver 172, system 100 may receive, for example, periodic or on demand updates to data stored in map database 160, memory 140, and/or memory 150. Similarly, wireless transceiver 172 may upload any data (e.g., images captured by image acquisition unit 120, data received by position sensor 130 or other sensors, vehicle control systems, etc.) from by system 100 and/or any data processed by processing unit 110 to the one or more servers.

System 100 may upload data to a server (e.g., to the cloud) based on a privacy level setting. For example, system 100 may implement privacy level settings to regulate or limit the types of data (including metadata) sent to the server that may uniquely identify a vehicle and or driver/owner of a vehicle. Such settings may be set by user via, for example, wireless transceiver 172, be initialized by factory default settings, or by data received by wireless transceiver 172.

In some embodiments, system 100 may upload data according to a “high” privacy level, and under setting a setting, system 100 may transmit data (e.g., location information related to a route, captured images, etc.) without any details about the specific vehicle and/or driver/owner. For example, when uploading data according to a “high” privacy setting, system 100 may not include a vehicle identification number (VIN) or a name of a driver or owner of the vehicle, and may instead of transmit data, such as captured images and/or limited location information related to a route.

Other privacy levels are contemplated. For example, system 100 may transmit data to a server according to an “intermediate” privacy level and include additional information not included under a “high” privacy level, such as a make and/or model of a vehicle and/or a vehicle type (e.g., a passenger vehicle, sport utility vehicle, truck, etc.). In some embodiments, system 100 may upload data according to a “low” privacy level. Under a “low” privacy level setting, system 100 may upload data and include information sufficient to uniquely identify a specific vehicle, owner/driver, and/or a portion or entirely of a route traveled by the vehicle. Such “low” privacy level data may include one or more of, for example, a VIN, a driver/owner name, an origination point of a vehicle prior to departure, an intended destination of the vehicle, a make and/or model of the vehicle, a type of the vehicle, etc.

FIG. 2A is a diagrammatic side view representation of an exemplary vehicle imaging system consistent with the disclosed embodiments. FIG. 2B is a diagrammatic top view illustration of the embodiment shown in FIG. 2A. As illustrated in FIG. 2B, the disclosed embodiments may include a vehicle 200 including in its body a system 100 with a first image capture device 122 positioned in the vicinity of the rearview mirror and/or near the driver of vehicle 200, a second image capture device 124 positioned on or in a bumper region (e.g., one of bumper regions 210) of vehicle 200, and a processing unit 110.

As illustrated in FIG. 2C, image capture devices 122 and 124 may both be positioned in the vicinity of the rearview mirror and/or near the driver of vehicle 200. Additionally, while two image capture devices 122 and 124 are shown in FIGS. 2B and 2C, it should be understood that other embodiments may include more than two image capture devices. For example, in the embodiments shown in FIGS. 2D and 2E, first, second, and third image capture devices 122, 124, and 126, are included in the system 100 of vehicle 200.

As illustrated in FIG. 2D, image capture device 122 may be positioned in the vicinity of the rearview mirror and/or near the driver of vehicle 200, and image capture devices 124 and 126 may be positioned on or in a bumper region (e.g., one of bumper regions 210) of vehicle 200. And as shown in FIG. 2E, image capture devices 122, 124, and 126 may be positioned in the vicinity of the rearview mirror and/or near the driver seat of vehicle 200. The disclosed embodiments are not limited to any particular number and configuration of the image capture devices, and the image capture devices may be positioned in any appropriate location within and/or on vehicle 200.

It is to be understood that the disclosed embodiments are not limited to vehicles and could be applied in other contexts. It is also to be understood that disclosed embodiments are not limited to a particular type of vehicle 200 and may be applicable to all types of vehicles including automobiles, trucks, trailers, and other types of vehicles.

The first image capture device 122 may include any suitable type of image capture device. Image capture device 122 may include an optical axis. In one instance, the image capture device 122 may include an Aptina M9V024 WVGA sensor with a global shutter. In other embodiments, image capture device 122 may provide a resolution of 1280×960 pixels and may include a rolling shutter. Image capture device 122 may include various optical elements. In some embodiments one or more lenses may be included, for example, to provide a desired focal length and field of view for the image capture device. In some embodiments, image capture device 122 may be associated with a 6 mm lens or a 12 mm lens. In some embodiments, image capture device 122 may be configured to capture images having a desired field-of-view (FOV) 202, as illustrated in FIG. 2D. For example, image capture device 122 may be configured to have a regular FOV, such as within a range of 40 degrees to 56 degrees, including a 46 degree FOV, 50 degree FOV, 52 degree FOV, or greater. Alternatively, image capture device 122 may be configured to have a narrow FOV in the range of 23 to 40 degrees, such as a 28 degree FOV or 36 degree FOV. In addition, image capture device 122 may be configured to have a wide FOV in the range of 100 to 180 degrees. In some embodiments, image capture device 122 may include a wide angle bumper camera or one with up to a 180 degree FOV. In some embodiments, image capture device 122 may be a 7.2M pixel image capture device with an aspect ratio of about 2:1 (e.g., H×V=3800×1900 pixels) with about 100 degree horizontal FOV. Such an image capture device may be used in place of a three image capture device configuration. Due to significant lens distortion, the vertical FOV of such an image capture device may be significantly less than 50 degrees in implementations in which the image capture device uses a radially symmetric lens. For example, such a lens may not be radially symmetric which would allow for a vertical FOV greater than 50 degrees with 100 degree horizontal FOV.

The first image capture device 122 may acquire a plurality of first images relative to a scene associated with the vehicle 200. Each of the plurality of first images may be acquired as a series of image scan lines, which may be captured using a rolling shutter. Each scan line may include a plurality of pixels.

The first image capture device 122 may have a scan rate associated with acquisition of each of the first series of image scan lines. The scan rate may refer to a rate at which an image sensor can acquire image data associated with each pixel included in a particular scan line.

Image capture devices 122, 124, and 126 may contain any suitable type and number of image sensors, including CCD sensors or CMOS sensors, for example. In one embodiment, a CMOS image sensor may be employed along with a rolling shutter, such that each pixel in a row is read one at a time, and scanning of the rows proceeds on a row-by-row basis until an entire image frame has been captured. In some embodiments, the rows may be captured sequentially from top to bottom relative to the frame.

In some embodiments, one or more of the image capture devices (e.g., image capture devices 122, 124, and 126) disclosed herein may constitute a high resolution imager and may have a resolution greater than 5M pixel, 7M pixel, 10M pixel, or greater.

The use of a rolling shutter may result in pixels in different rows being exposed and captured at different times, which may cause skew and other image artifacts in the captured image frame. On the other hand, when the image capture device 122 is configured to operate with a global or synchronous shutter, all of the pixels may be exposed for the same amount of time and during a common exposure period. As a result, the image data in a frame collected from a system employing a global shutter represents a snapshot of the entire FOV (such as FOV 202) at a particular time. In contrast, in a rolling shutter application, each row in a frame is exposed and data is capture at different times. Thus, moving objects may appear distorted in an image capture device having a rolling shutter. This phenomenon will be described in greater detail below.

The second image capture device 124 and the third image capturing device 126 may be any type of image capture device. Like the first image capture device 122, each of image capture devices 124 and 126 may include an optical axis. In one embodiment, each of image capture devices 124 and 126 may include an Aptina M9V024 WVGA sensor with a global shutter. Alternatively, each of image capture devices 124 and 126 may include a rolling shutter. Like image capture device 122, image capture devices 124 and 126 may be configured to include various lenses and optical elements. In some embodiments, lenses associated with image capture devices 124 and 126 may provide FOVs (such as FOVs 204 and 206) that are the same as, or narrower than, a FOV (such as FOV 202) associated with image capture device 122. For example, image capture devices 124 and 126 may have FOVs of 40 degrees, 30 degrees, 26 degrees, 23 degrees, 20 degrees, or less.

Image capture devices 124 and 126 may acquire a plurality of second and third images relative to a scene associated with the vehicle 200. Each of the plurality of second and third images may be acquired as a second and third series of image scan lines, which may be captured using a rolling shutter. Each scan line or row may have a plurality of pixels. Image capture devices 124 and 126 may have second and third scan rates associated with acquisition of each of image scan lines included in the second and third series.

Each image capture device 122, 124, and 126 may be positioned at any suitable position and orientation relative to vehicle 200. The relative positioning of the image capture devices 122, 124, and 126 may be selected to aid in fusing together the information acquired from the image capture devices. For example, in some embodiments, a FOV (such as FOV 204) associated with image capture device 124 may overlap partially or fully with a FOV (such as FOV 202) associated with image capture device 122 and a FOV (such as FOV 206) associated with image capture device 126.

Image capture devices 122, 124, and 126 may be located on vehicle 200 at any suitable relative heights. In one instance, there may be a height difference between the image capture devices 122, 124, and 126, which may provide sufficient parallax information to enable stereo analysis. For example, as shown in FIG. 2A, the two image capture devices 122 and 124 are at different heights. There may also be a lateral displacement difference between image capture devices 122, 124, and 126, giving additional parallax information for stereo analysis by processing unit 110, for example. The difference in the lateral displacement may be denoted by dₓ, as shown in FIGS. 2C and 2D. In some embodiments, fore or aft displacement (e.g., range displacement) may exist between image capture devices 122, 124, and 126. For example, image capture device 122 may be located 0.5 to 2 meters or more behind image capture device 124 and/or image capture device 126. This type of displacement may enable one of the image capture devices to cover potential blind spots of the other image capture device(s).

Image capture devices 122 may have any suitable resolution capability (e.g., number of pixels associated with the image sensor), and the resolution of the image sensor(s) associated with the image capture device 122 may be higher, lower, or the same as the resolution of the image sensor(s) associated with image capture devices 124 and 126. In some embodiments, the image sensor(s) associated with image capture device 122 and/or image capture devices 124 and 126 may have a resolution of 640×480, 1024×768, 1280×960, or any other suitable resolution.

The frame rate (e.g., the rate at which an image capture device acquires a set of pixel data of one image frame before moving on to capture pixel data associated with the next image frame) may be controllable. The frame rate associated with image capture device 122 may be higher, lower, or the same as the frame rate associated with image capture devices 124 and 126. The frame rate associated with image capture devices 122, 124, and 126 may depend on a variety of factors that may affect the timing of the frame rate. For example, one or more of image capture devices 122, 124, and 126 may include a selectable pixel delay period imposed before or after acquisition of image data associated with one or more pixels of an image sensor in image capture device 122, 124, and/or 126. Generally, image data corresponding to each pixel may be acquired according to a clock rate for the device (e.g., one pixel per clock cycle). Additionally, in embodiments including a rolling shutter, one or more of image capture devices 122, 124, and 126 may include a selectable horizontal blanking period imposed before or after acquisition of image data associated with a row of pixels of an image sensor in image capture device 122, 124, and/or 126. Further, one or more of image capture devices 122, 124, and/or 126 may include a selectable vertical blanking period imposed before or after acquisition of image data associated with an image frame of image capture device 122, 124, and 126.

These timing controls may enable synchronization of frame rates associated with image capture devices 122, 124, and 126, even where the line scan rates of each are different. Additionally, as will be discussed in greater detail below, these selectable timing controls, among other factors (e.g., image sensor resolution, maximum line scan rates, etc.) may enable synchronization of image capture from an area where the FOV of image capture device 122 overlaps with one or more FOVs of image capture devices 124 and 126, even where the field of view of image capture device 122 is different from the FOVs of image capture devices 124 and 126.

Frame rate timing in image capture device 122, 124, and 126 may depend on the resolution of the associated image sensors. For example, assuming similar line scan rates for both devices, if one device includes an image sensor having a resolution of 640×480 and another device includes an image sensor with a resolution of 1280×960, then more time will be required to acquire a frame of image data from the sensor having the higher resolution.

Another factor that may affect the timing of image data acquisition in image capture devices 122, 124, and 126 is the maximum line scan rate. For example, acquisition of a row of image data from an image sensor included in image capture device 122, 124, and 126 will require some minimum amount of time. Assuming no pixel delay periods are added, this minimum amount of time for acquisition of a row of image data will be related to the maximum line scan rate for a particular device. Devices that offer higher maximum line scan rates have the potential to provide higher frame rates than devices with lower maximum line scan rates. In some embodiments, one or more of image capture devices 124 and 126 may have a maximum line scan rate that is higher than a maximum line scan rate associated with image capture device 122. In some embodiments, the maximum line scan rate of image capture device 124 and/or 126 may be 1.25, 1.5, 1.75, or 2 times or more than a maximum line scan rate of image capture device 122.

In another embodiment, image capture devices 122, 124, and 126 may have the same maximum line scan rate, but image capture device 122 may be operated at a scan rate less than or equal to its maximum scan rate. The system may be configured such that one or more of image capture devices 124 and 126 operate at a line scan rate that is equal to the line scan rate of image capture device 122. In other instances, the system may be configured such that the line scan rate of image capture device 124 and/or image capture device 126 may be 1.25, 1.5, 1.75, or 2 times or more than the line scan rate of image capture device 122.

In some embodiments, image capture devices 122, 124, and 126 may be asymmetric. That is, they may include cameras having different fields of view (FOV) and focal lengths. The fields of view of image capture devices 122, 124, and 126 may include any desired area relative to an environment of vehicle 200, for example. In some embodiments, one or more of image capture devices 122, 124, and 126 may be configured to acquire image data from an environment in front of vehicle 200, behind vehicle 200, to the sides of vehicle 200, or combinations thereof.

Further, the focal length associated with each image capture device 122, 124, and/or 126 may be selectable (e.g., by inclusion of appropriate lenses etc.) such that each device acquires images of objects at a desired distance range relative to vehicle 200. For example, in some embodiments image capture devices 122, 124, and 126 may acquire images of close-up objects within a few meters from the vehicle. Image capture devices 122, 124, and 126 may also be configured to acquire images of objects at ranges more distant from the vehicle (e.g., 25 m, 50 m, 100 m, 150 m, or more). Further, the focal lengths of image capture devices 122, 124, and 126 may be selected such that one image capture device (e.g., image capture device 122) can acquire images of objects relatively close to the vehicle (e.g., within 10 m or within 20 m) while the other image capture devices (e.g., image capture devices 124 and 126) can acquire images of more distant objects (e.g., greater than 20 m, 50 m, 100 m, 150 m, etc.) from vehicle 200.

According to some embodiments, the FOV of one or more image capture devices 122, 124, and 126 may have a wide angle. For example, it may be advantageous to have a FOV of 140 degrees, especially for image capture devices 122, 124, and 126 that may be used to capture images of the area in the vicinity of vehicle 200. For example, image capture device 122 may be used to capture images of the area to the right or left of vehicle 200 and, in such embodiments, it may be desirable for image capture device 122 to have a wide FOV (e.g., at least 140 degrees).

The field of view associated with each of image capture devices 122, 124, and 126 may depend on the respective focal lengths. For example, as the focal length increases, the corresponding field of view decreases.

Image capture devices 122, 124, and 126 may be configured to have any suitable fields of view. In one particular example, image capture device 122 may have a horizontal FOV of 46 degrees, image capture device 124 may have a horizontal FOV of 23 degrees, and image capture device 126 may have a horizontal FOV in between 23 and 46 degrees. In another instance, image capture device 122 may have a horizontal FOV of 52 degrees, image capture device 124 may have a horizontal FOV of 26 degrees, and image capture device 126 may have a horizontal FOV in between 26 and 52 degrees. In some embodiments, a ratio of the FOV of image capture device 122 to the FOVs of image capture device 124 and/or image capture device 126 may vary from 1.5 to 2.0. In other embodiments, this ratio may vary between 1.25 and 2.25.

System 100 may be configured so that a field of view of image capture device 122 overlaps, at least partially or fully, with a field of view of image capture device 124 and/or image capture device 126. In some embodiments, system 100 may be configured such that the fields of view of image capture devices 124 and 126, for example, fall within (e.g., are narrower than) and share a common center with the field of view of image capture device 122. In other embodiments, the image capture devices 122, 124, and 126 may capture adjacent FOVs or may have partial overlap in their FOVs. In some embodiments, the fields of view of image capture devices 122, 124, and 126 may be aligned such that a center of the narrower FOV image capture devices 124 and/or 126 may be located in a lower half of the field of view of the wider FOV device 122.

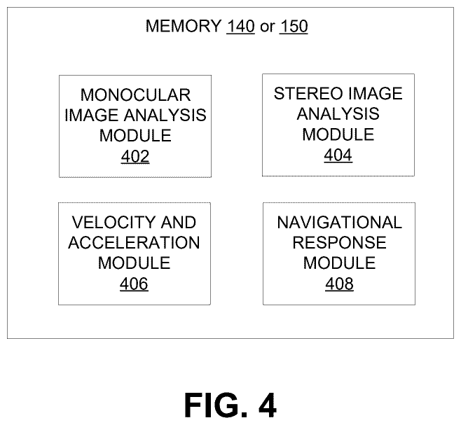

FIG. 2F is a diagrammatic representation of exemplary vehicle control systems, consistent with the disclosed embodiments. As indicated in FIG. 2F, vehicle 200 may include throttling system 220, braking system 230, and steering system 240. System 100 may provide inputs (e.g., control signals) to one or more of throttling system 220, braking system 230, and steering system 240 over one or more data links (e.g., any wired and/or wireless link or links for transmitting data). For example, based on analysis of images acquired by image capture devices 122, 124, and/or 126, system 100 may provide control signals to one or more of throttling system 220, braking system 230, and steering system 240 to navigate vehicle 200 (e.g., by causing an acceleration, a turn, a lane shift, etc.). Further, system 100 may receive inputs from one or more of throttling system 220, braking system 230, and steering system 24 indicating operating conditions of vehicle 200 (e.g., speed, whether vehicle 200 is braking and/or turning, etc.). Further details are provided in connection with FIGS. 4-7, below.

As shown in FIG. 3A, vehicle 200 may also include a user interface 170 for interacting with a driver or a passenger of vehicle 200. For example, user interface 170 in a vehicle application may include a touch screen 320, knobs 330, buttons 340, and a microphone 350. A driver or passenger of vehicle 200 may also use handles (e.g., located on or near the steering column of vehicle 200 including, for example, turn signal handles), buttons (e.g., located on the steering wheel of vehicle 200), and the like, to interact with system 100. In some embodiments, microphone 350 may be positioned adjacent to a rearview mirror 310. Similarly, in some embodiments, image capture device 122 may be located near rearview mirror 310. In some embodiments, user interface 170 may also include one or more speakers 360 (e.g., speakers of a vehicle audio system). For example, system 100 may provide various notifications (e.g., alerts) via speakers 360.

FIGS. 3B-3D are illustrations of an exemplary camera mount 370 configured to be positioned behind a rearview mirror (e.g., rearview mirror 310) and against a vehicle windshield, consistent with disclosed embodiments. As shown in FIG. 3B, camera mount 370 may include image capture devices 122, 124, and 126. Image capture devices 124 and 126 may be positioned behind a glare shield 380, which may be flush against the vehicle windshield and include a composition of film and/or anti-reflective materials. For example, glare shield 380 may be positioned such that the shield aligns against a vehicle windshield having a matching slope. In some embodiments, each of image capture devices 122, 124, and 126 may be positioned behind glare shield 380, as depicted, for example, in FIG. 3D. The disclosed embodiments are not limited to any particular configuration of image capture devices 122, 124, and 126, camera mount 370, and glare shield 380. FIG. 3C is an illustration of camera mount 370 shown in FIG. 3B from a front perspective.

As will be appreciated by a person skilled in the art having the benefit of this disclosure, numerous variations and/or modifications may be made to the foregoing disclosed embodiments. For example, not all components are essential for the operation of system 100. Further, any component may be located in any appropriate part of system 100 and the components may be rearranged into a variety of configurations while providing the functionality of the disclosed embodiments. Therefore, the foregoing configurations are examples and, regardless of the configurations discussed above, system 100 can provide a wide range of functionality to analyze the surroundings of vehicle 200 and navigate vehicle 200 in response to the analysis.

As discussed below in further detail and consistent with various disclosed embodiments, system 100 may provide a variety of features related to autonomous driving and/or driver assist technology. For example, system 100 may analyze image data, position data (e.g., GPS location information), map data, speed data, and/or data from sensors included in vehicle 200. System 100 may collect the data for analysis from, for example, image acquisition unit 120, position sensor 130, and other sensors. Further, system 100 may analyze the collected data to determine whether or not vehicle 200 should take a certain action, and then automatically take the determined action without human intervention. For example, when vehicle 200 navigates without human intervention, system 100 may automatically control the braking, acceleration, and/or steering of vehicle 200 (e.g., by sending control signals to one or more of throttling system 220, braking system 230, and steering system 240). Further, system 100 may analyze the collected data and issue warnings and/or alerts to vehicle occupants based on the analysis of the collected data. Additional details regarding the various embodiments that are provided by system 100 are provided below.

### Forward-Facing Multi-Imaging System

As discussed above, system 100 may provide drive assist functionality that uses a multi-camera system. The multi-camera system may use one or more cameras facing in the forward direction of a vehicle. In other embodiments, the multi-camera system may include one or more cameras facing to the side of a vehicle or to the rear of the vehicle. In one embodiment, for example, system 100 may use a two-camera imaging system, where a first camera and a second camera (e.g., image capture devices 122 and 124) may be positioned at the front and/or the sides of a vehicle (e.g., vehicle 200). The first camera may have a field of view that is greater than, less than, or partially overlapping with, the field of view of the second camera. In addition, the first camera may be connected to a first image processor to perform monocular image analysis of images provided by the first camera, and the second camera may be connected to a second image processor to perform monocular image analysis of images provided by the second camera. The outputs (e.g., processed information) of the first and second image processors may be combined. In some embodiments, the second image processor may receive images from both the first camera and second camera to perform stereo analysis. In another embodiment, system 100 may use a three-camera imaging system where each of the cameras has a different field of view. Such a system may, therefore, make decisions based on information derived from objects located at varying distances both forward and to the sides of the vehicle. References to monocular image analysis may refer to instances where image analysis is performed based on images captured from a single point of view (e.g., from a single camera). Stereo image analysis may refer to instances where image analysis is performed based on two or more images captured with one or more variations of an image capture parameter. For example, captured images suitable for performing stereo image analysis may include images captured: from two or more different positions, from different fields of view, using different focal lengths, along with parallax information, etc.

For example, in one embodiment, system 100 may implement a three camera configuration using image capture devices 122, 124, and 126. In such a configuration, image capture device 122 may provide a narrow field of view (e.g., 34 degrees, or other values selected from a range of about 20 to 45 degrees, etc.), image capture device 124 may provide a wide field of view (e.g., 150 degrees or other values selected from a range of about 100 to about 180 degrees), and image capture device 126 may provide an intermediate field of view (e.g., 46 degrees or other values selected from a range of about 35 to about 60 degrees). In some embodiments, image capture device 126 may act as a main or primary camera. Image capture devices 122, 124, and 126 may be positioned behind rearview mirror 310 and positioned substantially side-by-side (e.g., 6 cm apart). Further, in some embodiments, as discussed above, one or more of image capture devices 122, 124, and 126 may be mounted behind glare shield 380 that is flush with the windshield of vehicle 200. Such shielding may act to minimize the impact of any reflections from inside the car on image capture devices 122, 124, and 126.

In another embodiment, as discussed above in connection with FIGS. 3B and 3C, the wide field of view camera (e.g., image capture device 124 in the above example) may be mounted lower than the narrow and main field of view cameras (e.g., image devices 122 and 126 in the above example). This configuration may provide a free line of sight from the wide field of view camera. To reduce reflections, the cameras may be mounted close to the windshield of vehicle 200, and may include polarizers on the cameras to damp reflected light.

A three camera system may provide certain performance characteristics. For example, some embodiments may include an ability to validate the detection of objects by one camera based on detection results from another camera. In the three camera configuration discussed above, processing unit 110 may include, for example, three processing devices (e.g., three EyeQ series of processor chips, as discussed above), with each processing device dedicated to processing images captured by one or more of image capture devices 122, 124, and 126.

In a three camera system, a first processing device may receive images from both the main camera and the narrow field of view camera, and perform vision processing of the narrow FOV camera to, for example, detect other vehicles, pedestrians, lane marks, traffic signs, traffic lights, and other road objects. Further, the first processing device may calculate a disparity of pixels between the images from the main camera and the narrow camera and create a 3D reconstruction of the environment of vehicle 200. The first processing device may then combine the 3D reconstruction with 3D map data or with 3D information calculated based on information from another camera.

The second processing device may receive images from main camera and perform vision processing to detect other vehicles, pedestrians, lane marks, traffic signs, traffic lights, and other road objects. Additionally, the second processing device may calculate a camera displacement and, based on the displacement, calculate a disparity of pixels between successive images and create a 3D reconstruction of the scene (e.g., a structure from motion). The second processing device may send the structure from motion based 3D reconstruction to the first processing device to be combined with the stereo 3D images.

The third processing device may receive images from the wide FOV camera and process the images to detect vehicles, pedestrians, lane marks, traffic signs, traffic lights, and other road objects. The third processing device may further execute additional processing instructions to analyze images to identify objects moving in the image, such as vehicles changing lanes, pedestrians, etc.

In some embodiments, having streams of image-based information captured and processed independently may provide an opportunity for providing redundancy in the system. Such redundancy may include, for example, using a first image capture device and the images processed from that device to validate and/or supplement information obtained by capturing and processing image information from at least a second image capture device.

In some embodiments, system 100 may use two image capture devices (e.g., image capture devices 122 and 124) in providing navigation assistance for vehicle 200 and use a third image capture device (e.g., image capture device 126) to provide redundancy and validate the analysis of data received from the other two image capture devices. For example, in such a configuration, image capture devices 122 and 124 may provide images for stereo analysis by system 100 for navigating vehicle 200, while image capture device 126 may provide images for monocular analysis by system 100 to provide redundancy and validation of information obtained based on images captured from image capture device 122 and/or image capture device 124. That is, image capture device 126 (and a corresponding processing device) may be considered to provide a redundant sub-system for providing a check on the analysis derived from image capture devices 122 and 124 (e.g., to provide an automatic emergency braking (AEB) system). Furthermore, in some embodiments, redundancy and validation of received data may be supplemented based on information received from one more sensors (e.g., radar, lidar, acoustic sensors, information received from one or more transceivers outside of a vehicle, etc.).

One of skill in the art will recognize that the above camera configurations, camera placements, number of cameras, camera locations, etc., are examples only. These components and others described relative to the overall system may be assembled and used in a variety of different configurations without departing from the scope of the disclosed embodiments. Further details regarding usage of a multi-camera system to provide driver assist and/or autonomous vehicle functionality follow below.

FIG. 4 is an exemplary functional block diagram of memory 140 and/or 150, which may be stored/programmed with instructions for performing one or more operations consistent with the disclosed embodiments. Although the following refers to memory 140, one of skill in the art will recognize that instructions may be stored in memory 140 and/or 150.

As shown in FIG. 4, memory 140 may store a monocular image analysis module 402, a stereo image analysis module 404, a velocity and acceleration module 406, and a navigational response module 408. The disclosed embodiments are not limited to any particular configuration of memory 140. Further, application processor 180 and/or image processor 190 may execute the instructions stored in any of modules 402, 404, 406, and 408 included in memory 140. One of skill in the art will understand that references in the following discussions to processing unit 110 may refer to application processor 180 and image processor 190 individually or collectively. Accordingly, steps of any of the following processes may be performed by one or more processing devices.

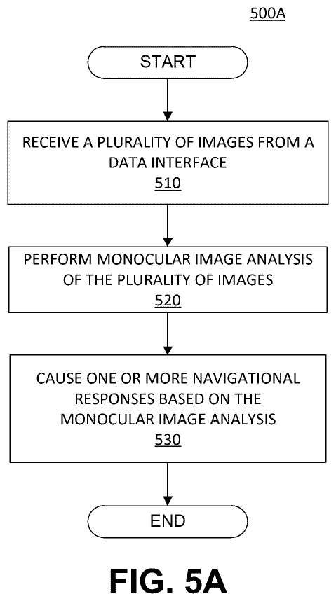

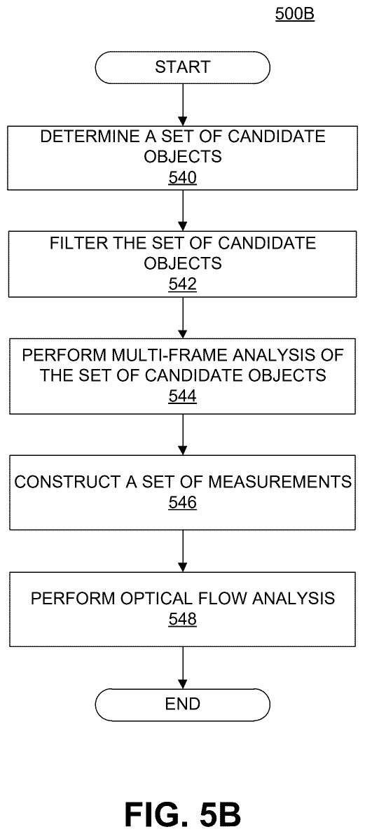

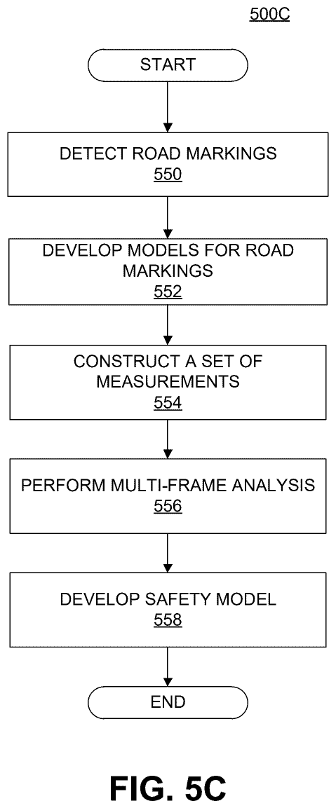

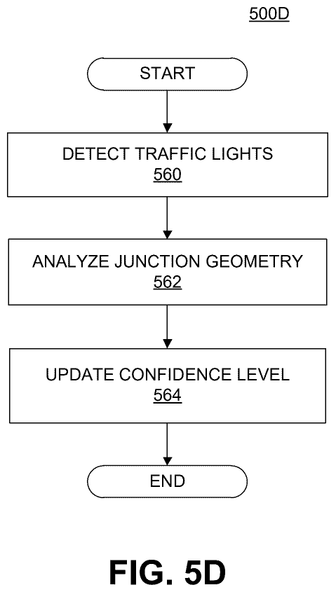

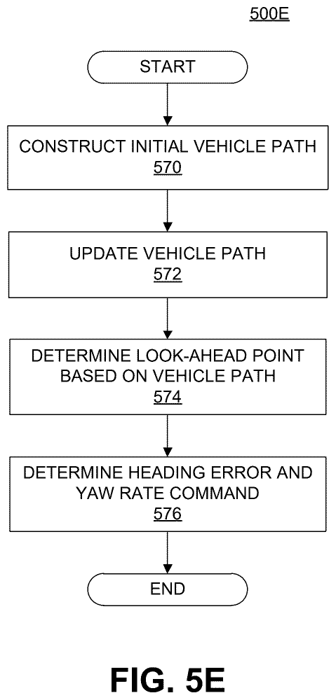

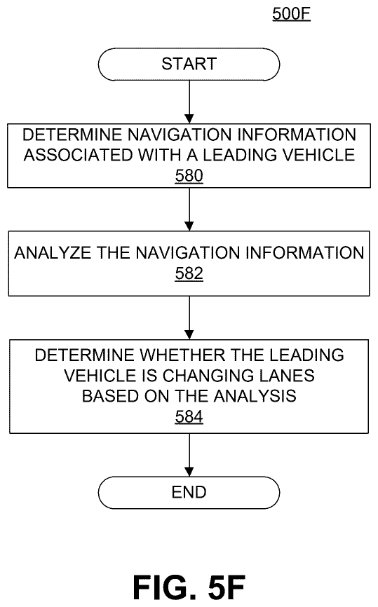

In one embodiment, monocular image analysis module 402 may store instructions (such as computer vision software) which, when executed by processing unit 110, performs monocular image analysis of a set of images acquired by one of image capture devices 122, 124, and 126. In some embodiments, processing unit 110 may combine information from a set of images with additional sensory information (e.g., information from radar, lidar, etc.) to perform the monocular image analysis. As described in connection with FIGS. 5A-5D below, monocular image analysis module 402 may include instructions for detecting a set of features within the set of images, such as lane markings, vehicles, pedestrians, road signs, highway exit ramps, traffic lights, hazardous objects, and any other feature associated with an environment of a vehicle. Based on the analysis, system 100 (e.g., via processing unit 110) may cause one or more navigational responses in vehicle 200, such as a turn, a lane shift, a change in acceleration, and the like, as discussed below in connection with navigational response module 408.

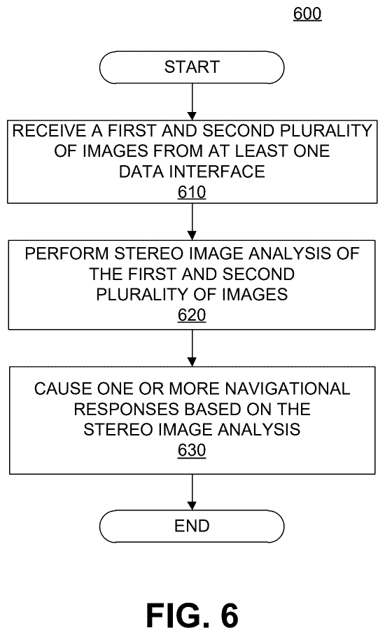

In one embodiment, stereo image analysis module 404 may store instructions (such as computer vision software) which, when executed by processing unit 110, performs stereo image analysis of first and second sets of images acquired by a combination of image capture devices selected from any of image capture devices 122, 124, and 126. In some embodiments, processing unit 110 may combine information from the first and second sets of images with additional sensory information (e.g., information from radar) to perform the stereo image analysis. For example, stereo image analysis module 404 may include instructions for performing stereo image analysis based on a first set of images acquired by image capture device 124 and a second set of images acquired by image capture device 126. As described in connection with FIG. 6 below, stereo image analysis module 404 may include instructions for detecting a set of features within the first and second sets of images, such as lane markings, vehicles, pedestrians, road signs, highway exit ramps, traffic lights, hazardous objects, and the like. Based on the analysis, processing unit 110 may cause one or more navigational responses in vehicle 200, such as a turn, a lane shift, a change in acceleration, and the like, as discussed below in connection with navigational response module 408. Furthermore, in some embodiments, stereo image analysis module 404 may implement techniques associated with a trained system (such as a neural network or a deep neural network) or an untrained system, such as a system that may be configured to use computer vision algorithms to detect and/or label objects in an environment from which sensory information was captured and processed. In one embodiment, stereo image analysis module 404 and/or other image processing modules may be configured to use a combination of a trained and untrained system.

In one embodiment, velocity and acceleration module 406 may store software configured to analyze data received from one or more computing and electromechanical devices in vehicle 200 that are configured to cause a change in velocity and/or acceleration of vehicle 200. For example, processing unit 110 may execute instructions associated with velocity and acceleration module 406 to calculate a target speed for vehicle 200 based on data derived from execution of monocular image analysis module 402 and/or stereo image analysis module 404. Such data may include, for example, a target position, velocity, and/or acceleration, the position and/or speed of vehicle 200 relative to a nearby vehicle, pedestrian, or road object, position information for vehicle 200 relative to lane markings of the road, and the like. In addition, processing unit 110 may calculate a target speed for vehicle 200 based on sensory input (e.g., information from radar) and input from other systems of vehicle 200, such as throttling system 220, braking system 230, and/or steering system 240 of vehicle 200. Based on the calculated target speed, processing unit 110 may transmit electronic signals to throttling system 220, braking system 230, and/or steering system 240 of vehicle 200 to trigger a change in velocity and/or acceleration by, for example, physically depressing the brake or easing up off the accelerator of vehicle 200.

In one embodiment, navigational response module 408 may store software executable by processing unit 110 to determine a desired navigational response based on data derived from execution of monocular image analysis module 402 and/or stereo image analysis module 404. Such data may include position and speed information associated with nearby vehicles, pedestrians, and road objects, target position information for vehicle 200, and the like. Additionally, in some embodiments, the navigational response may be based (partially or fully) on map data, a predetermined position of vehicle 200, and/or a relative velocity or a relative acceleration between vehicle 200 and one or more objects detected from execution of monocular image analysis module 402 and/or stereo image analysis module 404. Navigational response module 408 may also determine a desired navigational response based on sensory input (e.g., information from radar) and inputs from other systems of vehicle 200, such as throttling system 220, braking system 230, and steering system 240 of vehicle 200. Based on the desired navigational response, processing unit 110 may transmit electronic signals to throttling system 220, braking system 230, and steering system 240 of vehicle 200 to trigger a desired navigational response by, for example, turning the steering wheel of vehicle 200 to achieve a rotation of a predetermined angle. In some embodiments, processing unit 110 may use the output of navigational response module 408 (e.g., the desired navigational response) as an input to execution of velocity and acceleration module 406 for calculating a change in speed of vehicle 200.

Furthermore, any of the modules (e.g., modules 402, 404, and 406) disclosed herein may implement techniques associated with a trained system (such as a neural network or a deep neural network) or an untrained system.

FIG. 5A is a flowchart showing an exemplary process 500A for causing one or more navigational responses based on monocular image analysis, consistent with disclosed embodiments. At step 510, processing unit 110 may receive a plurality of images via data interface 128 between processing unit 110 and image acquisition unit 120. For instance, a camera included in image acquisition unit 120 (such as image capture device 122 having field of view 202) may capture a plurality of images of an area forward of vehicle 200 (or to the sides or rear of a vehicle, for example) and transmit them over a data connection (e.g., digital, wired, USB, wireless, Bluetooth, etc.) to processing unit 110. Processing unit 110 may execute monocular image analysis module 402 to analyze the plurality of images at step 520, as described in further detail in connection with FIGS. 5B-5D below. By performing the analysis, processing unit 110 may detect a set of features within the set of images, such as lane markings, vehicles, pedestrians, road signs, highway exit ramps, traffic lights, and the like.

Processing unit 110 may also execute monocular image analysis module 402 to detect various road hazards at step 520, such as, for example, parts of a truck tire, fallen road signs, loose cargo, small animals, and the like. Road hazards may vary in structure, shape, size, and color, which may make detection of such hazards more challenging. In some embodiments, processing unit 110 may execute monocular image analysis module 402 to perform multi-frame analysis on the plurality of images to detect road hazards. For example, processing unit 110 may estimate camera motion between consecutive image frames and calculate the disparities in pixels between the frames to construct a 3D-map of the road. Processing unit 110 may then use the 3D-map to detect the road surface, as well as hazards existing above the road surface.

At step 530, processing unit 110 may execute navigational response module 408 to cause one or more navigational responses in vehicle 200 based on the analysis performed at step 520 and the techniques as described above in connection with FIG. 4. Navigational responses may include, for example, a turn, a lane shift, a change in acceleration, and the like. In some embodiments, processing unit 110 may use data derived from execution of velocity and acceleration module 406 to cause the one or more navigational responses. Additionally, multiple navigational responses may occur simultaneously, in sequence, or any combination thereof. For instance, processing unit 110 may cause vehicle 200 to shift one lane over and then accelerate by, for example, sequentially transmitting control signals to steering system 240 and throttling system 220 of vehicle 200. Alternatively, processing unit 110 may cause vehicle 200 to brake while at the same time shifting lanes by, for example, simultaneously transmitting control signals to braking system 230 and steering system 240 of vehicle 200.

FIG. 5B is a flowchart showing an exemplary process 500B for detecting one or more vehicles and/or pedestrians in a set of images, consistent with disclosed embodiments. Processing unit 110 may execute monocular image analysis module 402 to implement process 500B. At step 540, processing unit 110 may determine a set of candidate objects representing possible vehicles and/or pedestrians. For example, processing unit 110 may scan one or more images, compare the images to one or more predetermined patterns, and identify within each image possible locations that may contain objects of interest (e.g., vehicles, pedestrians, or portions thereof). The predetermined patterns may be designed in such a way to achieve a high rate of “false hits” and a low rate of “misses.” For example, processing unit 110 may use a low threshold of similarity to predetermined patterns for identifying candidate objects as possible vehicles or pedestrians. Doing so may allow processing unit 110 to reduce the probability of missing (e.g., not identifying) a candidate object representing a vehicle or pedestrian.

At step 542, processing unit 110 may filter the set of candidate objects to exclude certain candidates (e.g., irrelevant or less relevant objects) based on classification criteria. Such criteria may be derived from various properties associated with object types stored in a database (e.g., a database stored in memory 140). Properties may include object shape, dimensions, texture, position (e.g., relative to vehicle 200), and the like. Thus, processing unit 110 may use one or more sets of criteria to reject false candidates from the set of candidate objects.

At step 544, processing unit 110 may analyze multiple frames of images to determine whether objects in the set of candidate objects represent vehicles and/or pedestrians. For example, processing unit 110 may track a detected candidate object across consecutive frames and accumulate frame-by-frame data associated with the detected object (e.g., size, position relative to vehicle 200, etc.). Additionally, processing unit 110 may estimate parameters for the detected object and compare the object's frame-by-frame position data to a predicted position.

At step 546, processing unit 110 may construct a set of measurements for the detected objects. Such measurements may include, for example, position, velocity, and acceleration values (relative to vehicle 200) associated with the detected objects. In some embodiments, processing unit 110 may construct the measurements based on estimation techniques using a series of time-based observations such as Kalman filters or linear quadratic estimation (LQE), and/or based on available modeling data for different object types (e.g., cars, trucks, pedestrians, bicycles, road signs, etc.). The Kalman filters may be based on a measurement of an object's scale, where the scale measurement is proportional to a time to collision (e.g., the amount of time for vehicle 200 to reach the object). Thus, by performing steps 540-546, processing unit 110 may identify vehicles and pedestrians appearing within the set of captured images and derive information (e.g., position, speed, size) associated with the vehicles and pedestrians. Based on the identification and the derived information, processing unit 110 may cause one or more navigational responses in vehicle 200, as described in connection with FIG. 5A, above.

At step 548, processing unit 110 may perform an optical flow analysis of one or more images to reduce the probabilities of detecting a “false hit” and missing a candidate object that represents a vehicle or pedestrian. The optical flow analysis may refer to, for example, analyzing motion patterns relative to vehicle 200 in the one or more images associated with other vehicles and pedestrians, and that are distinct from road surface motion. Processing unit 110 may calculate the motion of candidate objects by observing the different positions of the objects across multiple image frames, which are captured at different times. Processing unit 110 may use the position and time values as inputs into mathematical models for calculating the motion of the candidate objects. Thus, optical flow analysis may provide another method of detecting vehicles and pedestrians that are nearby vehicle 200. Processing unit 110 may perform optical flow analysis in combination with steps 540-546 to provide redundancy for detecting vehicles and pedestrians and increase the reliability of system 100.

FIG. 5C is a flowchart showing an exemplary process 500C for detecting road marks and/or lane geometry information in a set of images, consistent with disclosed embodiments. Processing unit 110 may execute monocular image analysis module 402 to implement process 500C. At step 550, processing unit 110 may detect a set of objects by scanning one or more images. To detect segments of lane markings, lane geometry information, and other pertinent road marks, processing unit 110 may filter the set of objects to exclude those determined to be irrelevant (e.g., minor potholes, small rocks, etc.). At step 552, processing unit 110 may group together the segments detected in step 550 belonging to the same road mark or lane mark. Based on the grouping, processing unit 110 may develop a model to represent the detected segments, such as a mathematical model.

At step 554, processing unit 110 may construct a set of measurements associated with the detected segments. In some embodiments, processing unit 110 may create a projection of the detected segments from the image plane onto the real-world plane. The projection may be characterized using a 3rd-degree polynomial having coefficients corresponding to physical properties such as the position, slope, curvature, and curvature derivative of the detected road. In generating the projection, processing unit 110 may take into account changes in the road surface, as well as pitch and roll rates associated with vehicle 200. In addition, processing unit 110 may model the road elevation by analyzing position and motion cues present on the road surface. Further, processing unit 110 may estimate the pitch and roll rates associated with vehicle 200 by tracking a set of feature points in the one or more images.

At step 556, processing unit 110 may perform multi-frame analysis by, for example, tracking the detected segments across consecutive image frames and accumulating frame-by-frame data associated with detected segments. As processing unit 110 performs multi-frame analysis, the set of measurements constructed at step 554 may become more reliable and associated with an increasingly higher confidence level. Thus, by performing steps 550, 552, 554, and 556, processing unit 110 may identify road marks appearing within the set of captured images and derive lane geometry information. Based on the identification and the derived information, processing unit 110 may cause one or more navigational responses in vehicle 200, as described in connection with FIG. 5A, above.

At step 558, processing unit 110 may consider additional sources of information to further develop a safety model for vehicle 200 in the context of its surroundings. Processing unit 110 may use the safety model to define a context in which system 100 may execute autonomous control of vehicle 200 in a safe manner. To develop the safety model, in some embodiments, processing unit 110 may consider the position and motion of other vehicles, the detected road edges and barriers, and/or general road shape descriptions extracted from map data (such as data from map database 160). By considering additional sources of information, processing unit 110 may provide redundancy for detecting road marks and lane geometry and increase the reliability of system 100.

FIG. 5D is a flowchart showing an exemplary process 500D for detecting traffic lights in a set of images, consistent with disclosed embodiments. Processing unit 110 may execute monocular image analysis module 402 to implement process 500D. At step 560, processing unit 110 may scan the set of images and identify objects appearing at locations in the images likely to contain traffic lights. For example, processing unit 110 may filter the identified objects to construct a set of candidate objects, excluding those objects unlikely to correspond to traffic lights. The filtering may be done based on various properties associated with traffic lights, such as shape, dimensions, texture, position (e.g., relative to vehicle 200), and the like. Such properties may be based on multiple examples of traffic lights and traffic control signals and stored in a database. In some embodiments, processing unit 110 may perform multi-frame analysis on the set of candidate objects reflecting possible traffic lights. For example, processing unit 110 may track the candidate objects across consecutive image frames, estimate the real-world position of the candidate objects, and filter out those objects that are moving (which are unlikely to be traffic lights). In some embodiments, processing unit 110 may perform color analysis on the candidate objects and identify the relative position of the detected colors appearing inside possible traffic lights.

At step 562, processing unit 110 may analyze the geometry of a junction. The analysis may be based on any combination of: (i) the number of lanes detected on either side of vehicle 200, (ii) markings (such as arrow marks) detected on the road, and (iii) descriptions of the junction extracted from map data (such as data from map database 160). Processing unit 110 may conduct the analysis using information derived from execution of monocular analysis module 402. In addition, Processing unit 110 may determine a correspondence between the traffic lights detected at step 560 and the lanes appearing near vehicle 200.

As vehicle 200 approaches the junction, at step 564, processing unit 110 may update the confidence level associated with the analyzed junction geometry and the detected traffic lights. For instance, the number of traffic lights estimated to appear at the junction as compared with the number actually appearing at the junction may impact the confidence level. Thus, based on the confidence level, processing unit 110 may delegate control to the driver of vehicle 200 in order to improve safety conditions. By performing steps 560, 562, and 564, processing unit 110 may identify traffic lights appearing within the set of captured images and analyze junction geometry information. Based on the identification and the analysis, processing unit 110 may cause one or more navigational responses in vehicle 200, as described in connection with FIG. 5A, above.

FIG. 5E is a flowchart showing an exemplary process 500E for causing one or more navigational responses in vehicle 200 based on a vehicle path, consistent with the disclosed embodiments. At step 570, processing unit 110 may construct an initial vehicle path associated with vehicle 200. The vehicle path may be represented using a set of points expressed in coordinates (x, z), and the distance di between two points in the set of points may fall in the range of 1 to 5 meters. In one embodiment, processing unit 110 may construct the initial vehicle path using two polynomials, such as left and right road polynomials. Processing unit 110 may calculate the geometric midpoint between the two polynomials and offset each point included in the resultant vehicle path by a predetermined offset (e.g., a smart lane offset), if any (an offset of zero may correspond to travel in the middle of a lane). The offset may be in a direction perpendicular to a segment between any two points in the vehicle path. In another embodiment, processing unit 110 may use one polynomial and an estimated lane width to offset each point of the vehicle path by half the estimated lane width plus a predetermined offset (e.g., a smart lane offset).

At step 572, processing unit 110 may update the vehicle path constructed at step 570. Processing unit 110 may reconstruct the vehicle path constructed at step 570 using a higher resolution, such that the distance dk between two points in the set of points representing the vehicle path is less than the distance di described above. For example, the distance dk may fall in the range of 0.1 to 0.3 meters. Processing unit 110 may reconstruct the vehicle path using a parabolic spline algorithm, which may yield a cumulative distance vector S corresponding to the total length of the vehicle path (i.e., based on the set of points representing the vehicle path).

At step 574, processing unit 110 may determine a look-ahead point (expressed in coordinates as (xₗ, zₗ)) based on the updated vehicle path constructed at step 572. Processing unit 110 may extract the look-ahead point from the cumulative distance vector S, and the look-ahead point may be associated with a look-ahead distance and look-ahead time. The look-ahead distance, which may have a lower bound ranging from 10 to 20 meters, may be calculated as the product of the speed of vehicle 200 and the look-ahead time. For example, as the speed of vehicle 200 decreases, the look-ahead distance may also decrease (e.g., until it reaches the lower bound). The look-ahead time, which may range from 0.5 to 1.5 seconds, may be inversely proportional to the gain of one or more control loops associated with causing a navigational response in vehicle 200, such as the heading error tracking control loop. For example, the gain of the heading error tracking control loop may depend on the bandwidth of a yaw rate loop, a steering actuator loop, car lateral dynamics, and the like. Thus, the higher the gain of the heading error tracking control loop, the lower the look-ahead time.

At step 576, processing unit 110 may determine a heading error and yaw rate command based on the look-ahead point determined at step 574. Processing unit 110 may determine the heading error by calculating the arctangent of the look-ahead point, e.g., arctan (xₗ/zₗ). Processing unit 110 may determine the yaw rate command as the product of the heading error and a high-level control gain. The high-level control gain may be equal to: (2/look-ahead time), if the look-ahead distance is not at the lower bound. Otherwise, the high-level control gain may be equal to: (2*speed of vehicle 200/look-ahead distance).

FIG. 5F is a flowchart showing an exemplary process 500F for determining whether a leading vehicle is changing lanes, consistent with the disclosed embodiments. At step 580, processing unit 110 may determine navigation information associated with a leading vehicle (e.g., a vehicle traveling ahead of vehicle 200). For example, processing unit 110 may determine the position, velocity (e.g., direction and speed), and/or acceleration of the leading vehicle, using the techniques described in connection with FIGS. 5A and 5B, above. Processing unit 110 may also determine one or more road polynomials, a look-ahead point (associated with vehicle 200), and/or a snail trail (e.g., a set of points describing a path taken by the leading vehicle), using the techniques described in connection with FIG. 5E, above.

At step 582, processing unit 110 may analyze the navigation information determined at step 580. In one embodiment, processing unit 110 may calculate the distance between a snail trail and a road polynomial (e.g., along the trail). If the variance of this distance along the trail exceeds a predetermined threshold (for example, 0.1 to 0.2 meters on a straight road, 0.3 to 0.4 meters on a moderately curvy road, and 0.5 to 0.6 meters on a road with sharp curves), processing unit 110 may determine that the leading vehicle is likely changing lanes. In the case where multiple vehicles are detected traveling ahead of vehicle 200, processing unit 110 may compare the snail trails associated with each vehicle. Based on the comparison, processing unit 110 may determine that a vehicle whose snail trail does not match with the snail trails of the other vehicles is likely changing lanes. Processing unit 110 may additionally compare the curvature of the snail trail (associated with the leading vehicle) with the expected curvature of the road segment in which the leading vehicle is traveling. The expected curvature may be extracted from map data (e.g., data from map database 160), from road polynomials, from other vehicles' snail trails, from prior knowledge about the road, and the like. If the difference in curvature of the snail trail and the expected curvature of the road segment exceeds a predetermined threshold, processing unit 110 may determine that the leading vehicle is likely changing lanes.

In another embodiment, processing unit 110 may compare the leading vehicle's instantaneous position with the look-ahead point (associated with vehicle 200) over a specific period of time (e.g., 0.5 to 1.5 seconds). If the distance between the leading vehicle's instantaneous position and the look-ahead point varies during the specific period of time, and the cumulative sum of variation exceeds a predetermined threshold (for example, 0.3 to 0.4 meters on a straight road, 0.7 to 0.8 meters on a moderately curvy road, and 1.3 to 1.7 meters on a road with sharp curves), processing unit 110 may determine that the leading vehicle is likely changing lanes. In another embodiment, processing unit 110 may analyze the geometry of the snail trail by comparing the lateral distance traveled along the trail with the expected curvature of the snail trail. The expected radius of curvature may be determined according to the calculation: (δ_{z}²+δₓ²)/2/(δₓ), where δₓ represents the lateral distance traveled and δ_{z} represents the longitudinal distance traveled. If the difference between the lateral distance traveled and the expected curvature exceeds a predetermined threshold (e.g., 500 to 700 meters), processing unit 110 may determine that the leading vehicle is likely changing lanes. In another embodiment, processing unit 110 may analyze the position of the leading vehicle. If the position of the leading vehicle obscures a road polynomial (e.g., the leading vehicle is overlaid on top of the road polynomial), then processing unit 110 may determine that the leading vehicle is likely changing lanes. In the case where the position of the leading vehicle is such that, another vehicle is detected ahead of the leading vehicle and the snail trails of the two vehicles are not parallel, processing unit 110 may determine that the (closer) leading vehicle is likely changing lanes.

At step 584, processing unit 110 may determine whether or not leading vehicle 200 is changing lanes based on the analysis performed at step 582. For example, processing unit 110 may make the determination based on a weighted average of the individual analyses performed at step 582. Under such a scheme, for example, a decision by processing unit 110 that the leading vehicle is likely changing lanes based on a particular type of analysis may be assigned a value of “1” (and “0” to represent a determination that the leading vehicle is not likely changing lanes). Different analyses performed at step 582 may be assigned different weights, and the disclosed embodiments are not limited to any particular combination of analyses and weights.

FIG. 6 is a flowchart showing an exemplary process 600 for causing one or more navigational responses based on stereo image analysis, consistent with disclosed embodiments. At step 610, processing unit 110 may receive a first and second plurality of images via data interface 128. For example, cameras included in image acquisition unit 120 (such as image capture devices 122 and 124 having fields of view 202 and 204) may capture a first and second plurality of images of an area forward of vehicle 200 and transmit them over a digital connection (e.g., USB, wireless, Bluetooth, etc.) to processing unit 110. In some embodiments, processing unit 110 may receive the first and second plurality of images via two or more data interfaces. The disclosed embodiments are not limited to any particular data interface configurations or protocols.

At step 620, processing unit 110 may execute stereo image analysis module 404 to perform stereo image analysis of the first and second plurality of images to create a 3D map of the road in front of the vehicle and detect features within the images, such as lane markings, vehicles, pedestrians, road signs, highway exit ramps, traffic lights, road hazards, and the like. Stereo image analysis may be performed in a manner similar to the steps described in connection with FIGS. 5A-5D, above. For example, processing unit 110 may execute stereo image analysis module 404 to detect candidate objects (e.g., vehicles, pedestrians, road marks, traffic lights, road hazards, etc.) within the first and second plurality of images, filter out a subset of the candidate objects based on various criteria, and perform multi-frame analysis, construct measurements, and determine a confidence level for the remaining candidate objects. In performing the steps above, processing unit 110 may consider information from both the first and second plurality of images, rather than information from one set of images alone. For example, processing unit 110 may analyze the differences in pixel-level data (or other data subsets from among the two streams of captured images) for a candidate object appearing in both the first and second plurality of images. As another example, processing unit 110 may estimate a position and/or velocity of a candidate object (e.g., relative to vehicle 200) by observing that the object appears in one of the plurality of images but not the other or relative to other differences that may exist relative to objects appearing if the two image streams. For example, position, velocity, and/or acceleration relative to vehicle 200 may be determined based on trajectories, positions, movement characteristics, etc. of features associated with an object appearing in one or both of the image streams.

At step 630, processing unit 110 may execute navigational response module 408 to cause one or more navigational responses in vehicle 200 based on the analysis performed at step 620 and the techniques as described above in connection with FIG. 4. Navigational responses may include, for example, a turn, a lane shift, a change in acceleration, a change in velocity, braking, and the like. In some embodiments, processing unit 110 may use data derived from execution of velocity and acceleration module 406 to cause the one or more navigational responses. Additionally, multiple navigational responses may occur simultaneously, in sequence, or any combination thereof.

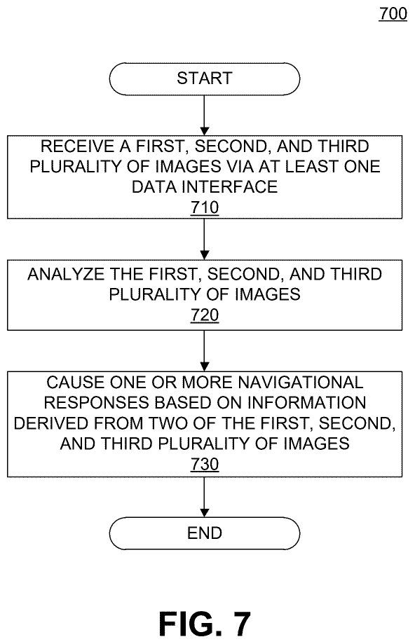

FIG. 7 is a flowchart showing an exemplary process 700 for causing one or more navigational responses based on an analysis of three sets of images, consistent with disclosed embodiments. At step 710, processing unit 110 may receive a first, second, and third plurality of images via data interface 128. For instance, cameras included in image acquisition unit 120 (such as image capture devices 122, 124, and 126 having fields of view 202, 204, and 206) may capture a first, second, and third plurality of images of an area forward and/or to the side of vehicle 200 and transmit them over a digital connection (e.g., USB, wireless, Bluetooth, etc.) to processing unit 110. In some embodiments, processing unit 110 may receive the first, second, and third plurality of images via three or more data interfaces. For example, each of image capture devices 122, 124, 126 may have an associated data interface for communicating data to processing unit 110. The disclosed embodiments are not limited to any particular data interface configurations or protocols.

At step 720, processing unit 110 may analyze the first, second, and third plurality of images to detect features within the images, such as lane markings, vehicles, pedestrians, road signs, highway exit ramps, traffic lights, road hazards, and the like. The analysis may be performed in a manner similar to the steps described in connection with FIGS. 5A-5D and 6, above. For instance, processing unit 110 may perform monocular image analysis (e.g., via execution of monocular image analysis module 402 and based on the steps described in connection with FIGS. 5A-5D, above) on each of the first, second, and third plurality of images. Alternatively, processing unit 110 may perform stereo image analysis (e.g., via execution of stereo image analysis module 404 and based on the steps described in connection with FIG. 6, above) on the first and second plurality of images, the second and third plurality of images, and/or the first and third plurality of images. The processed information corresponding to the analysis of the first, second, and/or third plurality of images may be combined. In some embodiments, processing unit 110 may perform a combination of monocular and stereo image analyses. For example, processing unit 110 may perform monocular image analysis (e.g., via execution of monocular image analysis module 402) on the first plurality of images and stereo image analysis (e.g., via execution of stereo image analysis module 404) on the second and third plurality of images. The configuration of image capture devices 122, 124, and 126—including their respective locations and fields of view 202, 204, and 206—may influence the types of analyses conducted on the first, second, and third plurality of images. The disclosed embodiments are not limited to a particular configuration of image capture devices 122, 124, and 126, or the types of analyses conducted on the first, second, and third plurality of images.

In some embodiments, processing unit 110 may perform testing on system 100 based on the images acquired and analyzed at steps 710 and 720. Such testing may provide an indicator of the overall performance of system 100 for certain configurations of image capture devices 122, 124, and 126. For example, processing unit 110 may determine the proportion of “false hits” (e.g., cases where system 100 incorrectly determined the presence of a vehicle or pedestrian) and “misses.”

At step 730, processing unit 110 may cause one or more navigational responses in vehicle 200 based on information derived from two of the first, second, and third plurality of images. Selection of two of the first, second, and third plurality of images may depend on various factors, such as, for example, the number, types, and sizes of objects detected in each of the plurality of images. Processing unit 110 may also make the selection based on image quality and resolution, the effective field of view reflected in the images, the number of captured frames, the extent to which one or more objects of interest actually appear in the frames (e.g., the percentage of frames in which an object appears, the proportion of the object that appears in each such frame, etc.), and the like.

In some embodiments, processing unit 110 may select information derived from two of the first, second, and third plurality of images by determining the extent to which information derived from one image source is consistent with information derived from other image sources. For example, processing unit 110 may combine the processed information derived from each of image capture devices 122, 124, and 126 (whether by monocular analysis, stereo analysis, or any combination of the two) and determine visual indicators (e.g., lane markings, a detected vehicle and its location and/or path, a detected traffic light, etc.) that are consistent across the images captured from each of image capture devices 122, 124, and 126. Processing unit 110 may also exclude information that is inconsistent across the captured images (e.g., a vehicle changing lanes, a lane model indicating a vehicle that is too close to vehicle 200, etc.). Thus, processing unit 110 may select information derived from two of the first, second, and third plurality of images based on the determinations of consistent and inconsistent information.

Navigational responses may include, for example, a turn, a lane shift, a change in acceleration, and the like. Processing unit 110 may cause the one or more navigational responses based on the analysis performed at step 720 and the techniques as described above in connection with FIG. 4. Processing unit 110 may also use data derived from execution of velocity and acceleration module 406 to cause the one or more navigational responses. In some embodiments, processing unit 110 may cause the one or more navigational responses based on a relative position, relative velocity, and/or relative acceleration between vehicle 200 and an object detected within any of the first, second, and third plurality of images. Multiple navigational responses may occur simultaneously, in sequence, or any combination thereof.

### Sparse Road Model for Autonomous Vehicle Navigation

In some embodiments, the disclosed systems and methods may use a sparse map for autonomous vehicle navigation. In particular, the sparse map may be for autonomous vehicle navigation along a road segment. For example, the sparse map may provide sufficient information for navigating an autonomous vehicle without storing and/or updating a large quantity of data. As discussed below in further detail, an autonomous vehicle may use the sparse map to navigate one or more roads based on one or more stored trajectories.

### Sparse Map for Autonomous Vehicle Navigation

In some embodiments, the disclosed systems and methods may generate a sparse map for autonomous vehicle navigation. For example, the sparse map may provide sufficient information for navigation without requiring excessive data storage or data transfer rates. As discussed below in further detail, a vehicle (which may be an autonomous vehicle) may use the sparse map to navigate one or more roads. For example, in some embodiments, the sparse map may include data related to a road and potentially landmarks along the road that may be sufficient for vehicle navigation, but which also exhibit small data footprints. For example, the sparse data maps described in detail below may require significantly less storage space and data transfer bandwidth as compared with digital maps including detailed map information, such as image data collected along a road.

For example, rather than storing detailed representations of a road segment, the sparse data map may store three-dimensional polynomial representations of preferred vehicle paths along a road. These paths may require very little data storage space. Further, in the described sparse data maps, landmarks may be identified and included in the sparse map road model to aid in navigation. These landmarks may be located at any spacing suitable for enabling vehicle navigation, but in some cases, such landmarks need not be identified and included in the model at high densities and short spacings. Rather, in some cases, navigation may be possible based on landmarks that are spaced apart by at least 50 meters, at least 100 meters, at least 500 meters, at least 1 kilometer, or at least 2 kilometers. As will be discussed in more detail in other sections, the sparse map may be generated based on data collected or measured by vehicles equipped with various sensors and devices, such as image capture devices, Global Positioning System sensors, motion sensors, etc., as the vehicles travel along roadways. In some cases, the sparse map may be generated based on data collected during multiple drives of one or more vehicles along a particular roadway. Generating a sparse map using multiple drives of one or more vehicles may be referred to as “crowdsourcing” a sparse map.

Consistent with disclosed embodiments, an autonomous vehicle system may use a sparse map for navigation. For example, the disclosed systems and methods may distribute a sparse map for generating a road navigation model for an autonomous vehicle and may navigate an autonomous vehicle along a road segment using a sparse map and/or a generated road navigation model. Sparse maps consistent with the present disclosure may include one or more three-dimensional contours that may represent predetermined trajectories that autonomous vehicles may traverse as they move along associated road segments.

Sparse maps consistent with the present disclosure may also include data representing one or more road features. Such road features may include recognized landmarks, road signature profiles, and any other road-related features useful in navigating a vehicle. Sparse maps consistent with the present disclosure may enable autonomous navigation of a vehicle based on relatively small amounts of data included in the sparse map. For example, rather than including detailed representations of a road, such as road edges, road curvature, images associated with road segments, or data detailing other physical features associated with a road segment, the disclosed embodiments of the sparse map may require relatively little storage space (and relatively little bandwidth when portions of the sparse map are transferred to a vehicle) but may still adequately provide for autonomous vehicle navigation. The small data footprint of the disclosed sparse maps, discussed in further detail below, may be achieved in some embodiments by storing representations of road-related elements that require small amounts of data but still enable autonomous navigation.

For example, rather than storing detailed representations of various aspects of a road, the disclosed sparse maps may store polynomial representations of one or more trajectories that a vehicle may follow along the road. Thus, rather than storing (or having to transfer) details regarding the physical nature of the road to enable navigation along the road, using the disclosed sparse maps, a vehicle may be navigated along a particular road segment without, in some cases, having to interpret physical aspects of the road, but rather, by aligning its path of travel with a trajectory (e.g., a polynomial spline) along the particular road segment. In this way, the vehicle may be navigated based mainly upon the stored trajectory (e.g., a polynomial spline) that may require much less storage space than an approach involving storage of roadway images, road parameters, road layout, etc.

In addition to the stored polynomial representations of trajectories along a road segment, the disclosed sparse maps may also include small data objects that may represent a road feature. In some embodiments, the small data objects may include digital signatures, which are derived from a digital image (or a digital signal) that was obtained by a sensor (e.g., a camera or other sensor, such as a suspension sensor) onboard a vehicle traveling along the road segment. The digital signature may have a reduced size relative to the signal that was acquired by the sensor. In some embodiments, the digital signature may be created to be compatible with a classifier function that is configured to detect and to identify the road feature from the signal that is acquired by the sensor, for example, during a subsequent drive. In some embodiments, a digital signature may be created such that the digital signature has a footprint that is as small as possible, while retaining the ability to correlate or match the road feature with the stored signature based on an image (or a digital signal generated by a sensor, if the stored signature is not based on an image and/or includes other data) of the road feature that is captured by a camera onboard a vehicle traveling along the same road segment at a subsequent time.

In some embodiments, a size of the data objects may be further associated with a uniqueness of the road feature. For example, for a road feature that is detectable by a camera onboard a vehicle, and where the camera system onboard the vehicle is coupled to a classifier that is capable of distinguishing the image data corresponding to that road feature as being associated with a particular type of road feature, for example, a road sign, and where such a road sign is locally unique in that area (e.g., there is no identical road sign or road sign of the same type nearby), it may be sufficient to store data indicating the type of the road feature and its location.

As will be discussed in further detail below, road features (e.g., landmarks along a road segment) may be stored as small data objects that may represent a road feature in relatively few bytes, while at the same time providing sufficient information for recognizing and using such a feature for navigation. In one example, a road sign may be identified as a recognized landmark on which navigation of a vehicle may be based. A representation of the road sign may be stored in the sparse map to include, e.g., a few bytes of data indicating a type of landmark (e.g., a stop sign) and a few bytes of data indicating a location of the landmark (e.g., coordinates). Navigating based on such data-light representations of the landmarks (e.g., using representations sufficient for locating, recognizing, and navigating based upon the landmarks) may provide a desired level of navigational functionality associated with sparse maps without significantly increasing the data overhead associated with the sparse maps. This lean representation of landmarks (and other road features) may take advantage of the sensors and processors included onboard such vehicles that are configured to detect, identify, and/or classify certain road features.

When, for example, a sign or even a particular type of a sign is locally unique (e.g., when there is no other sign or no other sign of the same type) in a given area, the sparse map may use data indicating a type of a landmark (a sign or a specific type of sign), and during navigation (e.g., autonomous navigation) when a camera onboard an autonomous vehicle captures an image of the area including a sign (or of a specific type of sign), the processor may process the image, detect the sign (if indeed present in the image), classify the image as a sign (or as a specific type of sign), and correlate the location of the image with the location of the sign as stored in the sparse map.

The sparse map may include any suitable representation of objects identified along a road segment. In some cases, the objects may be referred to as semantic objects or non-semantic objects. Semantic objects may include, for example, objects associated with a predetermined type classification. This type classification may be useful in reducing the amount of data required to describe the semantic object recognized in an environment, which can be beneficial both in the harvesting phase (e.g., to reduce costs associated with bandwidth use for transferring drive information from a plurality of harvesting vehicles to a server) and during the navigation phase (e.g., reduction of map data can speed transfer of map tiles from a server to a navigating vehicle and can also reduce costs associated with bandwidth use for such transfers). Semantic object classification types may be assigned to any type of objects or features that are expected to be encountered along a roadway.

Semantic objects may further be divided into two or more logical groups. For example, in some cases, one group of semantic object types may be associated with predetermined dimensions. Such semantic objects may include certain speed limit signs, yield signs, merge signs, stop signs, traffic lights, directional arrows on a roadway, manhole covers, or any other type of object that may be associated with a standardized size. One benefit offered by such semantic objects is that very little data may be needed to represent/fully define the objects. For example, if a standardized size of a speed limit size is known, then a harvesting vehicle may need only identify (through analysis of a captured image) the presence of a speed limit sign (a recognized type) along with an indication of a position of the detected speed limit sign (e.g., a 2D position in the captured image (or, alternatively, a 3D position in real world coordinates) of a center of the sign or a certain corner of the sign) to provide sufficient information for map generation on the server side. Where 2D image positions are transmitted to the server, a position associated with the captured image where the sign was detected may also be transmitted so the server can determine a real-world position of the sign (e.g., through structure in motion techniques using multiple captured images from one or more harvesting vehicles). Even with this limited information (requiring just a few bytes to define each detected object), the server may construct the map including a fully represented speed limit sign based on the type classification (representative of a speed limit sign) received from one or more harvesting vehicles along with the position information for the detected sign.

Semantic objects may also include other recognized object or feature types that are not associated with certain standardized characteristics. Such objects or features may include potholes, tar seams, light poles, non-standardized signs, curbs, trees, tree branches, or any other type of recognized object type with one or more variable characteristics (e.g., variable dimensions). In such cases, in addition to transmitting to a server an indication of the detected object or feature type (e.g., pothole, pole, etc.) and position information for the detected object or feature, a harvesting vehicle may also transmit an indication of a size of the object or feature. The size may be expressed in 2D image dimensions (e.g., with a bounding box or one or more dimension values) or real-world dimensions (determined through structure in motion calculations, based on LIDAR or RADAR system outputs, based on trained neural network outputs, etc.).

Non-semantic objects or features may include any detectable objects or features that fall outside of a recognized category or type, but that still may provide valuable information in map generation. In some cases, such non-semantic features may include a detected corner of a building or a corner of a detected window of a building, a unique stone or object near a roadway, a concrete splatter in a roadway shoulder, or any other detectable object or feature. Upon detecting such an object or feature one or more harvesting vehicles may transmit to a map generation server a location of one or more points (2D image points or 3D real world points) associated with the detected object/feature. Additionally, a compressed or simplified image segment (e.g., an image hash) may be generated for a region of the captured image including the detected object or feature. This image hash may be calculated based on a predetermined image processing algorithm and may form an effective signature for the detected non-semantic object or feature. Such a signature may be useful for navigation relative to a sparse map including the non-semantic feature or object, as a vehicle traversing the roadway may apply an algorithm similar to the algorithm used to generate the image hash in order to confirm/verify the presence in a captured image of the mapped non-semantic feature or object. Using this technique, non-semantic features may add to the richness of the sparse maps (e.g., to enhance their usefulness in navigation) without adding significant data overhead.

As noted, target trajectories may be stored in the sparse map. These target trajectories (e.g., 3D splines) may represent the preferred or recommended paths for each available lane of a roadway, each valid pathway through a junction, for merges and exits, etc. In addition to target trajectories, other road feature may also be detected, harvested, and incorporated in the sparse maps in the form of representative splines. Such features may include, for example, road edges, lane markings, curbs, guardrails, or any other objects or features that extend along a roadway or road segment.

### Generating a Sparse Map

In some embodiments, a sparse map may include at least one line representation of a road surface feature extending along a road segment and a plurality of landmarks associated with the road segment. In certain aspects, the sparse map may be generated via “crowdsourcing,” for example, through image analysis of a plurality of images acquired as one or more vehicles traverse the road segment.

FIG. 8 shows a sparse map 800 that one or more vehicles, e.g., vehicle 200 (which may be an autonomous vehicle), may access for providing autonomous vehicle navigation. Sparse map 800 may be stored in a memory, such as memory 140 or 150. Such memory devices may include any types of non-transitory storage devices or computer-readable media. For example, in some embodiments, memory 140 or 150 may include hard drives, compact discs, flash memory, magnetic based memory devices, optical based memory devices, etc. In some embodiments, sparse map 800 may be stored in a database (e.g., map database 160) that may be stored in memory 140 or 150, or other types of storage devices.

In some embodiments, sparse map 800 may be stored on a storage device or a non-transitory computer-readable medium provided onboard vehicle 200 (e.g., a storage device included in a navigation system onboard vehicle 200). A processor (e.g., processing unit 110) provided on vehicle 200 may access sparse map 800 stored in the storage device or computer-readable medium provided onboard vehicle 200 in order to generate navigational instructions for guiding the autonomous vehicle 200 as the vehicle traverses a road segment.

Sparse map 800 need not be stored locally with respect to a vehicle, however. In some embodiments, sparse map 800 may be stored on a storage device or computer-readable medium provided on a remote server that communicates with vehicle 200 or a device associated with vehicle 200. A processor (e.g., processing unit 110) provided on vehicle 200 may receive data included in sparse map 800 from the remote server and may execute the data for guiding the autonomous driving of vehicle 200. In such embodiments, the remote server may store all of sparse map 800 or only a portion thereof. Accordingly, the storage device or computer-readable medium provided onboard vehicle 200 and/or onboard one or more additional vehicles may store the remaining portion(s) of sparse map 800.

Furthermore, in such embodiments, sparse map 800 may be made accessible to a plurality of vehicles traversing various road segments (e.g., tens, hundreds, thousands, or millions of vehicles, etc.). It should be noted also that sparse map 800 may include multiple sub-maps. For example, in some embodiments, sparse map 800 may include hundreds, thousands, millions, or more, of sub-maps (e.g., map tiles) that may be used in navigating a vehicle. Such sub-maps may be referred to as local maps or map tiles, and a vehicle traveling along a roadway may access any number of local maps relevant to a location in which the vehicle is traveling. The local map sections of sparse map 800 may be stored with a Global Navigation Satellite System (GNSS) key as an index to the database of sparse map 800. Thus, while computation of steering angles for navigating a host vehicle in the present system may be performed without reliance upon a GNSS position of the host vehicle, road features, or landmarks, such GNSS information may be used for retrieval of relevant local maps.

In general, sparse map 800 may be generated based on data (e.g., drive information) collected from one or more vehicles as they travel along roadways. For example, using sensors aboard the one or more vehicles (e.g., cameras, speedometers, GPS, accelerometers, etc.), the trajectories that the one or more vehicles travel along a roadway may be recorded, and the polynomial representation of a preferred trajectory for vehicles making subsequent trips along the roadway may be determined based on the collected trajectories travelled by the one or more vehicles. Similarly, data collected by the one or more vehicles may aid in identifying potential landmarks along a particular roadway. Data collected from traversing vehicles may also be used to identify road profile information, such as road width profiles, road roughness profiles, traffic line spacing profiles, road conditions, etc. Using the collected information, sparse map 800 may be generated and distributed (e.g., for local storage or via on-the-fly data transmission) for use in navigating one or more autonomous vehicles. However, in some embodiments, map generation may not end upon initial generation of the map. As will be discussed in greater detail below, sparse map 800 may be continuously or periodically updated based on data collected from vehicles as those vehicles continue to traverse roadways included in sparse map 800.

Data recorded in sparse map 800 may include position information based on Global Positioning System (GPS) data. For example, location information may be included in sparse map 800 for various map elements, including, for example, landmark locations, road profile locations, etc. Locations for map elements included in sparse map 800 may be obtained using GPS data collected from vehicles traversing a roadway. For example, a vehicle passing an identified landmark may determine a location of the identified landmark using GPS position information associated with the vehicle and a determination of a location of the identified landmark relative to the vehicle (e.g., based on image analysis of data collected from one or more cameras on board the vehicle). Such location determinations of an identified landmark (or any other feature included in sparse map 800) may be repeated as additional vehicles pass the location of the identified landmark. Some or all of the additional location determinations may be used to refine the location information stored in sparse map 800 relative to the identified landmark. For example, in some embodiments, multiple position measurements relative to a particular feature stored in sparse map 800 may be averaged together. Any other mathematical operations, however, may also be used to refine a stored location of a map element based on a plurality of determined locations for the map element.

In a particular example, harvesting vehicles may traverse a particular road segment. Each harvesting vehicle captures images of their respective environments. The images may be collected at any suitable frame capture rate (e.g., 9 Hz, etc.). Image analysis processor(s) aboard each harvesting vehicle analyze the captured images to detect the presence of semantic and/or non-semantic features/objects. At a high level, the harvesting vehicles transmit to a mapping-server indications of detections of the semantic and/or non-semantic objects/features along with positions associated with those objects/features. In more detail, type indicators, dimension indicators, etc. may be transmitted together with the position information. The position information may include any suitable information for enabling the mapping server to aggregate the detected objects/features into a sparse map useful in navigation. In some cases, the position information may include one or more 2D image positions (e.g., X-Y pixel locations) in a captured image where the semantic or non-semantic features/objects were detected. Such image positions may correspond to a center of the feature/object, a corner, etc. In this scenario, to aid the mapping server in reconstructing the drive information and aligning the drive information from multiple harvesting vehicles, each harvesting vehicle may also provide the server with a location (e.g., a GPS location) where each image was captured.

In other cases, the harvesting vehicle may provide to the server one or more 3D real world points associated with the detected objects/features. Such 3D points may be relative to a predetermined origin (such as an origin of a drive segment) and may be determined through any suitable technique. In some cases, a structure in motion technique may be used to determine the 3D real world position of a detected object/feature. For example, a certain object such as a particular speed limit sign may be detected in two or more captured images. Using information such as the known ego motion (speed, trajectory, GPS position, etc.) of the harvesting vehicle between the captured images, along with observed changes of the speed limit sign in the captured images (change in X-Y pixel location, change in size, etc.), the real-world position of one or more points associated with the speed limit sign may be determined and passed along to the mapping server. Such an approach is optional, as it requires more computation on the part of the harvesting vehicle systems. The sparse map of the disclosed embodiments may enable autonomous navigation of a vehicle using relatively small amounts of stored data. In some embodiments, sparse map 800 may have a data density (e.g., including data representing the target trajectories, landmarks, and any other stored road features) of less than 2 MB per kilometer of roads, less than 1 MB per kilometer of roads, less than 500 kB per kilometer of roads, or less than 100 kB per kilometer of roads. In some embodiments, the data density of sparse map 800 may be less than 10 kB per kilometer of roads or even less than 2 kB per kilometer of roads (e.g., 1.6 kB per kilometer), or no more than 10 kB per kilometer of roads, or no more than 20 kB per kilometer of roads. In some embodiments, most, if not all, of the roadways of the United States may be navigated autonomously using a sparse map having a total of 4 GB or less of data. These data density values may represent an average over an entire sparse map 800, over a local map within sparse map 800, and/or over a particular road segment within sparse map 800.

As noted, sparse map 800 may include representations of a plurality of target trajectories 810 for guiding autonomous driving or navigation along a road segment. Such target trajectories may be stored as three-dimensional splines. The target trajectories stored in sparse map 800 may be determined based on two or more reconstructed trajectories of prior traversals of vehicles along a particular road segment, for example. A road segment may be associated with a single target trajectory or multiple target trajectories. For example, on a two lane road, a first target trajectory may be stored to represent an intended path of travel along the road in a first direction, and a second target trajectory may be stored to represent an intended path of travel along the road in another direction (e.g., opposite to the first direction). Additional target trajectories may be stored with respect to a particular road segment. For example, on a multi-lane road one or more target trajectories may be stored representing intended paths of travel for vehicles in one or more lanes associated with the multi-lane road. In some embodiments, each lane of a multi-lane road may be associated with its own target trajectory. In other embodiments, there may be fewer target trajectories stored than lanes present on a multi-lane road. In such cases, a vehicle navigating the multi-lane road may use any of the stored target trajectories to guides its navigation by taking into account an amount of lane offset from a lane for which a target trajectory is stored (e.g., if a vehicle is traveling in the left most lane of a three lane highway, and a target trajectory is stored only for the middle lane of the highway, the vehicle may navigate using the target trajectory of the middle lane by accounting for the amount of lane offset between the middle lane and the left-most lane when generating navigational instructions).

In some embodiments, the target trajectory may represent an ideal path that a vehicle should take as the vehicle travels. The target trajectory may be located, for example, at an approximate center of a lane of travel. In other cases, the target trajectory may be located elsewhere relative to a road segment. For example, a target trajectory may approximately coincide with a center of a road, an edge of a road, or an edge of a lane, etc. In such cases, navigation based on the target trajectory may include a determined amount of offset to be maintained relative to the location of the target trajectory. Moreover, in some embodiments, the determined amount of offset to be maintained relative to the location of the target trajectory may differ based on a type of vehicle (e.g., a passenger vehicle including two axles may have a different offset from a truck including more than two axles along at least a portion of the target trajectory).

Sparse map 800 may also include data relating to a plurality of predetermined landmarks 820 associated with particular road segments, local maps, etc. As discussed in greater detail below, these landmarks may be used in navigation of the autonomous vehicle. For example, in some embodiments, the landmarks may be used to determine a current position of the vehicle relative to a stored target trajectory. With this position information, the autonomous vehicle may be able to adjust a heading direction to match a direction of the target trajectory at the determined location.

The plurality of landmarks 820 may be identified and stored in sparse map 800 at any suitable spacing. In some embodiments, landmarks may be stored at relatively high densities (e.g., every few meters or more). In some embodiments, however, significantly larger landmark spacing values may be employed. For example, in sparse map 800, identified (or recognized) landmarks may be spaced apart by 10 meters, 20 meters, 50 meters, 100 meters, 1 kilometer, or 2 kilometers. In some cases, the identified landmarks may be located at distances of even more than 2 kilometers apart.

Between landmarks, and therefore between determinations of vehicle position relative to a target trajectory, the vehicle may navigate based on dead reckoning in which the vehicle uses sensors to determine its ego motion and estimate its position relative to the target trajectory. Because errors may accumulate during navigation by dead reckoning, over time the position determinations relative to the target trajectory may become increasingly less accurate. The vehicle may use landmarks occurring in sparse map 800 (and their known locations) to remove the dead reckoning-induced errors in position determination. In this way, the identified landmarks included in sparse map 800 may serve as navigational anchors from which an accurate position of the vehicle relative to a target trajectory may be determined. Because a certain amount of error may be acceptable in position location, an identified landmark need not always be available to an autonomous vehicle. Rather, suitable navigation may be possible even based on landmark spacings, as noted above, of 10 meters, 20 meters, 50 meters, 100 meters, 500 meters, 1 kilometer, 2 kilometers, or more. In some embodiments, a density of 1 identified landmark every 1 km of road may be sufficient to maintain a longitudinal position determination accuracy within 1 m. Thus, not every potential landmark appearing along a road segment need be stored in sparse map 800.

Moreover, in some embodiments, lane markings may be used for localization of the vehicle during landmark spacings. By using lane markings during landmark spacings, the accumulation of errors during navigation by dead reckoning may be minimized.

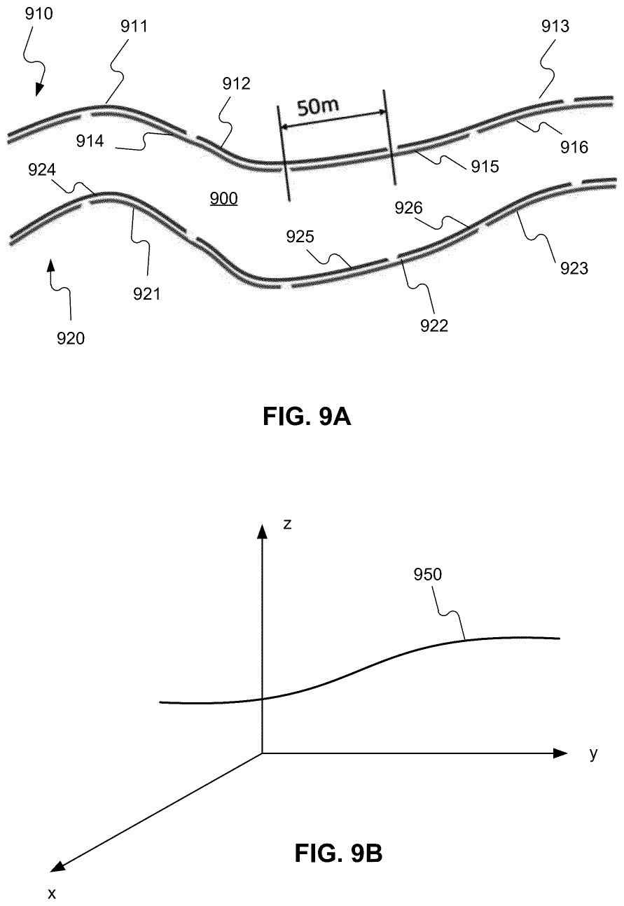

In addition to target trajectories and identified landmarks, sparse map 800 may include information relating to various other road features. For example, FIG. 9A illustrates a representation of curves along a particular road segment that may be stored in sparse map 800. In some embodiments, a single lane of a road may be modeled by a three-dimensional polynomial description of left and right sides of the road. Such polynomials representing left and right sides of a single lane are shown in FIG. 9A. Regardless of how many lanes a road may have, the road may be represented using polynomials in a way similar to that illustrated in FIG. 9A. For example, left and right sides of a multi-lane road may be represented by polynomials similar to those shown in FIG. 9A, and intermediate lane markings included on a multi-lane road (e.g., dashed markings representing lane boundaries, solid yellow lines representing boundaries between lanes traveling in different directions, etc.) may also be represented using polynomials such as those shown in FIG. 9A.

As shown in FIG. 9A, a lane 900 may be represented using polynomials (e.g., a first order, second order, third order, or any suitable order polynomials). For illustration, lane 900 is shown as a two-dimensional lane and the polynomials are shown as two-dimensional polynomials. As depicted in FIG. 9A, lane 900 includes a left side 910 and a right side 920. In some embodiments, more than one polynomial may be used to represent a location of each side of the road or lane boundary. For example, each of left side 910 and right side 920 may be represented by a plurality of polynomials of any suitable length. In some cases, the polynomials may have a length of about 100 m, although other lengths greater than or less than 100 m may also be used. Additionally, the polynomials can overlap with one another in order to facilitate seamless transitions in navigating based on subsequently encountered polynomials as a host vehicle travels along a roadway. For example, each of left side 910 and right side 920 may be represented by a plurality of third order polynomials separated into segments of about 100 meters in length (an example of the first predetermined range), and overlapping each other by about 50 meters. The polynomials representing the left side 910 and the right side 920 may or may not have the same order. For example, in some embodiments, some polynomials may be second order polynomials, some may be third order polynomials, and some may be fourth order polynomials.

In the example shown in FIG. 9A, left side 910 of lane 900 is represented by two groups of third order polynomials. The first group includes polynomial segments 911, 912, and 913. The second group includes polynomial segments 914, 915, and 916. The two groups, while substantially parallel to each other, follow the locations of their respective sides of the road. Polynomial segments 911, 912, 913, 914, 915, and 916 have a length of about 100 meters and overlap adjacent segments in the series by about 50 meters. As noted previously, however, polynomials of different lengths and different overlap amounts may also be used. For example, the polynomials may have lengths of 500 m, 1 km, or more, and the overlap amount may vary from 0 to 50 m, 50 m to 100 m, or greater than 100 m. Additionally, while FIG. 9A is shown as representing polynomials extending in 2D space (e.g., on the surface of the paper), it is to be understood that these polynomials may represent curves extending in three dimensions (e.g., including a height component) to represent elevation changes in a road segment in addition to X-Y curvature. In the example shown in FIG. 9A, right side 920 of lane 900 is further represented by a first group having polynomial segments 921, 922, and 923 and a second group having polynomial segments 924, 925, and 926.

Returning to the target trajectories of sparse map 800, FIG. 9B shows a three-dimensional polynomial representing a target trajectory for a vehicle traveling along a particular road segment. The target trajectory represents not only the X-Y path that a host vehicle should travel along a particular road segment, but also the elevation change that the host vehicle will experience when traveling along the road segment. Thus, each target trajectory in sparse map 800 may be represented by one or more three-dimensional polynomials, like the three-dimensional polynomial 950 shown in FIG. 9B. Sparse map 800 may include a plurality of trajectories (e.g., millions or billions or more to represent trajectories of vehicles along various road segments along roadways throughout the world). In some embodiments, each target trajectory may correspond to a spline connecting three-dimensional polynomial segments.

Regarding the data footprint of polynomial curves stored in sparse map 800, in some embodiments, each third degree polynomial may be represented by four parameters, each requiring four bytes of data. Suitable representations may be obtained with third degree polynomials requiring about 192 bytes of data for every 100 m. This may translate to approximately 200 kB per hour in data usage/transfer requirements for a host vehicle traveling approximately 100 km/hr.

Sparse map 800 may describe the lanes network using a combination of geometry descriptors and meta-data. The geometry may be described by polynomials or splines as described above. The meta-data may describe the number of lanes, special characteristics (such as a car pool lane), and possibly other sparse labels. The total footprint of such indicators may be negligible.

Accordingly, a sparse map according to embodiments of the present disclosure may include at least one line representation of a road surface feature extending along the road segment, each line representation representing a path along the road segment substantially corresponding with the road surface feature. In some embodiments, as discussed above, the at least one line representation of the road surface feature may include a spline, a polynomial representation, or a curve. Furthermore, in some embodiments, the road surface feature may include at least one of a road edge or a lane marking. Moreover, as discussed below with respect to “crowdsourcing,” the road surface feature may be identified through image analysis of a plurality of images acquired as one or more vehicles traverse the road segment.

As previously noted, sparse map 800 may include a plurality of predetermined landmarks associated with a road segment. Rather than storing actual images of the landmarks and relying, for example, on image recognition analysis based on captured images and stored images, each landmark in sparse map 800 may be represented and recognized using less data than a stored, actual image would require. Data representing landmarks may still include sufficient information for describing or identifying the landmarks along a road. Storing data describing characteristics of landmarks, rather than the actual images of landmarks, may reduce the size of sparse map 800.

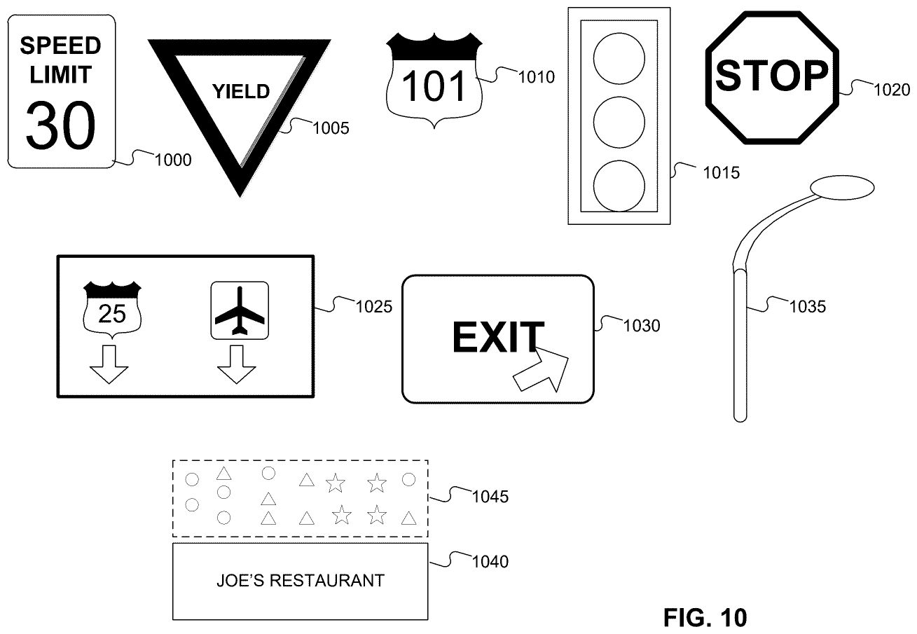

FIG. 10 illustrates examples of types of landmarks that may be represented in sparse map 800. The landmarks may include any visible and identifiable objects along a road segment. The landmarks may be selected such that they are fixed and do not change often with respect to their locations and/or content. The landmarks included in sparse map 800 may be useful in determining a location of vehicle 200 with respect to a target trajectory as the vehicle traverses a particular road segment. Examples of landmarks may include traffic signs, directional signs, general signs (e.g., rectangular signs), roadside fixtures (e.g., lampposts, reflectors, etc.), and any other suitable category. In some embodiments, lane marks on the road, may also be included as landmarks in sparse map 800.

Examples of landmarks shown in FIG. 10 include traffic signs, directional signs, roadside fixtures, and general signs. Traffic signs may include, for example, speed limit signs (e.g., speed limit sign 1000), yield signs (e.g., yield sign 1005), route number signs (e.g., route number sign 1010), traffic light signs (e.g., traffic light sign 1015), stop signs (e.g., stop sign 1020). Directional signs may include a sign that includes one or more arrows indicating one or more directions to different places. For example, directional signs may include a highway sign 1025 having arrows for directing vehicles to different roads or places, an exit sign 1030 having an arrow directing vehicles off a road, etc. Accordingly, at least one of the plurality of landmarks may include a road sign.

General signs may be unrelated to traffic. For example, general signs may include billboards used for advertisement, or a welcome board adjacent a border between two countries, states, counties, cities, or towns. FIG. 10 shows a general sign 1040 (“Joe's Restaurant”). Although general sign 1040 may have a rectangular shape, as shown in FIG. 10, general sign 1040 may have other shapes, such as square, circle, triangle, etc.

Landmarks may also include roadside fixtures. Roadside fixtures may be objects that are not signs, and may not be related to traffic or directions. For example, roadside fixtures may include lampposts (e.g., lamppost 1035), power line posts, traffic light posts, etc.

Landmarks may also include beacons that may be specifically designed for usage in an autonomous vehicle navigation system. For example, such beacons may include stand-alone structures placed at predetermined intervals to aid in navigating a host vehicle. Such beacons may also include visual/graphical information added to existing road signs (e.g., icons, emblems, bar codes, etc.) that may be identified or recognized by a vehicle traveling along a road segment. Such beacons may also include electronic components. In such embodiments, electronic beacons (e.g., RFID tags, etc.) may be used to transmit non-visual information to a host vehicle. Such information may include, for example, landmark identification and/or landmark location information that a host vehicle may use in determining its position along a target trajectory.

In some embodiments, the landmarks included in sparse map 800 may be represented by a data object of a predetermined size. The data representing a landmark may include any suitable parameters for identifying a particular landmark. For example, in some embodiments, landmarks stored in sparse map 800 may include parameters such as a physical size of the landmark (e.g., to support estimation of distance to the landmark based on a known size/scale), a distance to a previous landmark, lateral offset, height, a type code (e.g., a landmark type-what type of directional sign, traffic sign, etc.), a GPS coordinate (e.g., to support global localization), and any other suitable parameters. Each parameter may be associated with a data size. For example, a landmark size may be stored using 8 bytes of data. A distance to a previous landmark, a lateral offset, and height may be specified using 12 bytes of data. A type code associated with a landmark such as a directional sign or a traffic sign may require about 2 bytes of data. For general signs, an image signature enabling identification of the general sign may be stored using 50 bytes of data storage. The landmark GPS position may be associated with 16 bytes of data storage. These data sizes for each parameter are examples only, and other data sizes may also be used. Representing landmarks in sparse map 800 in this manner may offer a lean solution for efficiently representing landmarks in the database. In some embodiments, objects may be referred to as standard semantic objects or non-standard semantic objects. A standard semantic object may include any class of object for which there's a standardized set of characteristics (e.g., speed limit signs, warning signs, directional signs, traffic lights, etc. having known dimensions or other characteristics). A non-standard semantic object may include any object that is not associated with a standardized set of characteristics (e.g., general advertising signs, signs identifying business establishments, potholes, trees, etc. that may have variable dimensions). Each non-standard semantic object may be represented with 38 bytes of data (e.g., 8 bytes for size; 12 bytes for distance to previous landmark, lateral offset, and height; 2 bytes for a type code; and 16 bytes for position coordinates). Standard semantic objects may be represented using even less data, as size information may not be needed by the mapping server to fully represent the object in the sparse map.

Sparse map 800 may use a tag system to represent landmark types. In some cases, each traffic sign or directional sign may be associated with its own tag, which may be stored in the database as part of the landmark identification. For example, the database may include on the order of 1000 different tags to represent various traffic signs and on the order of about 10000 different tags to represent directional signs. Of course, any suitable number of tags may be used, and additional tags may be created as needed. General purpose signs may be represented in some embodiments using less than about 100 bytes (e.g., about 86 bytes including 8 bytes for size; 12 bytes for distance to previous landmark, lateral offset, and height; 50 bytes for an image signature; and 16 bytes for GPS coordinates).

Thus, for semantic road signs not requiring an image signature, the data density impact to sparse map 800, even at relatively high landmark densities of about 1 per 50 m, may be on the order of about 760 bytes per kilometer (e.g., 20 landmarks per km×38 bytes per landmark=760 bytes). Even for general purpose signs including an image signature component, the data density impact is about 1.72 kB per km (e.g., 20 landmarks per km×86 bytes per landmark=1,720 bytes). For semantic road signs, this equates to about 76 kB per hour of data usage for a vehicle traveling 100 km/hr. For general purpose signs, this equates to about 170 kB per hour for a vehicle traveling 100 km/hr. It should be noted that in some environments (e.g., urban environments) there may be a much higher density of detected objects available for inclusion in the sparse map (perhaps more than one per meter). In some embodiments, a generally rectangular object, such as a rectangular sign, may be represented in sparse map 800 by no more than 100 bytes of data. The representation of the generally rectangular object (e.g., general sign 1040) in sparse map 800 may include a condensed image signature or image hash (e.g., condensed image signature 1045) associated with the generally rectangular object. This condensed image signature/image hash may be determined using any suitable image hashing algorithm and may be used, for example, to aid in identification of a general purpose sign, for example, as a recognized landmark. Such a condensed image signature (e.g., image information derived from actual image data representing an object) may avoid a need for storage of an actual image of an object or a need for comparative image analysis performed on actual images in order to recognize landmarks.

Referring to FIG. 10, sparse map 800 may include or store a condensed image signature 1045 associated with a general sign 1040, rather than an actual image of general sign 1040. For example, after an image capture device (e.g., image capture device 122, 124, or 126) captures an image of general sign 1040, a processor (e.g., image processor 190 or any other processor that can process images either aboard or remotely located relative to a host vehicle) may perform an image analysis to extract/create condensed image signature 1045 that includes a unique signature or pattern associated with general sign 1040. In one embodiment, condensed image signature 1045 may include a shape, color pattern, a brightness pattern, or any other feature that may be extracted from the image of general sign 1040 for describing general sign 1040.

For example, in FIG. 10, the circles, triangles, and stars shown in condensed image signature 1045 may represent areas of different colors. The pattern represented by the circles, triangles, and stars may be stored in sparse map 800, e.g., within the 50 bytes designated to include an image signature. Notably, the circles, triangles, and stars are not necessarily meant to indicate that such shapes are stored as part of the image signature. Rather, these shapes are meant to conceptually represent recognizable areas having discernible color differences, textual areas, graphical shapes, or other variations in characteristics that may be associated with a general purpose sign. Such condensed image signatures can be used to identify a landmark in the form of a general sign. For example, the condensed image signature can be used to perform a same-not-same analysis based on a comparison of a stored condensed image signature with image data captured, for example, using a camera onboard an autonomous vehicle.

Accordingly, the plurality of landmarks may be identified through image analysis of the plurality of images acquired as one or more vehicles traverse the road segment. As explained below with respect to “crowdsourcing,” in some embodiments, the image analysis to identify the plurality of landmarks may include accepting potential landmarks when a ratio of images in which the landmark does appear to images in which the landmark does not appear exceeds a threshold. Furthermore, in some embodiments, the image analysis to identify the plurality of landmarks may include rejecting potential landmarks when a ratio of images in which the landmark does not appear to images in which the landmark does appear exceeds a threshold.

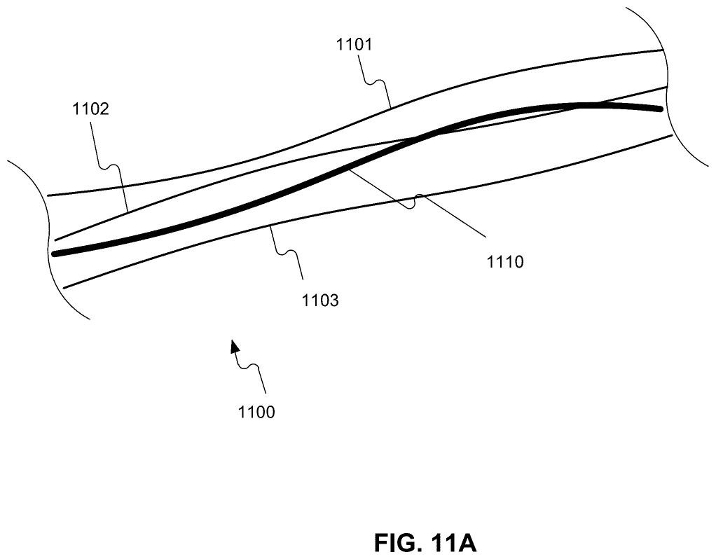

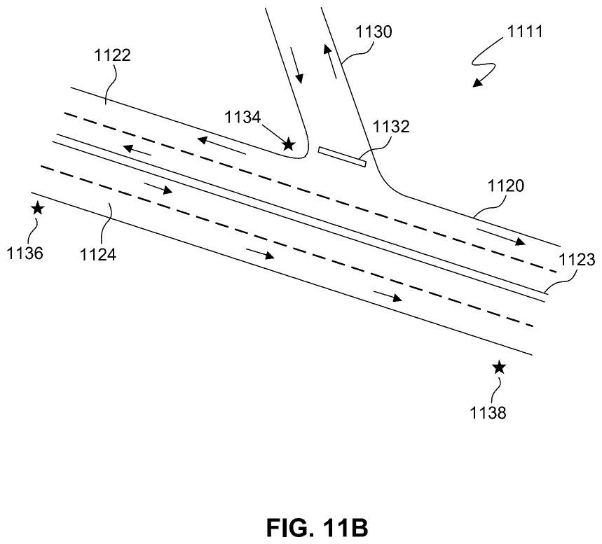

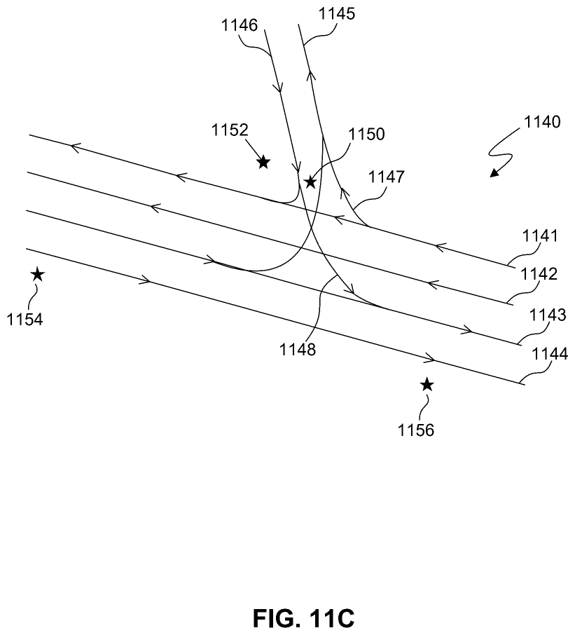

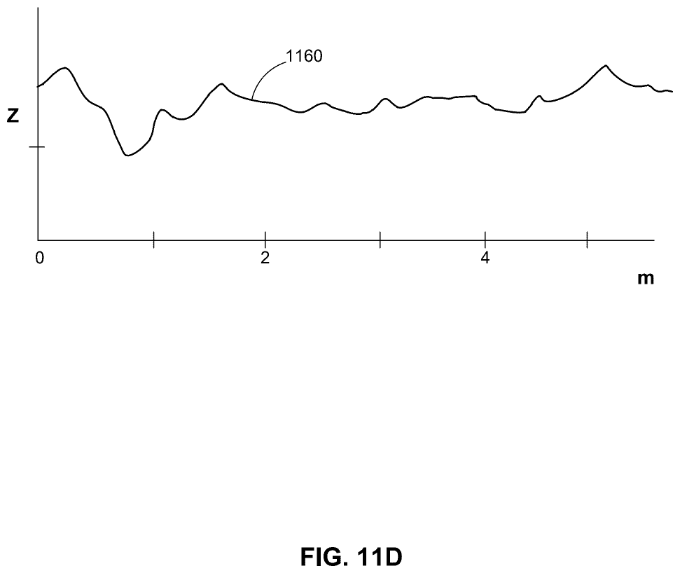

Returning to the target trajectories a host vehicle may use to navigate a particular road segment, FIG. 11A shows polynomial representations trajectories capturing during a process of building or maintaining sparse map 800. A polynomial representation of a target trajectory included in sparse map 800 may be determined based on two or more reconstructed trajectories of prior traversals of vehicles along the same road segment. In some embodiments, the polynomial representation of the target trajectory included in sparse map 800 may be an aggregation of two or more reconstructed trajectories of prior traversals of vehicles along the same road segment. In some embodiments, the polynomial representation of the target trajectory included in sparse map 800 may be an average of the two or more reconstructed trajectories of prior traversals of vehicles along the same road segment. Other mathematical operations may also be used to construct a target trajectory along a road path based on reconstructed trajectories collected from vehicles traversing along a road segment.

As shown in FIG. 11A, a road segment 1100 may be travelled by a number of vehicles 200 at different times. Each vehicle 200 may collect data relating to a path that the vehicle took along the road segment. The path traveled by a particular vehicle may be determined based on camera data, accelerometer information, speed sensor information, and/or GPS information, among other potential sources. Such data may be used to reconstruct trajectories of vehicles traveling along the road segment, and based on these reconstructed trajectories, a target trajectory (or multiple target trajectories) may be determined for the particular road segment. Such target trajectories may represent a preferred path of a host vehicle (e.g., guided by an autonomous navigation system) as the vehicle travels along the road segment.

In the example shown in FIG. 11A, a first reconstructed trajectory 1101 may be determined based on data received from a first vehicle traversing road segment 1100 at a first time period (e.g., day 1), a second reconstructed trajectory 1102 may be obtained from a second vehicle traversing road segment 1100 at a second time period (e.g., day 2), and a third reconstructed trajectory 1103 may be obtained from a third vehicle traversing road segment 1100 at a third time period (e.g., day 3). Each trajectory 1101, 1102, and 1103 may be represented by a polynomial, such as a three-dimensional polynomial. It should be noted that in some embodiments, any of the reconstructed trajectories may be assembled onboard the vehicles traversing road segment 1100.

Additionally, or alternatively, such reconstructed trajectories may be determined on a server side based on information received from vehicles traversing road segment 1100. For example, in some embodiments, vehicles 200 may transmit data to one or more servers relating to their motion along road segment 1100 (e.g., steering angle, heading, time, position, speed, sensed road geometry, and/or sensed landmarks, among things). The server may reconstruct trajectories for vehicles 200 based on the received data. The server may also generate a target trajectory for guiding navigation of autonomous vehicle that will travel along the same road segment 1100 at a later time based on the first, second, and third trajectories 1101, 1102, and 1103. While a target trajectory may be associated with a single prior traversal of a road segment, in some embodiments, each target trajectory included in sparse map 800 may be determined based on two or more reconstructed trajectories of vehicles traversing the same road segment. In FIG. 11A, the target trajectory is represented by 1110. In some embodiments, the target trajectory 1110 may be generated based on an average of the first, second, and third trajectories 1101, 1102, and 1103. In some embodiments, the target trajectory 1110 included in sparse map 800 may be an aggregation (e.g., a weighted combination) of two or more reconstructed trajectories.

At the mapping server, the server may receive actual trajectories for a particular road segment from multiple harvesting vehicles traversing the road segment. To generate a target trajectory for each valid path along the road segment (e.g., each lane, each drive direction, each path through a junction, etc.), the received actual trajectories may be aligned. The alignment process may include using detected objects/features identified along the road segment along with harvested positions of those detected objects/features to correlate the actual, harvested trajectories with one another. Once aligned, an average or “best fit” target trajectory for each available lane, etc. may be determined based on the aggregated, correlated/aligned actual trajectories.

FIGS. 11B and 11C further illustrate the concept of target trajectories associated with road segments present within a geographic region 1111. As shown in FIG. 11B, a first road segment 1120 within geographic region 1111 may include a multilane road, which includes two lanes 1122 designated for vehicle travel in a first direction and two additional lanes 1124 designated for vehicle travel in a second direction opposite to the first direction. Lanes 1122 and lanes 1124 may be separated by a double yellow line 1123. Geographic region 1111 may also include a branching road segment 1130 that intersects with road segment 1120. Road segment 1130 may include a two-lane road, each lane being designated for a different direction of travel. Geographic region 1111 may also include other road features, such as a stop line 1132, a stop sign 1134, a speed limit sign 1136, and a hazard sign 1138.

As shown in FIG. 11C, sparse map 800 may include a local map 1140 including a road model for assisting with autonomous navigation of vehicles within geographic region 1111. For example, local map 1140 may include target trajectories for one or more lanes associated with road segments 1120 and/or 1130 within geographic region 1111. For example, local map 1140 may include target trajectories 1141 and/or 1142 that an autonomous vehicle may access or rely upon when traversing lanes 1122. Similarly, local map 1140 may include target trajectories 1143 and/or 1144 that an autonomous vehicle may access or rely upon when traversing lanes 1124. Further, local map 1140 may include target trajectories 1145 and/or 1146 that an autonomous vehicle may access or rely upon when traversing road segment 1130. Target trajectory 1147 represents a preferred path an autonomous vehicle should follow when transitioning from lanes 1120 (and specifically, relative to target trajectory 1141 associated with a right-most lane of lanes 1120) to road segment 1130 (and specifically, relative to a target trajectory 1145 associated with a first side of road segment 1130. Similarly, target trajectory 1148 represents a preferred path an autonomous vehicle should follow when transitioning from road segment 1130 (and specifically, relative to target trajectory 1146) to a portion of road segment 1124 (and specifically, as shown, relative to a target trajectory 1143 associated with a left lane of lanes 1124.

Sparse map 800 may also include representations of other road-related features associated with geographic region 1111. For example, sparse map 800 may also include representations of one or more landmarks identified in geographic region 1111. Such landmarks may include a first landmark 1150 associated with stop line 1132, a second landmark 1152 associated with stop sign 1134, a third landmark associated with speed limit sign 1154, and a fourth landmark 1156 associated with hazard sign 1138. Such landmarks may be used, for example, to assist an autonomous vehicle in determining its current location relative to any of the shown target trajectories, such that the vehicle may adjust its heading to match a direction of the target trajectory at the determined location.

In some embodiments, sparse map 800 may also include road signature profiles. Such road signature profiles may be associated with any discernible/measurable variation in at least one parameter associated with a road. For example, in some cases, such profiles may be associated with variations in road surface information such as variations in surface roughness of a particular road segment, variations in road width over a particular road segment, variations in distances between dashed lines painted along a particular road segment, variations in road curvature along a particular road segment, etc. FIG. 11D shows an example of a road signature profile 1160. While profile 1160 may represent any of the parameters mentioned above, or others, in one example, profile 1160 may represent a measure of road surface roughness, as obtained, for example, by monitoring one or more sensors providing outputs indicative of an amount of suspension displacement as a vehicle travels a particular road segment.

Alternatively or concurrently, profile 1160 may represent variation in road width, as determined based on image data obtained via a camera onboard a vehicle traveling a particular road segment. Such profiles may be useful, for example, in determining a particular location of an autonomous vehicle relative to a particular target trajectory. That is, as it traverses a road segment, an autonomous vehicle may measure a profile associated with one or more parameters associated with the road segment. If the measured profile can be correlated/matched with a predetermined profile that plots the parameter variation with respect to position along the road segment, then the measured and predetermined profiles may be used (e.g., by overlaying corresponding sections of the measured and predetermined profiles) in order to determine a current position along the road segment and, therefore, a current position relative to a target trajectory for the road segment.

In some embodiments, sparse map 800 may include different trajectories based on different characteristics associated with a user of autonomous vehicles, environmental conditions, and/or other parameters relating to driving. For example, in some embodiments, different trajectories may be generated based on different user preferences and/or profiles. Sparse map 800 including such different trajectories may be provided to different autonomous vehicles of different users. For example, some users may prefer to avoid toll roads, while others may prefer to take the shortest or fastest routes, regardless of whether there is a toll road on the route. The disclosed systems may generate different sparse maps with different trajectories based on such different user preferences or profiles. As another example, some users may prefer to travel in a fast moving lane, while others may prefer to maintain a position in the central lane at all times.

Different trajectories may be generated and included in sparse map 800 based on different environmental conditions, such as day and night, snow, rain, fog, etc. Autonomous vehicles driving under different environmental conditions may be provided with sparse map 800 generated based on such different environmental conditions. In some embodiments, cameras provided on autonomous vehicles may detect the environmental conditions, and may provide such information back to a server that generates and provides sparse maps. For example, the server may generate or update an already generated sparse map 800 to include trajectories that may be more suitable or safer for autonomous driving under the detected environmental conditions. The update of sparse map 800 based on environmental conditions may be performed dynamically as the autonomous vehicles are traveling along roads.

Other different parameters relating to driving may also be used as a basis for generating and providing different sparse maps to different autonomous vehicles. For example, when an autonomous vehicle is traveling at a high speed, turns may be tighter. Trajectories associated with specific lanes, rather than roads, may be included in sparse map 800 such that the autonomous vehicle may maintain within a specific lane as the vehicle follows a specific trajectory. When an image captured by a camera onboard the autonomous vehicle indicates that the vehicle has drifted outside of the lane (e.g., crossed the lane mark), an action may be triggered within the vehicle to bring the vehicle back to the designated lane according to the specific trajectory.

### Crowdsourcing a Sparse Map

The disclosed sparse maps may be efficiently (and passively) generated through the power of crowdsourcing. For example, any private or commercial vehicle equipped with a camera (e.g., a simple, low resolution camera regularly included as OEM equipment on today's vehicles) and an appropriate image analysis processor can serve as a harvesting vehicle. No special equipment (e.g., high definition imaging and/or positioning systems) are required. As a result of the disclosed crowdsourcing technique, the generated sparse maps may be extremely accurate and may include extremely refined position information (enabling navigation error limits of 10 cm or less) without requiring any specialized imaging or sensing equipment as input to the map generation process. Crowdsourcing also enables much more rapid (and inexpensive) updates to the generated maps, as new drive information is continuously available to the mapping server system from any roads traversed by private or commercial vehicles minimally equipped to also serve as harvesting vehicles. There is no need for designated vehicles equipped with high-definition imaging and mapping sensors. Therefore, the expense associated with building such specialized vehicles can be avoided. Further, updates to the presently disclosed sparse maps may be made much more rapidly than systems that rely upon dedicated, specialized mapping vehicles (which by virtue of their expense and special equipment are typically limited to a fleet of specialized vehicles of far lower numbers than the number of private or commercial vehicles already available for performing the disclosed harvesting techniques).

The disclosed sparse maps generated through crowdsourcing may be extremely accurate because they may be generated based on many inputs from multiple (10s, hundreds, millions, etc.) of harvesting vehicles that have collected drive information along a particular road segment. For example, every harvesting vehicle that drives along a particular road segment may record its actual trajectory and may determine position information relative to detected objects/features along the road segment. This information is passed along from multiple harvesting vehicles to a server. The actual trajectories are aggregated to generate a refined, target trajectory for each valid drive path along the road segment. Additionally, the position information collected from the multiple harvesting vehicles for each of the detected objects/features along the road segment (semantic or non-semantic) can also be aggregated. As a result, the mapped position of each detected object/feature may constitute an average of hundreds, thousands, or millions of individually determined positions for each detected object/feature. Such a technique may yield extremely accurate mapped positions for the detected objects/features.

In some embodiments, the disclosed systems and methods may generate a sparse map for autonomous vehicle navigation. For example, disclosed systems and methods may use crowdsourced data for generation of a sparse map that one or more autonomous vehicles may use to navigate along a system of roads. As used herein, “crowdsourcing” means that data are received from various vehicles (e.g., autonomous vehicles) travelling on a road segment at different times, and such data are used to generate and/or update the road model, including sparse map tiles. The model or any of its sparse map tiles may, in turn, be transmitted to the vehicles or other vehicles later travelling along the road segment for assisting autonomous vehicle navigation. The road model may include a plurality of target trajectories representing preferred trajectories that autonomous vehicles should follow as they traverse a road segment. The target trajectories may be the same as a reconstructed actual trajectory collected from a vehicle traversing a road segment, which may be transmitted from the vehicle to a server. In some embodiments, the target trajectories may be different from actual trajectories that one or more vehicles previously took when traversing a road segment. The target trajectories may be generated based on actual trajectories (e.g., through averaging or any other suitable operation).

The vehicle trajectory data that a vehicle may upload to a server may correspond with the actual reconstructed trajectory for the vehicle or may correspond to a recommended trajectory, which may be based on or related to the actual reconstructed trajectory of the vehicle, but may differ from the actual reconstructed trajectory. For example, vehicles may modify their actual, reconstructed trajectories and submit (e.g., recommend) to the server the modified actual trajectories. The road model may use the recommended, modified trajectories as target trajectories for autonomous navigation of other vehicles.

In addition to trajectory information, other information for potential use in building a sparse data map 800 may include information relating to potential landmark candidates. For example, through crowd sourcing of information, the disclosed systems and methods may identify potential landmarks in an environment and refine landmark positions. The landmarks may be used by a navigation system of autonomous vehicles to determine and/or adjust the position of the vehicle along the target trajectories.

The reconstructed trajectories that a vehicle may generate as the vehicle travels along a road may be obtained by any suitable method. In some embodiments, the reconstructed trajectories may be developed by stitching together segments of motion for the vehicle, using, e.g., ego motion estimation (e.g., three dimensional translation and three dimensional rotation of the camera, and hence the body of the vehicle). The rotation and translation estimation may be determined based on analysis of images captured by one or more image capture devices along with information from other sensors or devices, such as inertial sensors and speed sensors. For example, the inertial sensors may include an accelerometer or other suitable sensors configured to measure changes in translation and/or rotation of the vehicle body. The vehicle may include a speed sensor that measures a speed of the vehicle.

In some embodiments, the ego motion of the camera (and hence the vehicle body) may be estimated based on an optical flow analysis of the captured images. An optical flow analysis of a sequence of images identifies movement of pixels from the sequence of images, and based on the identified movement, determines motions of the vehicle. The ego motion may be integrated over time and along the road segment to reconstruct a trajectory associated with the road segment that the vehicle has followed.

Data (e.g., reconstructed trajectories) collected by multiple vehicles in multiple drives along a road segment at different times may be used to construct the road model (e.g., including the target trajectories, etc.) included in sparse data map 800. Data collected by multiple vehicles in multiple drives along a road segment at different times may also be averaged to increase an accuracy of the model. In some embodiments, data regarding the road geometry and/or landmarks may be received from multiple vehicles that travel through the common road segment at different times. Such data received from different vehicles may be combined to generate the road model and/or to update the road model.

The geometry of a reconstructed trajectory (and also a target trajectory) along a road segment may be represented by a curve in three dimensional space, which may be a spline connecting three dimensional polynomials. The reconstructed trajectory curve may be determined from analysis of a video stream or a plurality of images captured by a camera installed on the vehicle. In some embodiments, a location is identified in each frame or image that is a few meters ahead of the current position of the vehicle. This location is where the vehicle is expected to travel to in a predetermined time period. This operation may be repeated frame by frame, and at the same time, the vehicle may compute the camera's ego motion (rotation and translation). At each frame or image, a short range model for the desired path is generated by the vehicle in a reference frame that is attached to the camera. The short range models may be stitched together to obtain a three dimensional model of the road in some coordinate frame, which may be an arbitrary or predetermined coordinate frame. The three dimensional model of the road may then be fitted by a spline, which may include or connect one or more polynomials of suitable orders.

To conclude the short range road model at each frame, one or more detection modules may be used. For example, a bottom-up lane detection module may be used. The bottom-up lane detection module may be useful when lane marks are drawn on the road. This module may look for edges in the image and assembles them together to form the lane marks. A second module may be used together with the bottom-up lane detection module. The second module is an end-to-end deep neural network, which may be trained to predict the correct short range path from an input image. In both modules, the road model may be detected in the image coordinate frame and transformed to a three dimensional space that may be virtually attached to the camera.

Although the reconstructed trajectory modeling method may introduce an accumulation of errors due to the integration of ego motion over a long period of time, which may include a noise component, such errors may be inconsequential as the generated model may provide sufficient accuracy for navigation over a local scale. In addition, it is possible to cancel the integrated error by using external sources of information, such as satellite images or geodetic measurements. For example, the disclosed systems and methods may use a GNSS receiver to cancel accumulated errors. However, the GNSS positioning signals may not be always available and accurate. The disclosed systems and methods may enable a steering application that depends weakly on the availability and accuracy of GNSS positioning. In such systems, the usage of the GNSS signals may be limited. For example, in some embodiments, the disclosed systems may use the GNSS signals for database indexing purposes only.

In some embodiments, the range scale (e.g., local scale) that may be relevant for an autonomous vehicle navigation steering application may be on the order of 50 meters, 100 meters, 200 meters, 300 meters, etc. Such distances may be used, as the geometrical road model is mainly used for two purposes: planning the trajectory ahead and localizing the vehicle on the road model. In some embodiments, the planning task may use the model over a typical range of 40 meters ahead (or any other suitable distance ahead, such as 20 meters, 30 meters, 50 meters), when the control algorithm steers the vehicle according to a target point located 1.3 seconds ahead (or any other time such as 1.5 seconds, 1.7 seconds, 2 seconds, etc.). The localization task uses the road model over a typical range of 60 meters behind the car (or any other suitable distances, such as 50 meters, 100 meters, 150 meters, etc.), according to a method called “tail alignment” described in more detail in another section. The disclosed systems and methods may generate a geometrical model that has sufficient accuracy over particular range, such as 100 meters, such that a planned trajectory will not deviate by more than, for example, 30 cm from the lane center.

As explained above, a three dimensional road model may be constructed from detecting short range sections and stitching them together. The stitching may be enabled by computing a six degree ego motion model, using the videos and/or images captured by the camera, data from the inertial sensors that reflect the motions of the vehicle, and the host vehicle velocity signal. The accumulated error may be small enough over some local range scale, such as of the order of 100 meters. All this may be completed in a single drive over a particular road segment.

In some embodiments, multiple drives may be used to average the resulted model, and to increase its accuracy further. The same car may travel the same route multiple times, or multiple cars may send their collected model data to a central server. In any case, a matching procedure may be performed to identify overlapping models and to enable averaging in order to generate target trajectories. The constructed model (e.g., including the target trajectories) may be used for steering once a convergence criterion is met. Subsequent drives may be used for further model improvements and in order to accommodate infrastructure changes.

Sharing of driving experience (such as sensed data) between multiple cars becomes feasible if they are connected to a central server. Each vehicle client may store a partial copy of a universal road model, which may be relevant for its current position. A bidirectional update procedure between the vehicles and the server may be performed by the vehicles and the server. The small footprint concept discussed above enables the disclosed systems and methods to perform the bidirectional updates using a very small bandwidth.

Information relating to potential landmarks may also be determined and forwarded to a central server. For example, the disclosed systems and methods may determine one or more physical properties of a potential landmark based on one or more images that include the landmark. The physical properties may include a physical size (e.g., height, width) of the landmark, a distance from a vehicle to a landmark, a distance between the landmark to a previous landmark, the lateral position of the landmark (e.g., the position of the landmark relative to the lane of travel), the GPS coordinates of the landmark, a type of landmark, identification of text on the landmark, etc. For example, a vehicle may analyze one or more images captured by a camera to detect a potential landmark, such as a speed limit sign.

The vehicle may determine a distance from the vehicle to the landmark or a position associated with the landmark (e.g., any semantic or non-semantic object or feature along a road segment) based on the analysis of the one or more images. In some embodiments, the distance may be determined based on analysis of images of the landmark using a suitable image analysis method, such as a scaling method and/or an optical flow method. As previously noted, a position of the object/feature may include a 2D image position (e.g., an X-Y pixel position in one or more captured images) of one or more points associated with the object/feature or may include a 3D real-world position of one or more points (e.g., determined through structure in motion/optical flow techniques, LIDAR or RADAR information, etc.). In some embodiments, the disclosed systems and methods may be configured to determine a type or classification of a potential landmark. In case the vehicle determines that a certain potential landmark corresponds to a predetermined type or classification stored in a sparse map, it may be sufficient for the vehicle to communicate to the server an indication of the type or classification of the landmark, along with its location. The server may store such indications. At a later time, during navigation, a navigating vehicle may capture an image that includes a representation of the landmark, process the image (e.g., using a classifier), and compare the result landmark in order to confirm detection of the mapped landmark and to use the mapped landmark in localizing the navigating vehicle relative to the sparse map.

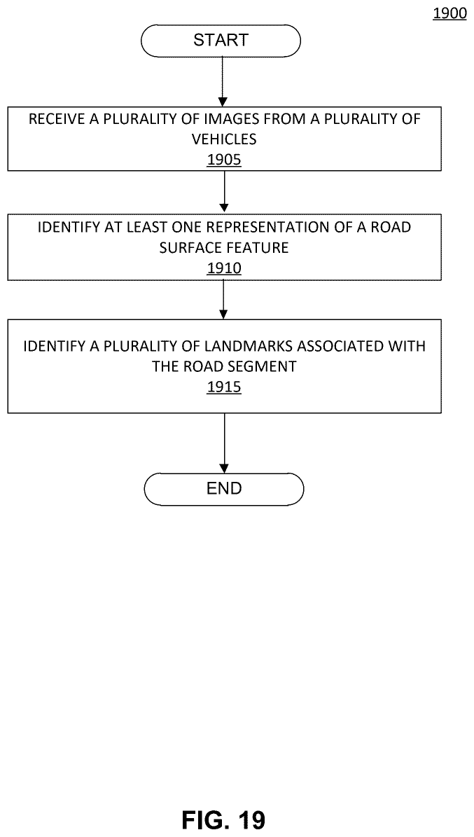

In some embodiments, multiple autonomous vehicles travelling on a road segment may communicate with a server. The vehicles (or clients) may generate a curve describing its drive (e.g., through ego motion integration) in an arbitrary coordinate frame. The vehicles may detect landmarks and locate them in the same frame. The vehicles may upload the curve and the landmarks to the server. The server may collect data from vehicles over multiple drives, and generate a unified road model. For example, as discussed below with respect to FIG. 19, the server may generate a sparse map having the unified road model using the uploaded curves and landmarks.

The server may also distribute the model to clients (e.g., vehicles). For example, the server may distribute the sparse map to one or more vehicles. The server may continuously or periodically update the model when receiving new data from the vehicles. For example, the server may process the new data to evaluate whether the data includes information that should trigger an updated, or creation of new data on the server. The server may distribute the updated model or the updates to the vehicles for providing autonomous vehicle navigation.

The server may use one or more criteria for determining whether new data received from the vehicles should trigger an update to the model or trigger creation of new data. For example, when the new data indicates that a previously recognized landmark at a specific location no longer exists, or is replaced by another landmark, the server may determine that the new data should trigger an update to the model. As another example, when the new data indicates that a road segment has been closed, and when this has been corroborated by data received from other vehicles, the server may determine that the new data should trigger an update to the model.

The server may distribute the updated model (or the updated portion of the model) to one or more vehicles that are traveling on the road segment, with which the updates to the model are associated. The server may also distribute the updated model to vehicles that are about to travel on the road segment, or vehicles whose planned trip includes the road segment, with which the updates to the model are associated. For example, while an autonomous vehicle is traveling along another road segment before reaching the road segment with which an update is associated, the server may distribute the updates or updated model to the autonomous vehicle before the vehicle reaches the road segment.

In some embodiments, the remote server may collect trajectories and landmarks from multiple clients (e.g., vehicles that travel along a common road segment). The server may match curves using landmarks and create an average road model based on the trajectories collected from the multiple vehicles. The server may also compute a graph of roads and the most probable path at each node or conjunction of the road segment. For example, the remote server may align the trajectories to generate a crowdsourced sparse map from the collected trajectories.

The server may average landmark properties received from multiple vehicles that travelled along the common road segment, such as the distances between one landmark to another (e.g., a previous one along the road segment) as measured by multiple vehicles, to determine an arc-length parameter and support localization along the path and speed calibration for each client vehicle. The server may average the physical dimensions of a landmark measured by multiple vehicles travelled along the common road segment and recognized the same landmark. The averaged physical dimensions may be used to support distance estimation, such as the distance from the vehicle to the landmark. The server may average lateral positions of a landmark (e.g., position from the lane in which vehicles are travelling in to the landmark) measured by multiple vehicles travelled along the common road segment and recognized the same landmark. The averaged lateral portion may be used to support lane assignment. The server may average the GPS coordinates of the landmark measured by multiple vehicles travelled along the same road segment and recognized the same landmark. The averaged GPS coordinates of the landmark may be used to support global localization or positioning of the landmark in the road model.

In some embodiments, the server may identify model changes, such as constructions, detours, new signs, removal of signs, etc., based on data received from the vehicles. The server may continuously or periodically or instantaneously update the model upon receiving new data from the vehicles. The server may distribute updates to the model or the updated model to vehicles for providing autonomous navigation. For example, as discussed further below, the server may use crowdsourced data to filter out “ghost” landmarks detected by vehicles.

In some embodiments, the server may analyze driver interventions during the autonomous driving. The server may analyze data received from the vehicle at the time and location where intervention occurs, and/or data received prior to the time the intervention occurred. The server may identify certain portions of the data that caused or are closely related to the intervention, for example, data indicating a temporary lane closure setup, data indicating a pedestrian in the road. The server may update the model based on the identified data. For example, the server may modify one or more trajectories stored in the model.

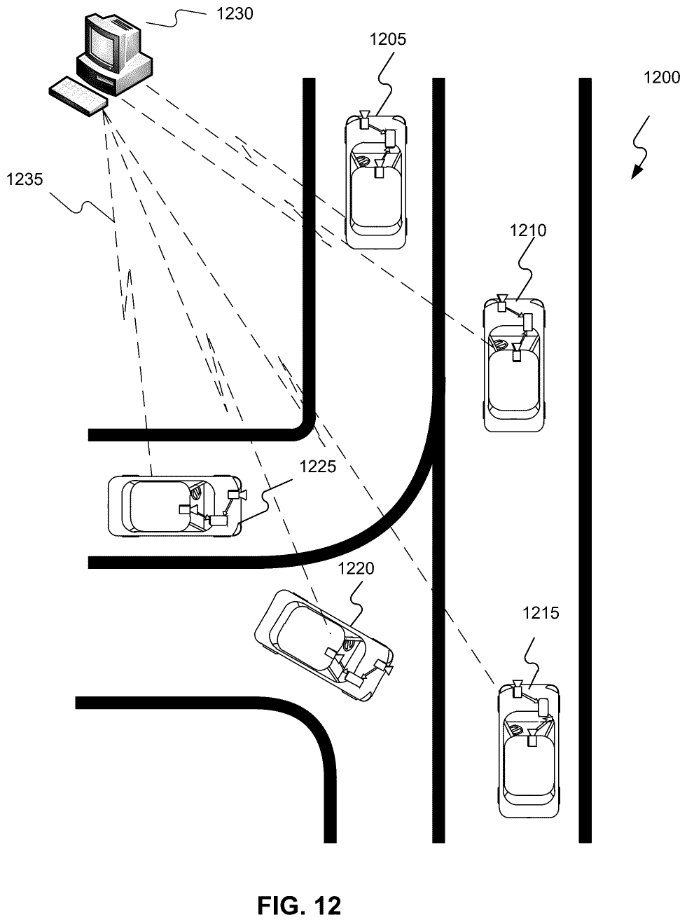

FIG. 12 is a schematic illustration of a system that uses crowdsourcing to generate a sparse map (as well as distribute and navigate using a crowdsourced sparse map). FIG. 12 shows a road segment 1200 that includes one or more lanes. A plurality of vehicles 1205, 1210, 1215, 1220, and 1225 may travel on road segment 1200 at the same time or at different times (although shown as appearing on road segment 1200 at the same time in FIG. 12). At least one of vehicles 1205, 1210, 1215, 1220, and 1225 may be an autonomous vehicle. For simplicity of the present example, all of the vehicles 1205, 1210, 1215, 1220, and 1225 are presumed to be autonomous vehicles.

Each vehicle may be similar to vehicles disclosed in other embodiments (e.g., vehicle 200), and may include components or devices included in or associated with vehicles disclosed in other embodiments. Each vehicle may be equipped with an image capture device or camera (e.g., image capture device 122 or camera 122). Each vehicle may communicate with a remote server 1230 via one or more networks (e.g., over a cellular network and/or the Internet, etc.) through wireless communication paths 1235, as indicated by the dashed lines. Each vehicle may transmit data to server 1230 and receive data from server 1230. For example, server 1230 may collect data from multiple vehicles travelling on the road segment 1200 at different times, and may process the collected data to generate an autonomous vehicle road navigation model, or an update to the model. Server 1230 may transmit the autonomous vehicle road navigation model or the update to the model to the vehicles that transmitted data to server 1230. Server 1230 may transmit the autonomous vehicle road navigation model or the update to the model to other vehicles that travel on road segment 1200 at later times.

As vehicles 1205, 1210, 1215, 1220, and 1225 travel on road segment 1200, navigation information collected (e.g., detected, sensed, or measured) by vehicles 1205, 1210, 1215, 1220, and 1225 may be transmitted to server 1230. In some embodiments, the navigation information may be associated with the common road segment 1200. The navigation information may include a trajectory associated with each of the vehicles 1205, 1210, 1215, 1220, and 1225 as each vehicle travels over road segment 1200. In some embodiments, the trajectory may be reconstructed based on data sensed by various sensors and devices provided on vehicle 1205. For example, the trajectory may be reconstructed based on at least one of accelerometer data, speed data, landmarks data, road geometry or profile data, vehicle positioning data, and ego motion data. In some embodiments, the trajectory may be reconstructed based on data from inertial sensors, such as accelerometer, and the velocity of vehicle 1205 sensed by a speed sensor. In addition, in some embodiments, the trajectory may be determined (e.g., by a processor onboard each of vehicles 1205, 1210, 1215, 1220, and 1225) based on sensed ego motion of the camera, which may indicate three dimensional translation and/or three dimensional rotations (or rotational motions). The ego motion of the camera (and hence the vehicle body) may be determined from analysis of one or more images captured by the camera.

In some embodiments, the trajectory of vehicle 1205 may be determined by a processor provided aboard vehicle 1205 and transmitted to server 1230. In other embodiments, server 1230 may receive data sensed by the various sensors and devices provided in vehicle 1205, and determine the trajectory based on the data received from vehicle 1205.

In some embodiments, the navigation information transmitted from vehicles 1205, 1210, 1215, 1220, and 1225 to server 1230 may include data regarding the road surface, the road geometry, or the road profile. The geometry of road segment 1200 may include lane structure and/or landmarks. The lane structure may include the total number of lanes of road segment 1200, the type of lanes (e.g., one-way lane, two-way lane, driving lane, passing lane, etc.), markings on lanes, width of lanes, etc. In some embodiments, the navigation information may include a lane assignment, e.g., which lane of a plurality of lanes a vehicle is traveling in. For example, the lane assignment may be associated with a numerical value “3” indicating that the vehicle is traveling on the third lane from the left or right. As another example, the lane assignment may be associated with a text value “center lane” indicating the vehicle is traveling on the center lane.

Server 1230 may store the navigation information on a non-transitory computer-readable medium, such as a hard drive, a compact disc, a tape, a memory, etc. Server 1230 may generate (e.g., through a processor included in server 1230) at least a portion of an autonomous vehicle road navigation model for the common road segment 1200 based on the navigation information received from the plurality of vehicles 1205, 1210, 1215, 1220, and 1225 and may store the model as a portion of a sparse map. Server 1230 may determine a trajectory associated with each lane based on crowdsourced data (e.g., navigation information) received from multiple vehicles (e.g., 1205, 1210, 1215, 1220, and 1225) that travel on a lane of road segment at different times. Server 1230 may generate the autonomous vehicle road navigation model or a portion of the model (e.g., an updated portion) based on a plurality of trajectories determined based on the crowd sourced navigation data. Server 1230 may transmit the model or the updated portion of the model to one or more of autonomous vehicles 1205, 1210, 1215, 1220, and 1225 traveling on road segment 1200 or any other autonomous vehicles that travel on road segment at a later time for updating an existing autonomous vehicle road navigation model provided in a navigation system of the vehicles. The autonomous vehicle road navigation model may be used by the autonomous vehicles in autonomously navigating along the common road segment 1200.

As explained above, the autonomous vehicle road navigation model may be included in a sparse map (e.g., sparse map 800 depicted in FIG. 8). Sparse map 800 may include sparse recording of data related to road geometry and/or landmarks along a road, which may provide sufficient information for guiding autonomous navigation of an autonomous vehicle, yet does not require excessive data storage. In some embodiments, the autonomous vehicle road navigation model may be stored separately from sparse map 800, and may use map data from sparse map 800 when the model is executed for navigation. In some embodiments, the autonomous vehicle road navigation model may use map data included in sparse map 800 for determining target trajectories along road segment 1200 for guiding autonomous navigation of autonomous vehicles 1205, 1210, 1215, 1220, and 1225 or other vehicles that later travel along road segment 1200. For example, when the autonomous vehicle road navigation model is executed by a processor included in a navigation system of vehicle 1205, the model may cause the processor to compare the trajectories determined based on the navigation information received from vehicle 1205 with predetermined trajectories included in sparse map 800 to validate and/or correct the current traveling course of vehicle 1205.

In the autonomous vehicle road navigation model, the geometry of a road feature or target trajectory may be encoded by a curve in a three-dimensional space. In one embodiment, the curve may be a three dimensional spline including one or more connecting three dimensional polynomials. As one of skill in the art would understand, a spline may be a numerical function that is piece-wise defined by a series of polynomials for fitting data. A spline for fitting the three dimensional geometry data of the road may include a linear spline (first order), a quadratic spline (second order), a cubic spline (third order), or any other splines (other orders), or a combination thereof. The spline may include one or more three dimensional polynomials of different orders connecting (e.g., fitting) data points of the three dimensional geometry data of the road. In some embodiments, the autonomous vehicle road navigation model may include a three dimensional spline corresponding to a target trajectory along a common road segment (e.g., road segment 1200) or a lane of the road segment 1200.

As explained above, the autonomous vehicle road navigation model included in the sparse map may include other information, such as identification of at least one landmark along road segment 1200. The landmark may be visible within a field of view of a camera (e.g., camera 122) installed on each of vehicles 1205, 1210, 1215, 1220, and 1225. In some embodiments, camera 122 may capture an image of a landmark. A processor (e.g., processor 180, 190, or processing unit 110) provided on vehicle 1205 may process the image of the landmark to extract identification information for the landmark. The landmark identification information, rather than an actual image of the landmark, may be stored in sparse map 800. The landmark identification information may require much less storage space than an actual image. Other sensors or systems (e.g., GPS system) may also provide certain identification information of the landmark (e.g., position of landmark). The landmark may include at least one of a traffic sign, an arrow marking, a lane marking, a dashed lane marking, a traffic light, a stop line, a directional sign (e.g., a highway exit sign with an arrow indicating a direction, a highway sign with arrows pointing to different directions or places), a landmark beacon, or a lamppost. A landmark beacon refers to a device (e.g., an RFID device) installed along a road segment that transmits or reflects a signal to a receiver installed on a vehicle, such that when the vehicle passes by the device, the beacon received by the vehicle and the location of the device (e.g., determined from GPS location of the device) may be used as a landmark to be included in the autonomous vehicle road navigation model and/or the sparse map 800.

The identification of at least one landmark may include a position of the at least one landmark. The position of the landmark may be determined based on position measurements performed using sensor systems (e.g., Global Positioning Systems, inertial based positioning systems, landmark beacon, etc.) associated with the plurality of vehicles 1205, 1210, 1215, 1220, and 1225. In some embodiments, the position of the landmark may be determined by averaging the position measurements detected, collected, or received by sensor systems on different vehicles 1205, 1210, 1215, 1220, and 1225 through multiple drives. For example, vehicles 1205, 1210, 1215, 1220, and 1225 may transmit position measurements data to server 1230, which may average the position measurements and use the averaged position measurement as the position of the landmark. The position of the landmark may be continuously refined by measurements received from vehicles in subsequent drives.

The identification of the landmark may include a size of the landmark. The processor provided on a vehicle (e.g., 1205) may estimate the physical size of the landmark based on the analysis of the images. Server 1230 may receive multiple estimates of the physical size of the same landmark from different vehicles over different drives. Server 1230 may average the different estimates to arrive at a physical size for the landmark, and store that landmark size in the road model. The physical size estimate may be used to further determine or estimate a distance from the vehicle to the landmark. The distance to the landmark may be estimated based on the current speed of the vehicle and a scale of expansion based on the position of the landmark appearing in the images relative to the focus of expansion of the camera. For example, the distance to landmark may be estimated by Z=V*dt*R/D, where V is the speed of vehicle, R is the distance in the image from the landmark at time t1 to the focus of expansion, and D is the change in distance for the landmark in the image from t1 to t2. dt represents the (t2−t1). For example, the distance to landmark may be estimated by Z=V*dt*R/D, where V is the speed of vehicle, R is the distance in the image between the landmark and the focus of expansion, dt is a time interval, and D is the image displacement of the landmark along the epipolar line. Other equations equivalent to the above equation, such as Z=V*ω/Δω, may be used for estimating the distance to the landmark. Here, V is the vehicle speed, ω is an image length (like the object width), and Ao is the change of that image length in a unit of time.

When the physical size of the landmark is known, the distance to the landmark may also be determined based on the following equation: Z=f*W/ω, where f is the focal length, W is the size of the landmark (e.g., height or width), ω is the number of pixels when the landmark leaves the image. From the above equation, a change in distance Z may be calculated using ΔZ=f*W*Δω/ω2+f*ΔW/ω, where ΔW decays to zero by averaging, and where Δω is the number of pixels representing a bounding box accuracy in the image. A value estimating the physical size of the landmark may be calculated by averaging multiple observations at the server side. The resulting error in distance estimation may be very small. There are two sources of error that may occur when using the formula above, namely ΔW and Δω. Their contribution to the distance error is given by ΔZ=f*W*Δω/ω2+f*ΔW/ω. However, ΔW decays to zero by averaging; hence ΔZ is determined by Δω (e.g., the inaccuracy of the bounding box in the image).

For landmarks of unknown dimensions, the distance to the landmark may be estimated by tracking feature points on the landmark between successive frames. For example, certain features appearing on a speed limit sign may be tracked between two or more image frames. Based on these tracked features, a distance distribution per feature point may be generated. The distance estimate may be extracted from the distance distribution. For example, the most frequent distance appearing in the distance distribution may be used as the distance estimate. As another example, the average of the distance distribution may be used as the distance estimate.

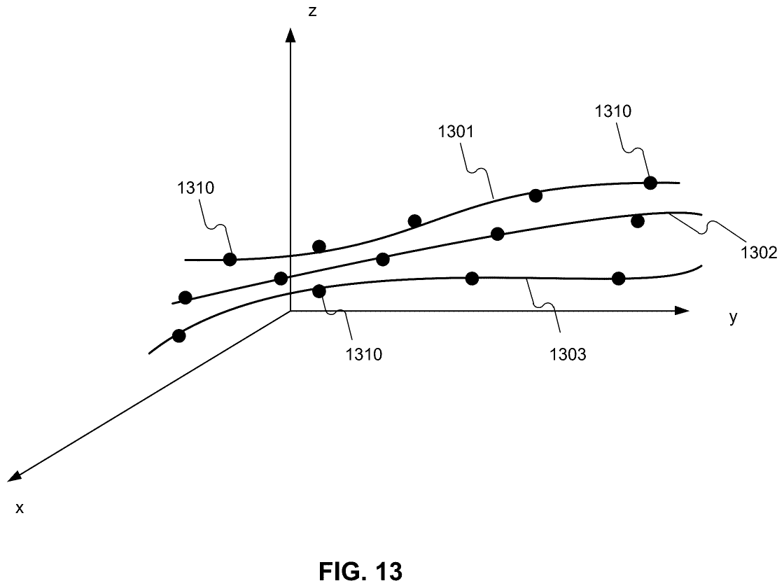

FIG. 13 illustrates an example autonomous vehicle road navigation model represented by a plurality of three dimensional splines 1301, 1302, and 1303. The curves 1301, 1302, and 1303 shown in FIG. 13 are for illustration purpose only. Each spline may include one or more three dimensional polynomials connecting a plurality of data points 1310. Each polynomial may be a first order polynomial, a second order polynomial, a third order polynomial, or a combination of any suitable polynomials having different orders. Each data point 1310 may be associated with the navigation information received from vehicles 1205, 1210, 1215, 1220, and 1225. In some embodiments, each data point 1310 may be associated with data related to landmarks (e.g., size, location, and identification information of landmarks) and/or road signature profiles (e.g., road geometry, road roughness profile, road curvature profile, road width profile). In some embodiments, some data points 1310 may be associated with data related to landmarks, and others may be associated with data related to road signature profiles.

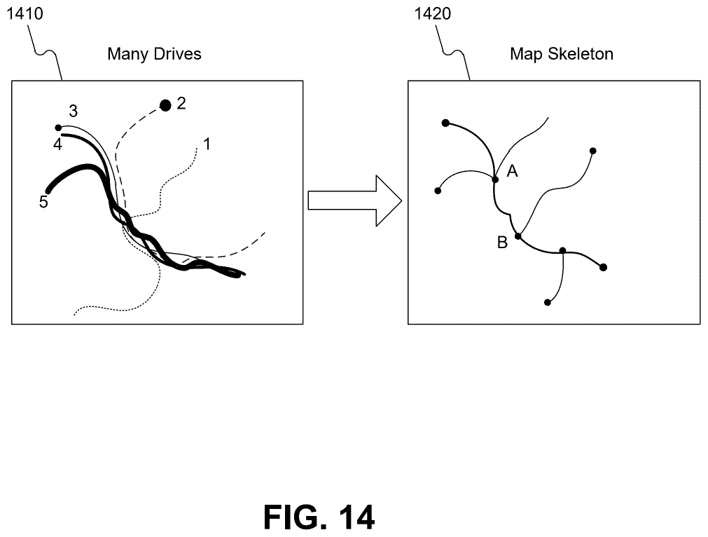

FIG. 14 illustrates raw location data 1410 (e.g., GPS data) received from five separate drives. One drive may be separate from another drive if it was traversed by separate vehicles at the same time, by the same vehicle at separate times, or by separate vehicles at separate times. To account for errors in the location data 1410 and for differing locations of vehicles within the same lane (e.g., one vehicle may drive closer to the left of a lane than another), server 1230 may generate a map skeleton 1420 using one or more statistical techniques to determine whether variations in the raw location data 1410 represent actual divergences or statistical errors. Each path within skeleton 1420 may be linked back to the raw data 1410 that formed the path. For example, the path between A and B within skeleton 1420 is linked to raw data 1410 from drives 2, 3, 4, and 5 but not from drive 1. Skeleton 1420 may not be detailed enough to be used to navigate a vehicle (e.g., because it combines drives from multiple lanes on the same road unlike the splines described above) but may provide useful topological information and may be used to define intersections.

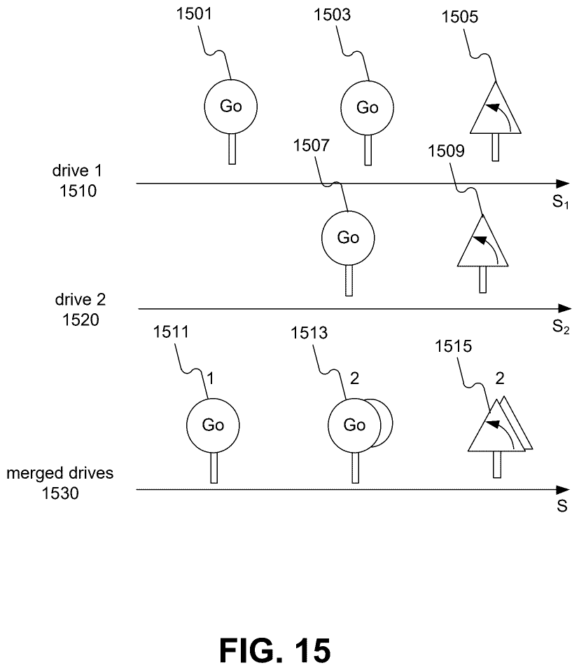

FIG. 15 illustrates an example by which additional detail may be generated for a sparse map within a segment of a map skeleton (e.g., segment A to B within skeleton 1420). As depicted in FIG. 15, the data (e.g., ego-motion data, road markings data, and the like) may be shown as a function of position S (or S1 or S2) along the drive. Server 1230 may identify landmarks for the sparse map by identifying unique matches between landmarks 1501, 1503, and 1505 of drive 1510 and landmarks 1507 and 1509 of drive 1520. Such a matching algorithm may result in identification of landmarks 1511, 1513, and 1515. One skilled in the art would recognize, however, that other matching algorithms may be used. For example, probability optimization may be used in lieu of or in combination with unique matching. Server 1230 may longitudinally align the drives to align the matched landmarks. For example, server 1230 may select one drive (e.g., drive 1520) as a reference drive and then shift and/or elastically stretch the other drive(s) (e.g., drive 1510) for alignment.

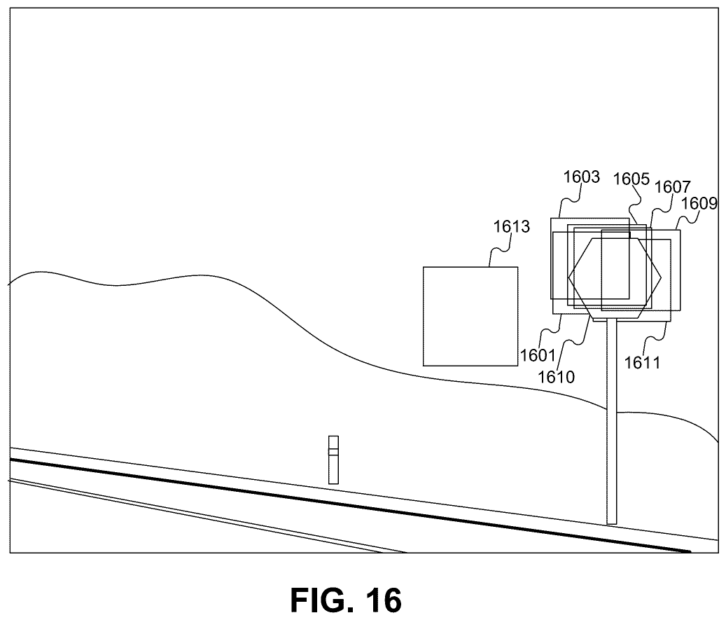

FIG. 16 shows an example of aligned landmark data for use in a sparse map. In the example of FIG. 16, landmark 1610 comprises a road sign. The example of FIG. 16 further depicts data from a plurality of drives 1601, 1603, 1605, 1607, 1609, 1611, and 1613. In the example of FIG. 16, the data from drive 1613 consists of a “ghost” landmark, and the server 1230 may identify it as such because none of drives 1601, 1603, 1605, 1607, 1609, and 1611 include an identification of a landmark in the vicinity of the identified landmark in drive 1613. Accordingly, server 1230 may accept potential landmarks when a ratio of images in which the landmark does appear to images in which the landmark does not appear exceeds a threshold and/or may reject potential landmarks when a ratio of images in which the landmark does not appear to images in which the landmark does appear exceeds a threshold.

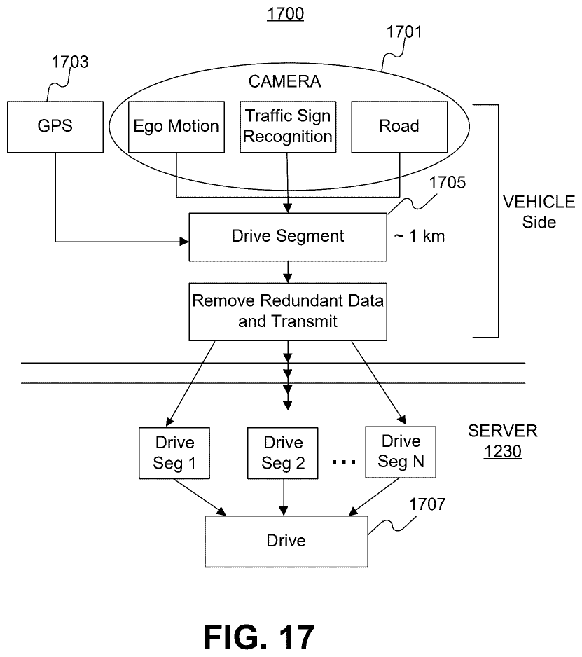

FIG. 17 depicts a system 1700 for generating drive data, which may be used to crowdsource a sparse map. As depicted in FIG. 17, system 1700 may include a camera 1701 and a locating device 1703 (e.g., a GPS locator). Camera 1701 and locating device 1703 may be mounted on a vehicle (e.g., one of vehicles 1205, 1210, 1215, 1220, and 1225). Camera 1701 may produce a plurality of data of multiple types, e.g., ego motion data, traffic sign data, road data, or the like. The camera data and location data may be segmented into drive segments 1705. For example, drive segments 1705 may each have camera data and location data from less than 1 km of driving.

In some embodiments, system 1700 may remove redundancies in drive segments 1705. For example, if a landmark appears in multiple images from camera 1701, system 1700 may strip the redundant data such that the drive segments 1705 only contain one copy of the location of and any metadata relating to the landmark. By way of further example, if a lane marking appears in multiple images from camera 1701, system 1700 may strip the redundant data such that the drive segments 1705 only contain one copy of the location of and any metadata relating to the lane marking.

System 1700 also includes a server (e.g., server 1230). Server 1230 may receive drive segments 1705 from the vehicle and recombine the drive segments 1705 into a single drive 1707. Such an arrangement may allow for reduce bandwidth requirements when transferring data between the vehicle and the server while also allowing for the server to store data relating to an entire drive.

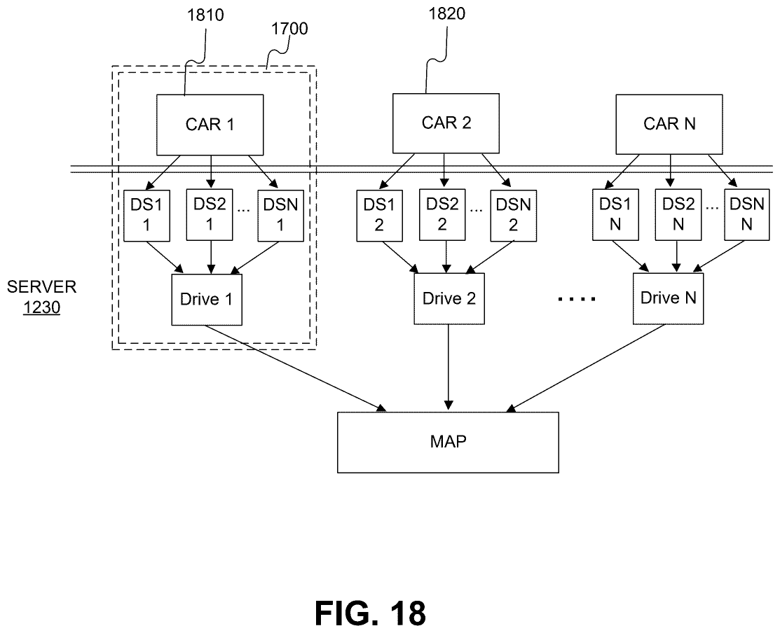

FIG. 18 depicts system 1700 of FIG. 17 further configured for crowdsourcing a sparse map. As in FIG. 17, system 1700 includes vehicle 1810, which captures drive data using, for example, a camera (which produces, e.g., ego motion data, traffic sign data, road data, or the like) and a locating device (e.g., a GPS locator). As in FIG. 17, vehicle 1810 segments the collected data into drive segments (depicted as “DS1 1,” “DS2 1,” “DSN 1” in FIG. 18). Server 1230 then receives the drive segments and reconstructs a drive (depicted as “Drive 1” in FIG. 18) from the received segments.

As further depicted in FIG. 18, system 1700 also receives data from additional vehicles. For example, vehicle 1820 also captures drive data using, for example, a camera (which produces, e.g., ego motion data, traffic sign data, road data, or the like) and a locating device (e.g., a GPS locator). Similar to vehicle 1810, vehicle 1820 segments the collected data into drive segments (depicted as “DS1 2,” “DS2 2,” “DSN 2” in FIG. 18). Server 1230 then receives the drive segments and reconstructs a drive (depicted as “Drive 2” in FIG. 18) from the received segments. Any number of additional vehicles may be used. For example, FIG. 18 also includes “CAR N” that captures drive data, segments it into drive segments (depicted as “DS1 N,” “DS2 N,” “DSN N” in FIG. 18), and sends it to server 1230 for reconstruction into a drive (depicted as “Drive N” in FIG. 18).

As depicted in FIG. 18, server 1230 may construct a sparse map (depicted as “MAP”) using the reconstructed drives (e.g., “Drive 1,” “Drive 2,” and “Drive N”) collected from a plurality of vehicles (e.g., “CAR 1” (also labeled vehicle 1810), “CAR 2” (also labeled vehicle 1820), and “CAR N”).

FIG. 19 is a flowchart showing an example process 1900 for generating a sparse map for autonomous vehicle navigation along a road segment. Process 1900 may be performed by one or more processing devices included in server 1230.

Process 1900 may include receiving a plurality of images acquired as one or more vehicles traverse the road segment (step 1905). Server 1230 may receive images from cameras included within one or more of vehicles 1205, 1210, 1215, 1220, and 1225. For example, camera 122 may capture one or more images of the environment surrounding vehicle 1205 as vehicle 1205 travels along road segment 1200. In some embodiments, server 1230 may also receive stripped down image data that has had redundancies removed by a processor on vehicle 1205, as discussed above with respect to FIG. 17.

Process 1900 may further include identifying, based on the plurality of images, at least one line representation of a road surface feature extending along the road segment (step 1910). Each line representation may represent a path along the road segment substantially corresponding with the road surface feature. For example, server 1230 may analyze the environmental images received from camera 122 to identify a road edge or a lane marking and determine a trajectory of travel along road segment 1200 associated with the road edge or lane marking. In some embodiments, the trajectory (or line representation) may include a spline, a polynomial representation, or a curve. Server 1230 may determine the trajectory of travel of vehicle 1205 based on camera ego motions (e.g., three dimensional translation and/or three dimensional rotational motions) received at step 1905.

Process 1900 may also include identifying, based on the plurality of images, a plurality of landmarks associated with the road segment (step 1910). For example, server 1230 may analyze the environmental images received from camera 122 to identify one or more landmarks, such as road sign along road segment 1200. Server 1230 may identify the landmarks using analysis of the plurality of images acquired as one or more vehicles traverse the road segment. To enable crowdsourcing, the analysis may include rules regarding accepting and rejecting possible landmarks associated with the road segment. For example, the analysis may include accepting potential landmarks when a ratio of images in which the landmark does appear to images in which the landmark does not appear exceeds a threshold and/or rejecting potential landmarks when a ratio of images in which the landmark does not appear to images in which the landmark does appear exceeds a threshold.

Process 1900 may include other operations or steps performed by server 1230. For example, the navigation information may include a target trajectory for vehicles to travel along a road segment, and process 1900 may include clustering, by server 1230, vehicle trajectories related to multiple vehicles travelling on the road segment and determining the target trajectory based on the clustered vehicle trajectories, as discussed in further detail below. Clustering vehicle trajectories may include clustering, by server 1230, the multiple trajectories related to the vehicles travelling on the road segment into a plurality of clusters based on at least one of the absolute heading of vehicles or lane assignment of the vehicles. Generating the target trajectory may include averaging, by server 1230, the clustered trajectories. By way of further example, process 1900 may include aligning data received in step 1905. Other processes or steps performed by server 1230, as described above, may also be included in process 1900.

The disclosed systems and methods may include other features. For example, the disclosed systems may use local coordinates, rather than global coordinates. For autonomous driving, some systems may present data in world coordinates. For example, longitude and latitude coordinates on the earth surface may be used. In order to use the map for steering, the host vehicle may determine its position and orientation relative to the map. It seems natural to use a GPS device on board, in order to position the vehicle on the map and in order to find the rotation transformation between the body reference frame and the world reference frame (e.g., North, East and Down). Once the body reference frame is aligned with the map reference frame, then the desired route may be expressed in the body reference frame and the steering commands may be computed or generated.

The disclosed systems and methods may enable autonomous vehicle navigation (e.g., steering control) with low footprint models, which may be collected by the autonomous vehicles themselves without the aid of expensive surveying equipment. To support the autonomous navigation (e.g., steering applications), the road model may include a sparse map having the geometry of the road, its lane structure, and landmarks that may be used to determine the location or position of vehicles along a trajectory included in the model. As discussed above, generation of the sparse map may be performed by a remote server that communicates with vehicles travelling on the road and that receives data from the vehicles. The data may include sensed data, trajectories reconstructed based on the sensed data, and/or recommended trajectories that may represent modified reconstructed trajectories. As discussed below, the server may transmit the model back to the vehicles or other vehicles that later travel on the road to aid in autonomous navigation.

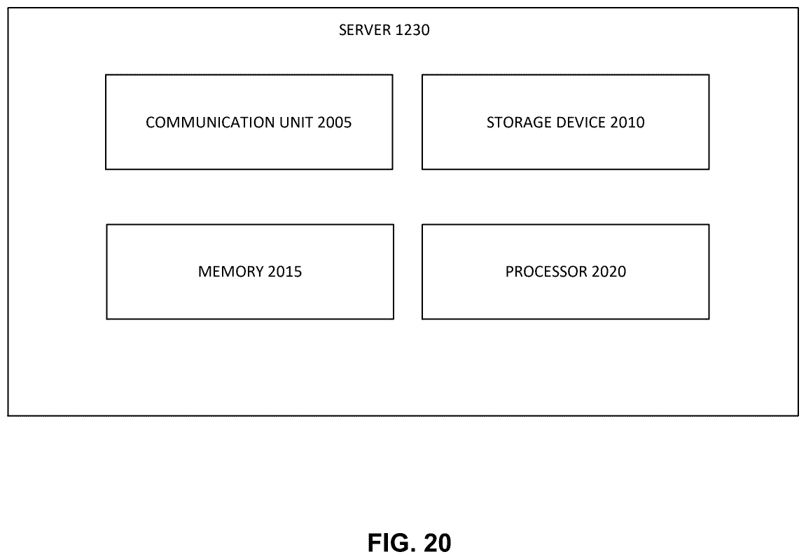

FIG. 20 illustrates a block diagram of server 1230. Server 1230 may include a communication unit 2005, which may include both hardware components (e.g., communication control circuits, switches, and antenna), and software components (e.g., communication protocols, computer codes). For example, communication unit 2005 may include at least one network interface. Server 1230 may communicate with vehicles 1205, 1210, 1215, 1220, and 1225 through communication unit 2005. For example, server 1230 may receive, through communication unit 2005, navigation information transmitted from vehicles 1205, 1210, 1215, 1220, and 1225. Server 1230 may distribute, through communication unit 2005, the autonomous vehicle road navigation model to one or more autonomous vehicles.

Server 1230 may include at least one non-transitory storage medium 2010, such as a hard drive, a compact disc, a tape, etc. Storage device 1410 may be configured to store data, such as navigation information received from vehicles 1205, 1210, 1215, 1220, and 1225 and/or the autonomous vehicle road navigation model that server 1230 generates based on the navigation information. Storage device 2010 may be configured to store any other information, such as a sparse map (e.g., sparse map 800 discussed above with respect to FIG. 8).

In addition to or in place of storage device 2010, server 1230 may include a memory 2015. Memory 2015 may be similar to or different from memory 140 or 150. Memory 2015 may be a non-transitory memory, such as a flash memory, a random access memory, etc. Memory 2015 may be configured to store data, such as computer codes or instructions executable by a processor (e.g., processor 2020), map data (e.g., data of sparse map 800), the autonomous vehicle road navigation model, and/or navigation information received from vehicles 1205, 1210, 1215, 1220, and 1225.

Server 1230 may include at least one processing device 2020 configured to execute computer codes or instructions stored in memory 2015 to perform various functions. For example, processing device 2020 may analyze the navigation information received from vehicles 1205, 1210, 1215, 1220, and 1225, and generate the autonomous vehicle road navigation model based on the analysis. Processing device 2020 may control communication unit 1405 to distribute the autonomous vehicle road navigation model to one or more autonomous vehicles (e.g., one or more of vehicles 1205, 1210, 1215, 1220, and 1225 or any vehicle that travels on road segment 1200 at a later time). Processing device 2020 may be similar to or different from processor 180, 190, or processing unit 110.

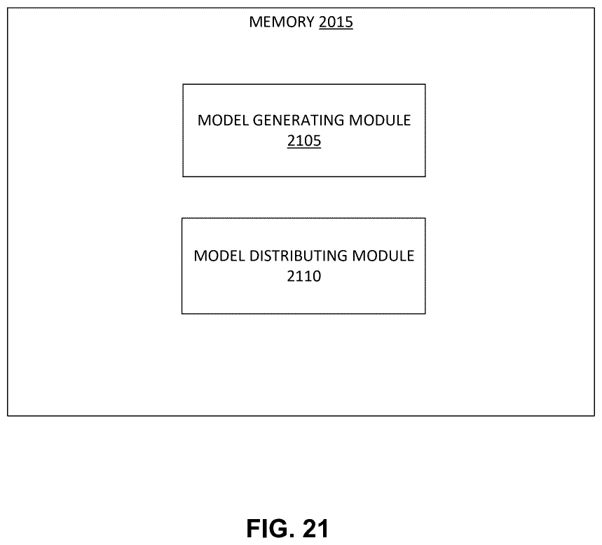

FIG. 21 illustrates a block diagram of memory 2015, which may store computer code or instructions for performing one or more operations for generating a road navigation model for use in autonomous vehicle navigation. As shown in FIG. 21, memory 2015 may store one or more modules for performing the operations for processing vehicle navigation information. For example, memory 2015 may include a model generating module 2105 and a model distributing module 2110. Processor 2020 may execute the instructions stored in any of modules 2105 and 2110 included in memory 2015.

Model generating module 2105 may store instructions which, when executed by processor 2020, may generate at least a portion of an autonomous vehicle road navigation model for a common road segment (e.g., road segment 1200) based on navigation information received from vehicles 1205, 1210, 1215, 1220, and 1225. For example, in generating the autonomous vehicle road navigation model, processor 2020 may cluster vehicle trajectories along the common road segment 1200 into different clusters. Processor 2020 may determine a target trajectory along the common road segment 1200 based on the clustered vehicle trajectories for each of the different clusters. Such an operation may include finding a mean or average trajectory of the clustered vehicle trajectories (e.g., by averaging data representing the clustered vehicle trajectories) in each cluster. In some embodiments, the target trajectory may be associated with a single lane of the common road segment 1200.

The road model and/or sparse map may store trajectories associated with a road segment. These trajectories may be referred to as target trajectories, which are provided to autonomous vehicles for autonomous navigation. The target trajectories may be received from multiple vehicles, or may be generated based on actual trajectories or recommended trajectories (actual trajectories with some modifications) received from multiple vehicles. The target trajectories included in the road model or sparse map may be continuously updated (e.g., averaged) with new trajectories received from other vehicles.

Vehicles travelling on a road segment may collect data by various sensors. The data may include landmarks, road signature profile, vehicle motion (e.g., accelerometer data, speed data), vehicle position (e.g., GPS data), and may either reconstruct the actual trajectories themselves, or transmit the data to a server, which will reconstruct the actual trajectories for the vehicles. In some embodiments, the vehicles may transmit data relating to a trajectory (e.g., a curve in an arbitrary reference frame), landmarks data, and lane assignment along traveling path to server 1230. Various vehicles travelling along the same road segment at multiple drives may have different trajectories. Server 1230 may identify routes or trajectories associated with each lane from the trajectories received from vehicles through a clustering process.

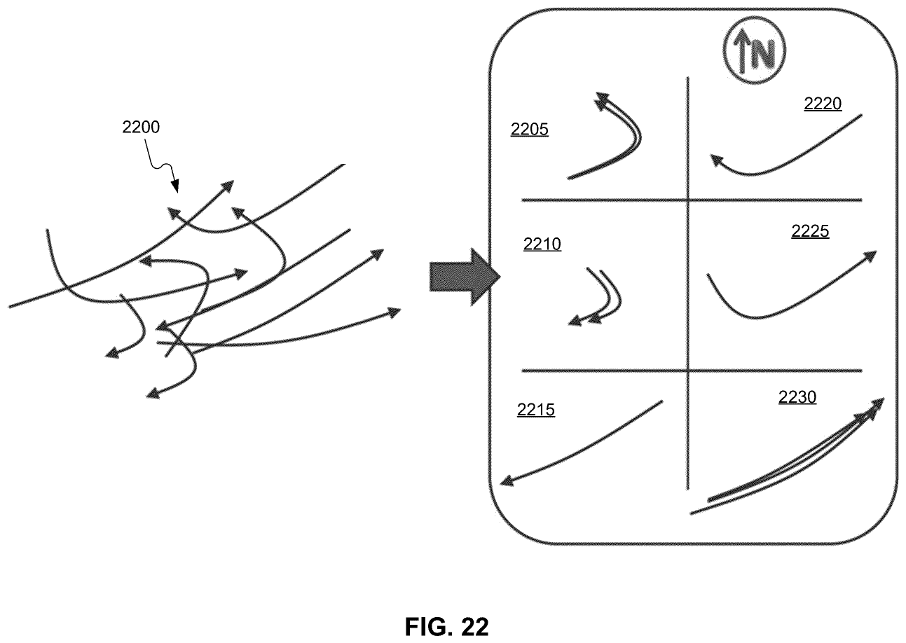

FIG. 22 illustrates a process of clustering vehicle trajectories associated with vehicles 1205, 1210, 1215, 1220, and 1225 for determining a target trajectory for the common road segment (e.g., road segment 1200). The target trajectory or a plurality of target trajectories determined from the clustering process may be included in the autonomous vehicle road navigation model or sparse map 800. In some embodiments, vehicles 1205, 1210, 1215, 1220, and 1225 traveling along road segment 1200 may transmit a plurality of trajectories 2200 to server 1230. In some embodiments, server 1230 may generate trajectories based on landmark, road geometry, and vehicle motion information received from vehicles 1205, 1210, 1215, 1220, and 1225. To generate the autonomous vehicle road navigation model, server 1230 may cluster vehicle trajectories 1600 into a plurality of clusters 2205, 2210, 2215, 2220, 2225, and 2230, as shown in FIG. 22.

Clustering may be performed using various criteria. In some embodiments, all drives in a cluster may be similar with respect to the absolute heading along the road segment 1200. The absolute heading may be obtained from GPS signals received by vehicles 1205, 1210, 1215, 1220, and 1225. In some embodiments, the absolute heading may be obtained using dead reckoning. Dead reckoning, as one of skill in the art would understand, may be used to determine the current position and hence heading of vehicles 1205, 1210, 1215, 1220, and 1225 by using previously determined position, estimated speed, etc. Trajectories clustered by absolute heading may be useful for identifying routes along the roadways.

In some embodiments, all the drives in a cluster may be similar with respect to the lane assignment (e.g., in the same lane before and after a junction) along the drive on road segment 1200. Trajectories clustered by lane assignment may be useful for identifying lanes along the roadways. In some embodiments, both criteria (e.g., absolute heading and lane assignment) may be used for clustering.

In each cluster 2205, 2210, 2215, 2220, 2225, and 2230, trajectories may be averaged to obtain a target trajectory associated with the specific cluster. For example, the trajectories from multiple drives associated with the same lane cluster may be averaged. The averaged trajectory may be a target trajectory associate with a specific lane. To average a cluster of trajectories, server 1230 may select a reference frame of an arbitrary trajectory C0. For all other trajectories (C1, . . . , Cn), server 1230 may find a rigid transformation that maps Ci to C0, where i=1, 2, . . . , n, where n is a positive integer number, corresponding to the total number of trajectories included in the cluster. Server 1230 may compute a mean curve or trajectory in the C0 reference frame.

In some embodiments, the landmarks may define an arc length matching between different drives, which may be used for alignment of trajectories with lanes. In some embodiments, lane marks before and after a junction may be used for alignment of trajectories with lanes.

To assemble lanes from the trajectories, server 1230 may select a reference frame of an arbitrary lane. Server 1230 may map partially overlapping lanes to the selected reference frame. Server 1230 may continue mapping until all lanes are in the same reference frame. Lanes that are next to each other may be aligned as if they were the same lane, and later they may be shifted laterally.

Landmarks recognized along the road segment may be mapped to the common reference frame, first at the lane level, then at the junction level. For example, the same landmarks may be recognized multiple times by multiple vehicles in multiple drives. The data regarding the same landmarks received in different drives may be slightly different. Such data may be averaged and mapped to the same reference frame, such as the C0 reference frame. Additionally or alternatively, the variance of the data of the same landmark received in multiple drives may be calculated.

In some embodiments, each lane of road segment 120 may be associated with a target trajectory and certain landmarks. The target trajectory or a plurality of such target trajectories may be included in the autonomous vehicle road navigation model, which may be used later by other autonomous vehicles travelling along the same road segment 1200. Landmarks identified by vehicles 1205, 1210, 1215, 1220, and 1225 while the vehicles travel along road segment 1200 may be recorded in association with the target trajectory. The data of the target trajectories and landmarks may be continuously or periodically updated with new data received from other vehicles in subsequent drives.

For localization of an autonomous vehicle, the disclosed systems and methods may use an Extended Kalman Filter. The location of the vehicle may be determined based on three dimensional position data and/or three dimensional orientation data, prediction of future location ahead of vehicle's current location by integration of ego motion. The localization of vehicle may be corrected or adjusted by image observations of landmarks. For example, when vehicle detects a landmark within an image captured by the camera, the landmark may be compared to a known landmark stored within the road model or sparse map 800. The known landmark may have a known location (e.g., GPS data) along a target trajectory stored in the road model and/or sparse map 800. Based on the current speed and images of the landmark, the distance from the vehicle to the landmark may be estimated. The location of the vehicle along a target trajectory may be adjusted based on the distance to the landmark and the landmark's known location (stored in the road model or sparse map 800). The landmark's position/location data (e.g., mean values from multiple drives) stored in the road model and/or sparse map 800 may be presumed to be accurate.

In some embodiments, the disclosed system may form a closed loop subsystem, in which estimation of the vehicle six degrees of freedom location (e.g., three dimensional position data plus three dimensional orientation data) may be used for navigating (e.g., steering the wheel of) the autonomous vehicle to reach a desired point (e.g., 1.3 second ahead in the stored). In turn, data measured from the steering and actual navigation may be used to estimate the six degrees of freedom location.

In some embodiments, poles along a road, such as lampposts and power or cable line poles may be used as landmarks for localizing the vehicles. Other landmarks such as traffic signs, traffic lights, arrows on the road, stop lines, as well as static features or signatures of an object along the road segment may also be used as landmarks for localizing the vehicle. When poles are used for localization, the x observation of the poles (i.e., the viewing angle from the vehicle) may be used, rather than the y observation (i.e., the distance to the pole) since the bottoms of the poles may be occluded and sometimes they are not on the road plane.

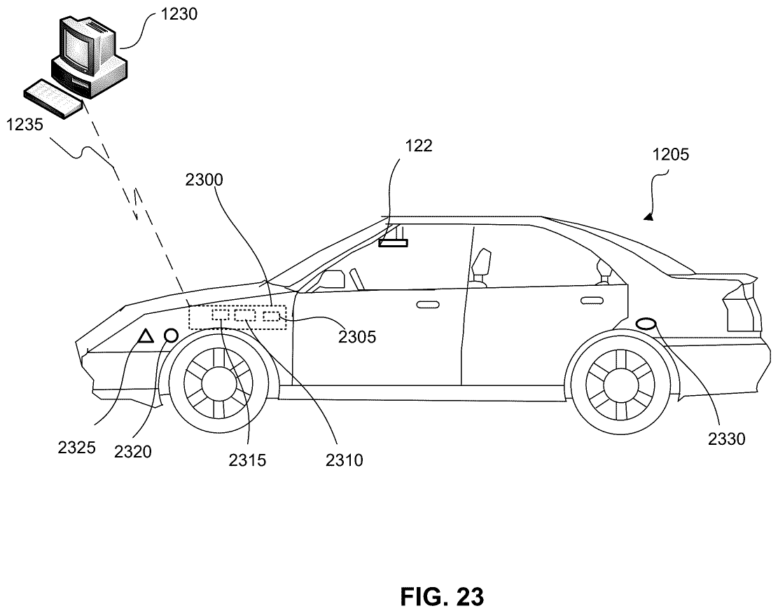

FIG. 23 illustrates a navigation system for a vehicle, which may be used for autonomous navigation using a crowdsourced sparse map. For illustration, the vehicle is referenced as vehicle 1205. The vehicle shown in FIG. 23 may be any other vehicle disclosed herein, including, for example, vehicles 1210, 1215, 1220, and 1225, as well as vehicle 200 shown in other embodiments. As shown in FIG. 12, vehicle 1205 may communicate with server 1230. Vehicle 1205 may include an image capture device 122 (e.g., camera 122). Vehicle 1205 may include a navigation system 2300 configured for providing navigation guidance for vehicle 1205 to travel on a road (e.g., road segment 1200). Vehicle 1205 may also include other sensors, such as a speed sensor 2320 and an accelerometer 2325. Speed sensor 2320 may be configured to detect the speed of vehicle 1205. Accelerometer 2325 may be configured to detect an acceleration or deceleration of vehicle 1205. Vehicle 1205 shown in FIG. 23 may be an autonomous vehicle, and the navigation system 2300 may be used for providing navigation guidance for autonomous driving. Alternatively, vehicle 1205 may also be a non-autonomous, human-controlled vehicle, and navigation system 2300 may still be used for providing navigation guidance.

Navigation system 2300 may include a communication unit 2305 configured to communicate with server 1230 through communication path 1235. Navigation system 2300 may also include a GPS unit 2310 configured to receive and process GPS signals. Navigation system 2300 may further include at least one processor 2315 configured to process data, such as GPS signals, map data from sparse map 800 (which may be stored on a storage device provided onboard vehicle 1205 and/or received from server 1230), road geometry sensed by a road profile sensor 2330, images captured by camera 122, and/or autonomous vehicle road navigation model received from server 1230. The road profile sensor 2330 may include different types of devices for measuring different types of road profile, such as road surface roughness, road width, road elevation, road curvature, etc. For example, the road profile sensor 2330 may include a device that measures the motion of a suspension of vehicle 2305 to derive the road roughness profile. In some embodiments, the road profile sensor 2330 may include radar sensors to measure the distance from vehicle 1205 to road sides (e.g., barrier on the road sides), thereby measuring the width of the road. In some embodiments, the road profile sensor 2330 may include a device configured for measuring the up and down elevation of the road. In some embodiment, the road profile sensor 2330 may include a device configured to measure the road curvature. For example, a camera (e.g., camera 122 or another camera) may be used to capture images of the road showing road curvatures. Vehicle 1205 may use such images to detect road curvatures.

The at least one processor 2315 may be programmed to receive, from camera 122, at least one environmental image associated with vehicle 1205. The at least one processor 2315 may analyze the at least one environmental image to determine navigation information related to the vehicle 1205. The navigation information may include a trajectory related to the travel of vehicle 1205 along road segment 1200. The at least one processor 2315 may determine the trajectory based on motions of camera 122 (and hence the vehicle), such as three dimensional translation and three dimensional rotational motions. In some embodiments, the at least one processor 2315 may determine the translation and rotational motions of camera 122 based on analysis of a plurality of images acquired by camera 122. In some embodiments, the navigation information may include lane assignment information (e.g., in which lane vehicle 1205 is travelling along road segment 1200). The navigation information transmitted from vehicle 1205 to server 1230 may be used by server 1230 to generate and/or update an autonomous vehicle road navigation model, which may be transmitted back from server 1230 to vehicle 1205 for providing autonomous navigation guidance for vehicle 1205.

The at least one processor 2315 may also be programmed to transmit the navigation information from vehicle 1205 to server 1230. In some embodiments, the navigation information may be transmitted to server 1230 along with road information. The road location information may include at least one of the GPS signal received by the GPS unit 2310, landmark information, road geometry, lane information, etc. The at least one processor 2315 may receive, from server 1230, the autonomous vehicle road navigation model or a portion of the model. The autonomous vehicle road navigation model received from server 1230 may include at least one update based on the navigation information transmitted from vehicle 1205 to server 1230. The portion of the model transmitted from server 1230 to vehicle 1205 may include an updated portion of the model. The at least one processor 2315 may cause at least one navigational maneuver (e.g., steering such as making a turn, braking, accelerating, passing another vehicle, etc.) by vehicle 1205 based on the received autonomous vehicle road navigation model or the updated portion of the model.

The at least one processor 2315 may be configured to communicate with various sensors and components included in vehicle 1205, including communication unit 1705, GPS unit 2315, camera 122, speed sensor 2320, accelerometer 2325, and road profile sensor 2330. The at least one processor 2315 may collect information or data from various sensors and components and transmit the information or data to server 1230 through communication unit 2305. Alternatively or additionally, various sensors or components of vehicle 1205 may also communicate with server 1230 and transmit data or information collected by the sensors or components to server 1230.

In some embodiments, vehicles 1205, 1210, 1215, 1220, and 1225 may communicate with each other, and may share navigation information with each other, such that at least one of the vehicles 1205, 1210, 1215, 1220, and 1225 may generate the autonomous vehicle road navigation model using crowdsourcing, e.g., based on information shared by other vehicles. In some embodiments, vehicles 1205, 1210, 1215, 1220, and 1225 may share navigation information with each other and each vehicle may update its own the autonomous vehicle road navigation model provided in the vehicle. In some embodiments, at least one of the vehicles 1205, 1210, 1215, 1220, and 1225 (e.g., vehicle 1205) may function as a hub vehicle. The at least one processor 2315 of the hub vehicle (e.g., vehicle 1205) may perform some or all of the functions performed by server 1230. For example, the at least one processor 2315 of the hub vehicle may communicate with other vehicles and receive navigation information from other vehicles. The at least one processor 2315 of the hub vehicle may generate the autonomous vehicle road navigation model or an update to the model based on the shared information received from other vehicles. The at least one processor 2315 of the hub vehicle may transmit the autonomous vehicle road navigation model or the update to the model to other vehicles for providing autonomous navigation guidance.

### Navigation Based on Sparse Maps

As previously discussed, the autonomous vehicle road navigation model including sparse map 800 may include a plurality of mapped lane marks and a plurality of mapped objects/features associated with a road segment. As discussed in greater detail below, these mapped lane marks, objects, and features may be used when the autonomous vehicle navigates. For example, in some embodiments, the mapped objects and features may be used to localized a host vehicle relative to the map (e.g., relative to a mapped target trajectory). The mapped lane marks may be used (e.g., as a check) to determine a lateral position and/or orientation relative to a planned or target trajectory. With this position information, the autonomous vehicle may be able to adjust a heading direction to match a direction of a target trajectory at the determined position.

Vehicle 200 may be configured to detect lane marks in a given road segment. The road segment may include any markings on a road for guiding vehicle traffic on a roadway. For example, the lane marks may be continuous or dashed lines demarking the edge of a lane of travel. The lane marks may also include double lines, such as a double continuous lines, double dashed lines or a combination of continuous and dashed lines indicating, for example, whether passing is permitted in an adjacent lane. The lane marks may also include freeway entrance and exit markings indicating, for example, a deceleration lane for an exit ramp or dotted lines indicating that a lane is turn-only or that the lane is ending. The markings may further indicate a work zone, a temporary lane shift, a path of travel through an intersection, a median, a special purpose lane (e.g., a bike lane, HOV lane, etc.), or other miscellaneous markings (e.g., crosswalk, a speed hump, a railway crossing, a stop line, etc.).

Vehicle 200 may use cameras, such as image capture devices 122 and 124 included in image acquisition unit 120, to capture images of the surrounding lane marks. Vehicle 200 may analyze the images to detect point locations associated with the lane marks based on features identified within one or more of the captured images. These point locations may be uploaded to a server to represent the lane marks in sparse map 800. Depending on the position and field of view of the camera, lane marks may be detected for both sides of the vehicle simultaneously from a single image. In other embodiments, different cameras may be used to capture images on multiple sides of the vehicle. Rather than uploading actual images of the lane marks, the marks may be stored in sparse map 800 as a spline or a series of points, thus reducing the size of sparse map 800 and/or the data that must be uploaded remotely by the vehicle.

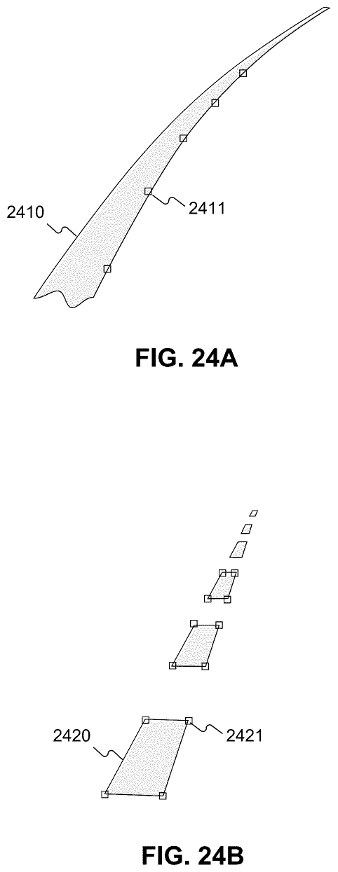

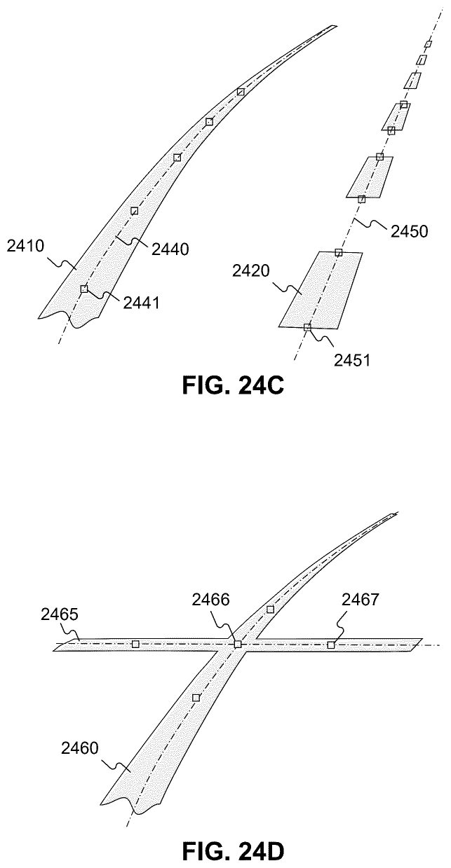

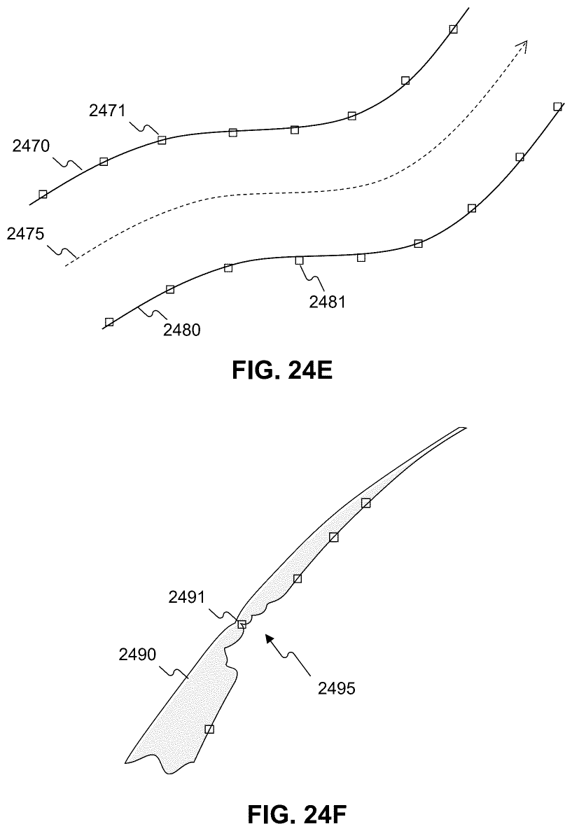

FIGS. 24A-24D illustrate exemplary point locations that may be detected by vehicle 200 to represent particular lane marks. Similar to the landmarks described above, vehicle 200 may use various image recognition algorithms or software to identify point locations within a captured image. For example, vehicle 200 may recognize a series of edge points, corner points or various other point locations associated with a particular lane mark. FIG. 24A shows a continuous lane mark 2410 that may be detected by vehicle 200. Lane mark 2410 may represent the outside edge of a roadway, represented by a continuous white line. As shown in FIG. 24A, vehicle 200 may be configured to detect a plurality of edge location points 2411 along the lane mark. Location points 2411 may be collected to represent the lane mark at any intervals sufficient to create a mapped lane mark in the sparse map. For example, the lane mark may be represented by one point per meter of the detected edge, one point per every five meters of the detected edge, or at other suitable spacings. In some embodiments, the spacing may be determined by other factors, rather than at set intervals such as, for example, based on points where vehicle 200 has a highest confidence ranking of the location of the detected points. Although FIG. 24A shows edge location points on an interior edge of lane mark 2410, points may be collected on the outside edge of the line or along both edges. Further, while a single line is shown in FIG. 24A, similar edge points may be detected for a double continuous line. For example, points 2411 may be detected along an edge of one or both of the continuous lines.

Vehicle 200 may also represent lane marks differently depending on the type or shape of lane mark. FIG. 24B shows an exemplary dashed lane mark 2420 that may be detected by vehicle 200. Rather than identifying edge points, as in FIG. 24A, vehicle may detect a series of corner points 2421 representing corners of the lane dashes to define the full boundary of the dash. While FIG. 24B shows each corner of a given dash marking being located, vehicle 200 may detect or upload a subset of the points shown in the figure. For example, vehicle 200 may detect the leading edge or leading corner of a given dash mark, or may detect the two corner points nearest the interior of the lane. Further, not every dash mark may be captured, for example, vehicle 200 may capture and/or record points representing a sample of dash marks (e.g., every other, every third, every fifth, etc.) or dash marks at a predefined spacing (e.g., every meter, every five meters, every 10 meters, etc.) Corner points may also be detected for similar lane marks, such as markings showing a lane is for an exit ramp, that a particular lane is ending, or other various lane marks that may have detectable corner points. Corner points may also be detected for lane marks consisting of double dashed lines or a combination of continuous and dashed lines.

In some embodiments, the points uploaded to the server to generate the mapped lane marks may represent other points besides the detected edge points or corner points. FIG. 24C illustrates a series of points that may represent a centerline of a given lane mark. For example, continuous lane 2410 may be represented by centerline points 2441 along a centerline 2440 of the lane mark. In some embodiments, vehicle 200 may be configured to detect these center points using various image recognition techniques, such as convolutional neural networks (CNN), scale-invariant feature transform (SIFT), histogram of oriented gradients (HOG) features, or other techniques. Alternatively, vehicle 200 may detect other points, such as edge points 2411 shown in FIG. 24A, and may calculate centerline points 2441, for example, by detecting points along each edge and determining a midpoint between the edge points. Similarly, dashed lane mark 2420 may be represented by centerline points 2451 along a centerline 2450 of the lane mark. The centerline points may be located at the edge of a dash, as shown in FIG. 24C, or at various other locations along the centerline. For example, each dash may be represented by a single point in the geometric center of the dash. The points may also be spaced at a predetermined interval along the centerline (e.g., every meter, 5 meters, 10 meters, etc.). The centerline points 2451 may be detected directly by vehicle 200, or may be calculated based on other detected reference points, such as corner points 2421, as shown in FIG. 24B. A centerline may also be used to represent other lane mark types, such as a double line, using similar techniques as above.

In some embodiments, vehicle 200 may identify points representing other features, such as a vertex between two intersecting lane marks. FIG. 24D shows exemplary points representing an intersection between two lane marks 2460 and 2465. Vehicle 200 may calculate a vertex point 2466 representing an intersection between the two lane marks. For example, one of lane marks 2460 or 2465 may represent a train crossing area or other crossing area in the road segment. While lane marks 2460 and 2465 are shown as crossing each other perpendicularly, various other configurations may be detected. For example, the lane marks 2460 and 2465 may cross at other angles, or one or both of the lane marks may terminate at the vertex point 2466. Similar techniques may also be applied for intersections between dashed or other lane mark types. In addition to vertex point 2466, various other points 2467 may also be detected, providing further information about the orientation of lane marks 2460 and 2465.

Vehicle 200 may associate real-world coordinates with each detected point of the lane mark. For example, location identifiers may be generated, including coordinate for each point, to upload to a server for mapping the lane mark. The location identifiers may further include other identifying information about the points, including whether the point represents a corner point, an edge point, center point, etc. Vehicle 200 may therefore be configured to determine a real-world position of each point based on analysis of the images. For example, vehicle 200 may detect other features in the image, such as the various landmarks described above, to locate the real-world position of the lane marks. This may involve determining the location of the lane marks in the image relative to the detected landmark or determining the position of the vehicle based on the detected landmark and then determining a distance from the vehicle (or target trajectory of the vehicle) to the lane mark. When a landmark is not available, the location of the lane mark points may be determined relative to a position of the vehicle determined based on dead reckoning. The real-world coordinates included in the location identifiers may be represented as absolute coordinates (e.g., latitude/longitude coordinates), or may be relative to other features, such as based on a longitudinal position along a target trajectory and a lateral distance from the target trajectory. The location identifiers may then be uploaded to a server for generation of the mapped lane marks in the navigation model (such as sparse map 800). In some embodiments, the server may construct a spline representing the lane marks of a road segment. Alternatively, vehicle 200 may generate the spline and upload it to the server to be recorded in the navigational model.

FIG. 24E shows an exemplary navigation model or sparse map for a corresponding road segment that includes mapped lane marks. The sparse map may include a target trajectory 2475 for a vehicle to follow along a road segment. As described above, target trajectory 2475 may represent an ideal path for a vehicle to take as it travels the corresponding road segment, or may be located elsewhere on the road (e.g., a centerline of the road, etc.). Target trajectory 2475 may be calculated in the various methods described above, for example, based on an aggregation (e.g., a weighted combination) of two or more reconstructed trajectories of vehicles traversing the same road segment.

In some embodiments, the target trajectory may be generated equally for all vehicle types and for all road, vehicle, and/or environment conditions. In other embodiments, however, various other factors or variables may also be considered in generating the target trajectory. A different target trajectory may be generated for different types of vehicles (e.g., a private car, a light truck, and a full trailer). For example, a target trajectory with relatively tighter turning radii may be generated for a small private car than a larger semi-trailer truck. In some embodiments, road, vehicle and environmental conditions may be considered as well. For example, a different target trajectory may be generated for different road conditions (e.g., wet, snowy, icy, dry, etc.), vehicle conditions (e.g., tire condition or estimated tire condition, brake condition or estimated brake condition, amount of fuel remaining, etc.) or environmental factors (e.g., time of day, visibility, weather, etc.). The target trajectory may also depend on one or more aspects or features of a particular road segment (e.g., speed limit, frequency and size of turns, grade, etc.). In some embodiments, various user settings may also be used to determine the target trajectory, such as a set driving mode (e.g., desired driving aggressiveness, economy mode, etc.).

The sparse map may also include mapped lane marks 2470 and 2480 representing lane marks along the road segment. The mapped lane marks may be represented by a plurality of location identifiers 2471 and 2481. As described above, the location identifiers may include locations in real world coordinates of points associated with a detected lane mark. Similar to the target trajectory in the model, the lane marks may also include elevation data and may be represented as a curve in three-dimensional space. For example, the curve may be a spline connecting three dimensional polynomials of suitable order the curve may be calculated based on the location identifiers. The mapped lane marks may also include other information or metadata about the lane mark, such as an identifier of the type of lane mark (e.g., between two lanes with the same direction of travel, between two lanes of opposite direction of travel, edge of a roadway, etc.) and/or other characteristics of the lane mark (e.g., continuous, dashed, single line, double line, yellow, white, etc.). In some embodiments, the mapped lane marks may be continuously updated within the model, for example, using crowdsourcing techniques. The same vehicle may upload location identifiers during multiple occasions of travelling the same road segment or data may be selected from a plurality of vehicles (such as 1205, 1210, 1215, 1220, and 1225) travelling the road segment at different times. Sparse map 800 may then be updated or refined based on subsequent location identifiers received from the vehicles and stored in the system. As the mapped lane marks are updated and refined, the updated road navigation model and/or sparse map may be distributed to a plurality of autonomous vehicles.

Generating the mapped lane marks in the sparse map may also include detecting and/or mitigating errors based on anomalies in the images or in the actual lane marks themselves. FIG. 24F shows an exemplary anomaly 2495 associated with detecting a lane mark 2490. Anomaly 2495 may appear in the image captured by vehicle 200, for example, from an object obstructing the camera's view of the lane mark, debris on the lens, etc. In some instances, the anomaly may be due to the lane mark itself, which may be damaged or worn away, or partially covered, for example, by dirt, debris, water, snow or other materials on the road. Anomaly 2495 may result in an erroneous point 2491 being detected by vehicle 200. Sparse map 800 may provide the correct the mapped lane mark and exclude the error. In some embodiments, vehicle 200 may detect erroneous point 2491 for example, by detecting anomaly 2495 in the image, or by identifying the error based on detected lane mark points before and after the anomaly. Based on detecting the anomaly, the vehicle may omit point 2491 or may adjust it to be in line with other detected points. In other embodiments, the error may be corrected after the point has been uploaded, for example, by determining the point is outside of an expected threshold based on other points uploaded during the same trip, or based on an aggregation of data from previous trips along the same road segment.

The mapped lane marks in the navigation model and/or sparse map may also be used for navigation by an autonomous vehicle traversing the corresponding roadway. For example, a vehicle navigating along a target trajectory may periodically use the mapped lane marks in the sparse map to align itself with the target trajectory. As mentioned above, between landmarks the vehicle may navigate based on dead reckoning in which the vehicle uses sensors to determine its ego motion and estimate its position relative to the target trajectory. Errors may accumulate over time and vehicle's position determinations relative to the target trajectory may become increasingly less accurate. Accordingly, the vehicle may use lane marks occurring in sparse map 800 (and their known locations) to reduce the dead reckoning-induced errors in position determination. In this way, the identified lane marks included in sparse map 800 may serve as navigational anchors from which an accurate position of the vehicle relative to a target trajectory may be determined.

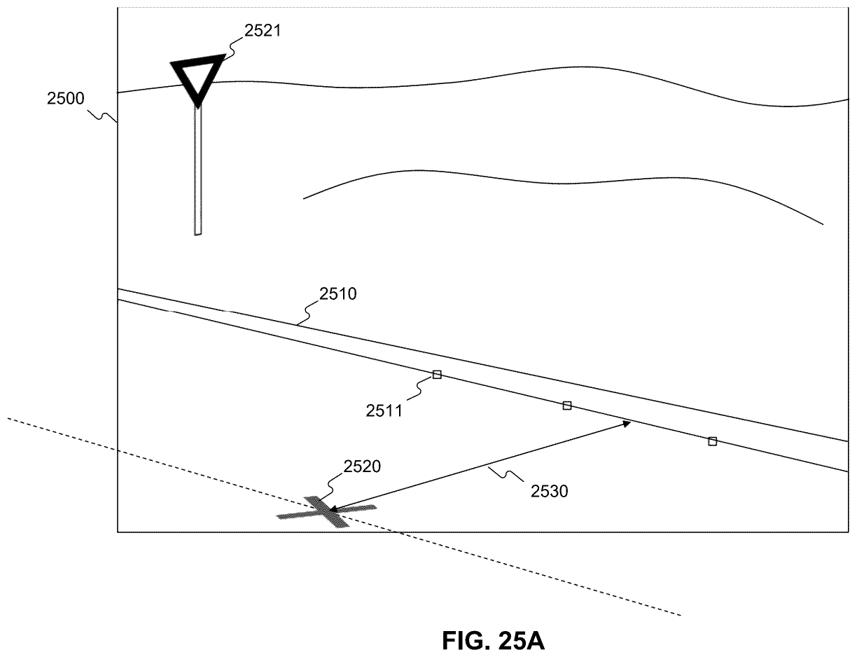

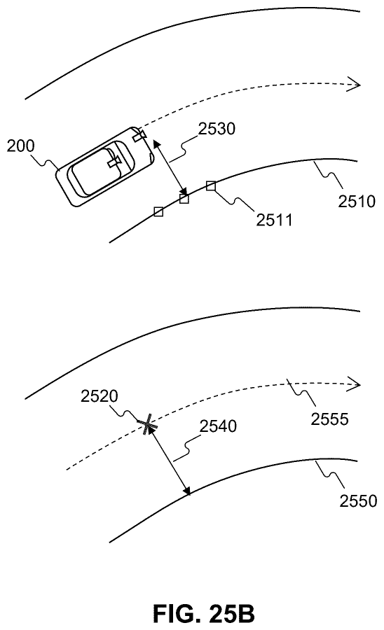

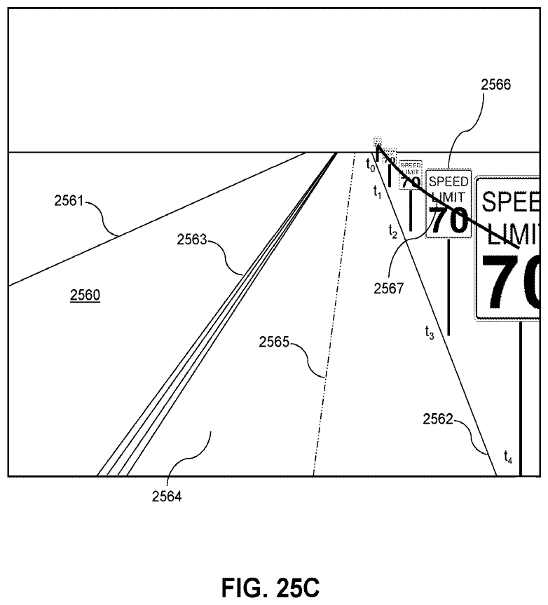

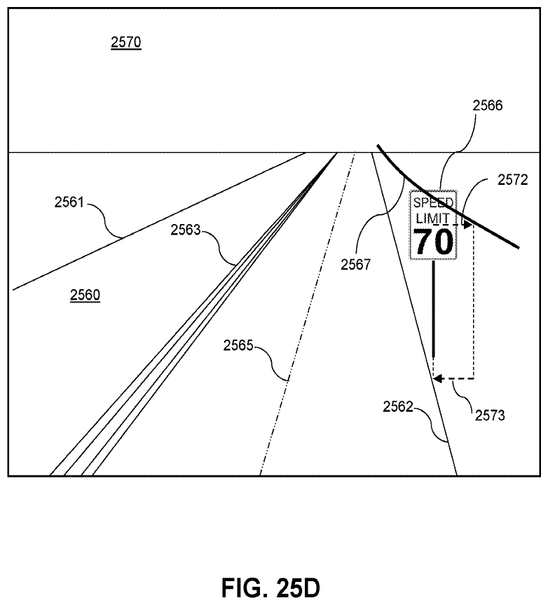

FIG. 25A shows an exemplary image 2500 of a vehicle's surrounding environment that may be used for navigation based on the mapped lane marks. Image 2500 may be captured, for example, by vehicle 200 through image capture devices 122 and 124 included in image acquisition unit 120. Image 2500 may include an image of at least one lane mark 2510, as shown in FIG. 25A. Image 2500 may also include one or more landmarks 2521, such as road sign, used for navigation as described above. Some elements shown in FIG. 25A, such as elements 2511, 2530, and 2520 which do not appear in the captured image 2500 but are detected and/or determined by vehicle 200 are also shown for reference.

Using the various techniques described above with respect to FIGS. 24A-D and 24F, a vehicle may analyze image 2500 to identify lane mark 2510. Various points 2511 may be detected corresponding to features of the lane mark in the image. Points 2511, for example, may correspond to an edge of the lane mark, a corner of the lane mark, a midpoint of the lane mark, a vertex between two intersecting lane marks, or various other features or locations. Points 2511 may be detected to correspond to a location of points stored in a navigation model received from a server. For example, if a sparse map is received containing points that represent a centerline of a mapped lane mark, points 2511 may also be detected based on a centerline of lane mark 2510.

The vehicle may also determine a longitudinal position represented by element 2520 and located along a target trajectory. Longitudinal position 2520 may be determined from image 2500, for example, by detecting landmark 2521 within image 2500 and comparing a measured location to a known landmark location stored in the road model or sparse map 800. The location of the vehicle along a target trajectory may then be determined based on the distance to the landmark and the landmark's known location. The longitudinal position 2520 may also be determined from images other than those used to determine the position of a lane mark. For example, longitudinal position 2520 may be determined by detecting landmarks in images from other cameras within image acquisition unit 120 taken simultaneously or near simultaneously to image 2500. In some instances, the vehicle may not be near any landmarks or other reference points for determining longitudinal position 2520. In such instances, the vehicle may be navigating based on dead reckoning and thus may use sensors to determine its ego motion and estimate a longitudinal position 2520 relative to the target trajectory. The vehicle may also determine a distance 2530 representing the actual distance between the vehicle and lane mark 2510 observed in the captured image(s). The camera angle, the speed of the vehicle, the width of the vehicle, or various other factors may be accounted for in determining distance 2530.

FIG. 25B illustrates a lateral localization correction of the vehicle based on the mapped lane marks in a road navigation model. As described above, vehicle 200 may determine a distance 2530 between vehicle 200 and a lane mark 2510 using one or more images captured by vehicle 200. Vehicle 200 may also have access to a road navigation model, such as sparse map 800, which may include a mapped lane mark 2550 and a target trajectory 2555. Mapped lane mark 2550 may be modeled using the techniques described above, for example using crowdsourced location identifiers captured by a plurality of vehicles. Target trajectory 2555 may also be generated using the various techniques described previously. Vehicle 200 may also determine or estimate a longitudinal position 2520 along target trajectory 2555 as described above with respect to FIG. 25A. Vehicle 200 may then determine an expected distance 2540 based on a lateral distance between target trajectory 2555 and mapped lane mark 2550 corresponding to longitudinal position 2520. The lateral localization of vehicle 200 may be corrected or adjusted by comparing the actual distance 2530, measured using the captured image(s), with the expected distance 2540 from the model.

FIGS. 25C and 25D provide illustrations associated with another example for localizing a host vehicle during navigation based on mapped landmarks/objects/features in a sparse map. FIG. 25C conceptually represents a series of images captured from a vehicle navigating along a road segment 2560. In this example, road segment 2560 includes a straight section of a two-lane divided highway delineated by road edges 2561 and 2562 and center lane marking 2563. As shown, the host vehicle is navigating along a lane 2564, which is associated with a mapped target trajectory 2565. Thus, in an ideal situation (and without influencers such as the presence of target vehicles or objects in the roadway, etc.) the host vehicle should closely track the mapped target trajectory 2565 as it navigates along lane 2564 of road segment 2560. In reality, the host vehicle may experience drift as it navigates along mapped target trajectory 2565. For effective and safe navigation, this drift should be maintained within acceptable limits (e.g., +/−10 cm of lateral displacement from target trajectory 2565 or any other suitable threshold). To periodically account for drift and to make any needed course corrections to ensure that the host vehicle follows target trajectory 2565, the disclosed navigation systems may be able to localize the host vehicle along the target trajectory 2565 (e.g., determine a lateral and longitudinal position of the host vehicle relative to the target trajectory 2565) using one or more mapped features/objects included in the sparse map.

As a simple example, FIG. 25C shows a speed limit sign 2566 as it may appear in five different, sequentially captured images as the host vehicle navigates along road segment 2560. For example, at a first time, t0, sign 2566 may appear in a captured image near the horizon. As the host vehicle approaches sign 2566, in subsequentially captured images at times t1, t2, t3, and t4, sign 2566 will appear at different 2D X-Y pixel locations of the captured images. For example, in the captured image space, sign 2566 will move downward and to the right along curve 2567 (e.g., a curve extending through the center of the sign in each of the five captured image frames). Sign 2566 will also appear to increase in size as it is approached by the host vehicle (i.e., it will occupy a great number of pixels in subsequently captured images).

These changes in the image space representations of an object, such as sign 2566, may be exploited to determine a localized position of the host vehicle along a target trajectory. For example, as described in the present disclosure, any detectable object or feature, such as a semantic feature like sign 2566 or a detectable non-semantic feature, may be identified by one or more harvesting vehicles that previously traversed a road segment (e.g., road segment 2560). A mapping server may collect the harvested drive information from a plurality of vehicles, aggregate and correlate that information, and generate a sparse map including, for example, a target trajectory 2565 for lane 2564 of road segment 2560. The sparse map may also store a location of sign 2566 (along with type information, etc.). During navigation (e.g., prior to entering road segment 2560), a host vehicle may be supplied with a map tile including a sparse map for road segment 2560. To navigate in lane 2564 of road segment 2560, the host vehicle may follow mapped target trajectory 2565.

The mapped representation of sign 2566 may be used by the host vehicle to localize itself relative to the target trajectory. For example, a camera on the host vehicle will capture an image 2570 of the environment of the host vehicle, and that captured image 2570 may include an image representation of sign 2566 having a certain size and a certain X-Y image location, as shown in FIG. 25D. This size and X-Y image location can be used to determine the host vehicle's position relative to target trajectory 2565. For example, based on the sparse map including a representation of sign 2566, a navigation processor of the host vehicle can determine that in response to the host vehicle traveling along target trajectory 2565, a representation of sign 2566 should appear in captured images such that a center of sign 2566 will move (in image space) along line 2567. If a captured image, such as image 2570, shows the center (or other reference point) displaced from line 2567 (e.g., the expected image space trajectory), then the host vehicle navigation system can determine that at the time of the captured image it was not located on target trajectory 2565. From the image, however, the navigation processor can determine an appropriate navigational correction to return the host vehicle to the target trajectory 2565. For example, if analysis shows an image location of sign 2566 that is displaced in the image by a distance 2572 to the left of the expected image space location on line 2567, then the navigation processor may cause a heading change by the host vehicle (e.g., change the steering angle of the wheels) to move the host vehicle leftward by a distance 2573. In this way, each captured image can be used as part of a feedback loop process such that a difference between an observed image position of sign 2566 and expected image trajectory 2567 may be minimized to ensure that the host vehicle continues along target trajectory 2565 with little to no deviation. Of course, the more mapped objects that are available, the more often the described localization technique may be employed, which can reduce or eliminate drift-induced deviations from target trajectory 2565.

The process described above may be useful for detecting a lateral orientation or displacement of the host vehicle relative to a target trajectory. Localization of the host vehicle relative to target trajectory 2565 may also include a determination of a longitudinal location of the target vehicle along the target trajectory. For example, captured image 2570 includes a representation of sign 2566 as having a certain image size (e.g., 2D X-Y pixel area). This size can be compared to an expected image size of mapped sign 2566 as it travels through image space along line 2567 (e.g., as the size of the sign progressively increases, as shown in FIG. 25C). Based on the image size of sign 2566 in image 2570, and based on the expected size progression in image space relative to mapped target trajectory 2565, the host vehicle can determine its longitudinal position (at the time when image 2570 was captured) relative to target trajectory 2565. This longitudinal position coupled with any lateral displacement relative to target trajectory 2565, as described above, allows for full localization of the host vehicle relative to target trajectory 2565, as the host vehicle navigates along road 2560.

FIGS. 25C and 25D provide just one example of the disclosed localization technique using a single mapped object and a single target trajectory. In other examples, there may be many more target trajectories (e.g., one target trajectory for each viable lane of a multi-lane highway, urban street, complex junction, etc.) and there may be many more mapped available for localization. For example, a sparse map representative of an urban environment may include many objects per meter available for localization.

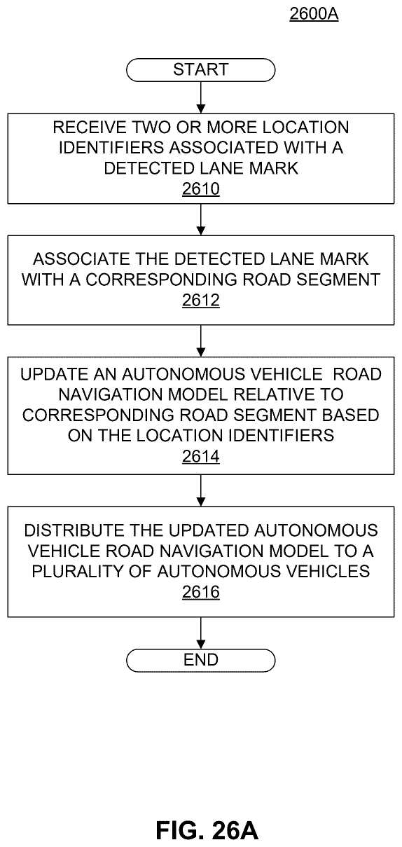

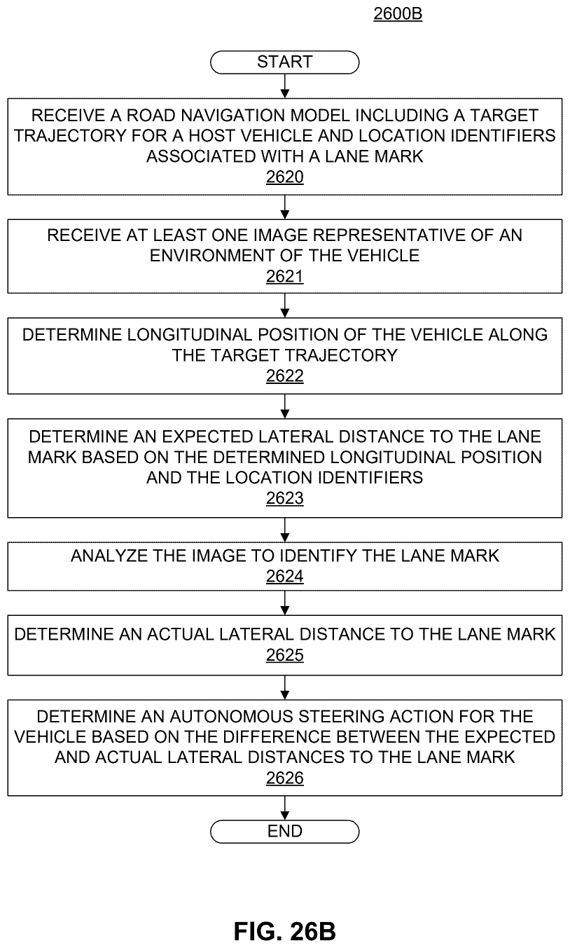

FIG. 26A is a flowchart showing an exemplary process 2600A for mapping a lane mark for use in autonomous vehicle navigation, consistent with disclosed embodiments. At step 2610, process 2600A may include receiving two or more location identifiers associated with a detected lane mark. For example, step 2610 may be performed by server 1230 or one or more processors associated with the server. The location identifiers may include locations in real-world coordinates of points associated with the detected lane mark, as described above with respect to FIG. 24E. In some embodiments, the location identifiers may also contain other data, such as additional information about the road segment or the lane mark. Additional data may also be received during step 2610, such as accelerometer data, speed data, landmarks data, road geometry or profile data, vehicle positioning data, ego motion data, or various other forms of data described above. The location identifiers may be generated by a vehicle, such as vehicles 1205, 1210, 1215, 1220, and 1225, based on images captured by the vehicle. For example, the identifiers may be determined based on acquisition, from a camera associated with a host vehicle, of at least one image representative of an environment of the host vehicle, analysis of the at least one image to detect the lane mark in the environment of the host vehicle, and analysis of the at least one image to determine a position of the detected lane mark relative to a location associated with the host vehicle. As described above, the lane mark may include a variety of different marking types, and the location identifiers may correspond to a variety of points relative to the lane mark. For example, where the detected lane mark is part of a dashed line marking a lane boundary, the points may correspond to detected corners of the lane mark. Where the detected lane mark is part of a continuous line marking a lane boundary, the points may correspond to a detected edge of the lane mark, with various spacings as described above. In some embodiments, the points may correspond to the centerline of the detected lane mark, as shown in FIG. 24C, or may correspond to a vertex between two intersecting lane marks and at least one two other points associated with the intersecting lane marks, as shown in FIG. 24D.

At step 2612, process 2600A may include associating the detected lane mark with a corresponding road segment. For example, server 1230 may analyze the real-world coordinates, or other information received during step 2610, and compare the coordinates or other information to location information stored in an autonomous vehicle road navigation model. Server 1230 may determine a road segment in the model that corresponds to the real-world road segment where the lane mark was detected.

At step 2614, process 2600A may include updating an autonomous vehicle road navigation model relative to the corresponding road segment based on the two or more location identifiers associated with the detected lane mark. For example, the autonomous road navigation model may be sparse map 800, and server 1230 may update the sparse map to include or adjust a mapped lane mark in the model. Server 1230 may update the model based on the various methods or processes described above with respect to FIG. 24E. In some embodiments, updating the autonomous vehicle road navigation model may include storing one or more indicators of position in real world coordinates of the detected lane mark. The autonomous vehicle road navigation model may also include a at least one target trajectory for a vehicle to follow along the corresponding road segment, as shown in FIG. 24E.

At step 2616, process 2600A may include distributing the updated autonomous vehicle road navigation model to a plurality of autonomous vehicles. For example, server 1230 may distribute the updated autonomous vehicle road navigation model to vehicles 1205, 1210, 1215, 1220, and 1225, which may use the model for navigation. The autonomous vehicle road navigation model may be distributed via one or more networks (e.g., over a cellular network and/or the Internet, etc.), through wireless communication paths 1235, as shown in FIG. 12.

In some embodiments, the lane marks may be mapped using data received from a plurality of vehicles, such as through a crowdsourcing technique, as described above with respect to FIG. 24E. For example, process 2600A may include receiving a first communication from a first host vehicle, including location identifiers associated with a detected lane mark, and receiving a second communication from a second host vehicle, including additional location identifiers associated with the detected lane mark. For example, the second communication may be received from a subsequent vehicle travelling on the same road segment, or from the same vehicle on a subsequent trip along the same road segment. Process 2600A may further include refining a determination of at least one position associated with the detected lane mark based on the location identifiers received in the first communication and based on the additional location identifiers received in the second communication. This may include using an average of the multiple location identifiers and/or filtering out “ghost” identifiers that may not reflect the real-world position of the lane mark.

FIG. 26B is a flowchart showing an exemplary process 2600B for autonomously navigating a host vehicle along a road segment using mapped lane marks. Process 2600B may be performed, for example, by processing unit 110 of autonomous vehicle 200. At step 2620, process 2600B may include receiving from a server-based system an autonomous vehicle road navigation model. In some embodiments, the autonomous vehicle road navigation model may include a target trajectory for the host vehicle along the road segment and location identifiers associated with one or more lane marks associated with the road segment. For example, vehicle 200 may receive sparse map 800 or another road navigation model developed using process 2600A. In some embodiments, the target trajectory may be represented as a three-dimensional spline, for example, as shown in FIG. 9B. As described above with respect to FIGS. 24A-F, the location identifiers may include locations in real world coordinates of points associated with the lane mark (e.g., corner points of a dashed lane mark, edge points of a continuous lane mark, a vertex between two intersecting lane marks and other points associated with the intersecting lane marks, a centerline associated with the lane mark, etc.).

At step 2621, process 2600B may include receiving at least one image representative of an environment of the vehicle. The image may be received from an image capture device of the vehicle, such as through image capture devices 122 and 124 included in image acquisition unit 120. The image may include an image of one or more lane marks, similar to image 2500 described above.

At step 2622, process 2600B may include determining a longitudinal position of the host vehicle along the target trajectory. As described above with respect to FIG. 25A, this may be based on other information in the captured image (e.g., landmarks, etc.) or by dead reckoning of the vehicle between detected landmarks.

At step 2623, process 2600B may include determining an expected lateral distance to the lane mark based on the determined longitudinal position of the host vehicle along the target trajectory and based on the two or more location identifiers associated with the at least one lane mark. For example, vehicle 200 may use sparse map 800 to determine an expected lateral distance to the lane mark. As shown in FIG. 25B, longitudinal position 2520 along a target trajectory 2555 may be determined in step 2622. Using spare map 800, vehicle 200 may determine an expected distance 2540 to mapped lane mark 2550 corresponding to longitudinal position 2520.

At step 2624, process 2600B may include analyzing the at least one image to identify the at least one lane mark. Vehicle 200, for example, may use various image recognition techniques or algorithms to identify the lane mark within the image, as described above. For example, lane mark 2510 may be detected through image analysis of image 2500, as shown in FIG. 25A.

At step 2625, process 2600B may include determining an actual lateral distance to the at least one lane mark based on analysis of the at least one image. For example, the vehicle may determine a distance 2530, as shown in FIG. 25A, representing the actual distance between the vehicle and lane mark 2510. The camera angle, the speed of the vehicle, the width of the vehicle, the position of the camera relative to the vehicle, or various other factors may be accounted for in determining distance 2530.

At step 2626, process 2600B may include determining an autonomous steering action for the host vehicle based on a difference between the expected lateral distance to the at least one lane mark and the determined actual lateral distance to the at least one lane mark. For example, as described above with respect to FIG. 25B, vehicle 200 may compare actual distance 2530 with an expected distance 2540. The difference between the actual and expected distance may indicate an error (and its magnitude) between the vehicle's actual position and the target trajectory to be followed by the vehicle. Accordingly, the vehicle may determine an autonomous steering action or other autonomous action based on the difference. For example, if actual distance 2530 is less than expected distance 2540, as shown in FIG. 25B, the vehicle may determine an autonomous steering action to direct the vehicle left, away from lane mark 2510. Thus, the vehicle's position relative to the target trajectory may be corrected. Process 2600B may be used, for example, to improve navigation of the vehicle between landmarks.

Processes 2600A and 2600B provide examples only of techniques that may be used for navigating a host vehicle using the disclosed sparse maps. In other examples, processes consistent with those described relative to FIGS. 25C and 25D may also be employed.

In some embodiments, the disclosed systems, methods, and non-transitory computer-readable media may use one or more AV maps. An autonomous vehicle (AV) map (or AV map) may include information to support and/or implement one or more autonomous vehicle (AV) functions of a vehicle in manner such that the vehicle operates in a safe manner and/or navigates in an accurate manner. The AV functions supported and/or implemented by an autonomous vehicle (or a semi-autonomous vehicle) may include one or more autonomously controlled functions (e.g., functions determined, selected, and/or implemented based on instructions executed by at least one processor) such as steering, accelerating, and/or braking the vehicle. The AV functions may be part of a driving policy, such as RSS, for example, which was developed and is implemented by Mobileye, of Jerusalem, Israel. The information for operating the vehicle in a safe manner may include, but is not limited to, information pertaining to one or more regulations applicable to a location of the vehicle or a jurisdiction (e.g., a right-hand traffic or left-hand traffic jurisdiction), information related to an environment in which the vehicle is located (e.g., information related to a drivable path, stop sign, traffic light, speed limit, lane markings, landmarks, free space, virtual or physical stop lines, traffic light relevancy information, etc.), and/or information related to adjusting and/or adapting navigation of the vehicle to account for one or more objects (e.g., other vehicles, pedestrians, objects, obstacles, occlusions, hazards, road work zones, traffic cones, etc.) in an environment of the vehicle. The vehicle may sense objects in the environment of the vehicle using one or more sensors (e.g., cameras, radar, lidar), as discussed herein. The AV map may serve as a redundant source of information for the sensed information and, in some cases, may also supplement the sensed information (e.g., provide a location of a virtual stop line, where no stop line is marked on the road). In some embodiments, operating the vehicle in a safe manner may further include operating the vehicle to maintain a comfort level for one or more passengers in the vehicle. The comfort level may include one or more predetermined criteria (e.g., related to speed, acceleration, and/or turning) selected to cause the vehicle to operate in a manner that meets or exceeds a designated or selected level of passenger comfort. The level of comfort may be formalized and expressed in appropriate mathematical formulae. For example, mathematical formulae that limit the extent of jerk or acceleration in different directions that is applied to a passenger may be used. The information for operating the vehicle in an accurate manner may include, but is not limited to, information pertaining to a planned or designated navigational path (e.g., a trajectory, as discussed herein) or a route (e.g., from a particular location, such as a starting location, to a destination). In some embodiments, the information included in an AV map may further include information that supports and/or implements one or more AV functions in an efficient manner. The information for operating the vehicle in an efficient manner may include information pertaining to speed, acceleration, lane changes, and/or lane positioning, and/or traveling and/or selecting a path or route based on traffic conditions (e.g., traveling a route that is a greater distance than a shorter route experiencing traffic conditions) and/or other factors or attributes related to potential routes (e.g., weather conditions, road conditions, or other characteristics of routes, such as traveling a highway without traffic lights instead of a road with traffic lights). In some embodiments, the AV map may further include at least some information from a high-definition (HD) map. In some embodiments, the AV map may be a sparse map, as described above. In some embodiments, the AV map may be crowdsourced, as discussed herein. In this disclosure, the terms “AV map” and “sparse map” are used interchangeable.

Network Generation of Target Trajectories from Road Topography Features

As previously discussed, the autonomous vehicle road navigation model including sparse map 800 may be configured to assist navigation based on map information (e.g., sparse map information) that may include crowdsourced information obtained based on a plurality of mapped objects/features associated with a road segment. This navigation assistance may occur, for example, when existing driven path information such as previously determined target trajectories/drivable paths are available. For example, navigation assistance may include using mapped landmarks (e.g., objects, features, etc.) to account for errors between a target trajectory and a real-world drivable path. In some cases, navigation assistance may take place over, for example, new and/or previously unmapped road segments, areas with outdated information, and/or road segments in which changes have been made to the road segments or regions surrounding road segments. In such case, a target trajectory for navigation over the road segment may not be available.

According to embodiments of the present disclosure, it may be possible to generate target trajectories without first obtaining crowdsourced information including trajectories previously travelled by one or more host vehicles. By not relying on actually travelled host vehicle trajectories for generation of target trajectories, assisted navigation along, for example, new lanes or paths connected to a rarely traveled road, areas with new roads or road segments, areas with roads that are drivable but may not appear as obvious roads, can be facilitated. Such road segments may, for example, have no previous record of actual driven paths, a low number of driven paths (e.g., fewer than ten) in a road segment or region of a road segment, difficulty in aligning target trajectories with drivable paths, forbidden or seemingly illegal maneuvers by drivers, or any combination thereof. In these cases, among others, a preexisting target trajectory may not exist, or recalculation may be desirable.

Furthermore, using mapped objects/features may allow, for example, a plurality of host vehicles in a road segment, regardless of each host vehicle's path, lane, direction, or the like, to contribute to the determination of target trajectories for a particular road segment. This determination may be useful for example, for other nearby drivable paths in the vicinity of host vehicles that may navigate such road segments. This approach may further provide higher confidence in the determination of a target trajectory with an otherwise low number of host vehicles traveling along that target trajectory, for example.

As used herein, a road or road segment may include any type of path that is navigable by a host vehicle, and is not intended to be limited to paved or pre-constructed road segments. For example, a drivable road or path may include highways, rural roads (e.g., field paths), gravel paths, dirt paths, trails, alleyways (e.g., between buildings), etc.

In some embodiments, road topography features for a road segment or region of a road segment are detected. Indicators representative of road topography features associated with a road segment are aggregated, for example, using techniques described above, and used to generate target trajectories, for example, without using aggregation of actual driven paths crowdsourced from a plurality of host vehicles. Road topography features may refer to any topographical features associated with the drivable path that may facilitate identification of location and generation of corresponding target trajectories. Road topography features may include, for example, lane markings, temporary changes to the road, landmarks around a road, miscellaneous markings, landscapes, flora, and any general variations in road topography. For example, in some cases general variations in road topography may include land-related variations such as sudden curves and elevation changes. In other cases, general variations may include potential road hazards or temporary problems such as a tree leaning over a road, or a pothole in the road. In still additional cases, road topography features may include geographical features, such as, for example, rivers, lakes, trees, and boulders, and any combination thereof.

In some embodiments, an image representation may be generated based on the indicators of detected road topography features. Such representations may include a simplification of the road topography features, which can be represented as, for example, a collection of points, splines, or shapes that capture, for example, a feature edge, corner, and/or midline of a corresponding road topography feature. The image representation may be, for example, indicative of a surface or two-dimensional projection of a three-dimensional road topography feature. As described above, some illustrative representations of road topography features and indicators are shown in FIG. 24A-F.

In some embodiments, the image representation of road topography for a road segment is input into a trained model configured to generate a target trajectory for the road segment. Target trajectories generated in this way may be stored, for example, along with map information associated with a corresponding road segment on a server, and shared with at least one other host vehicles in the network, among other things.

In some embodiments, map information may be generated for use in navigating a host vehicle relative to a road segment using at least one processor with circuitry and memory in a manner as described previously. Briefly, at least one processor may include any of the EyeQ™ series of processors or any aftermarket processor available, such as Intel or AMD processors, and the at least one processor may operate with a memory with instructions that are configured to allow for navigation of a host vehicle using map information. According to some embodiments, map information may include, for example, any of the previously described sparse map information, images of the environment around a host vehicle, road topography features obtained from at least one host vehicle, etc. Any such information may be uploaded to a server and used to calculate target trajectories for use in navigation.

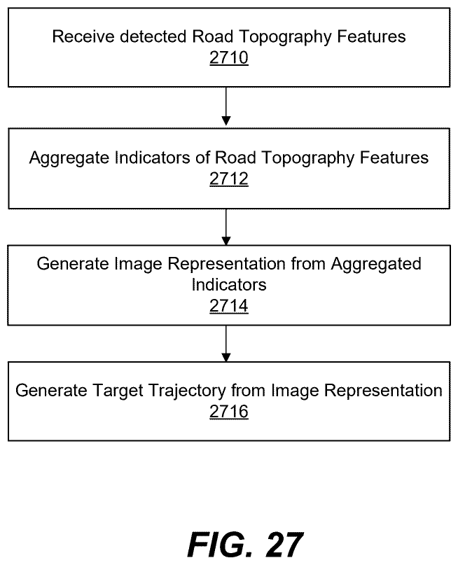

FIG. 27 shows an exemplary process 2700 for generating target trajectories from road topography features. Step 2710 may include receiving detected road topography features associated with a road segment or region of a road segment. As discussed previously, a host vehicle such as vehicle 200 may use cameras such as image capture device 122, 124, 126, included in image acquisition unit 120 to obtain images of road topography features, such as those shown in FIG. 10 and FIG. 15, for example. The road topography features may be converted to indicators (e.g., metadata describing the road topography features), as described above, which may be aggregated (step 2712). In step 2714, the aggregated indicators of road topography features may be used to generate an image representation of a road segment. In step 2716, at least one target trajectory may be generated from the image representation of road topography features. This may facilitate navigation of a host vehicle using only the input road topography features, rather than actual driven paths, i.e., actual trajectories taken by one or more host vehicles. The process 2700 is an illustrative series of steps intended to facilitate description of the present embodiments and as such corresponds to one illustrative combination of features of the disclosed embodiments. The steps of process 2700 may be performed independently, combined with other features of the present disclosure, and/or modified without departing from the scope of the present disclosure.

At step 2710, detected road topography features. In some embodiments, drive information is received from each of a plurality of vehicles traversing or having traversed a road segment. The drive information may include indicators representative of road topography features associated with the road segment, which may be consistent with the mapped objects/features as described previously.

In addition to these indicators, drive information may also include any type of information related to a host vehicle driving along a road segment, including quantitative, qualitative, and various types of metadata related to a host vehicle and/or a road segment. Such information or metadata may include, for example, data about the operating conditions of the host vehicle, relative velocity, driving direction, orientation of the host vehicle, data about other observed vehicles in the road segment, time stamp information, GPS data, and weather conditions.

Drive information collected by a host vehicle may be processed internally or sent to a system outside the host vehicle for further processing. For example, drive information may be sent via wireless connection to a server via mobile communication protocols (e.g., 4G, 5G, etc.) satellite communications, etc., as described previously. At least one processor of the server may be used to perform analyses of the drive information, such as, for example, determining driving behavior during navigation of the road segment. According to some embodiments, the drive information may be added to a collection of pre-existing information regarding each road segment, and/or used to generate new information to be stored in a database associated with a corresponding road segment, for example.

Consistent with some embodiments, the indicators representative of road topography features may identify a feature type and a position associated with each of the road topography features. For example, a feature type may refer to any categorization, characterization, condition, or qualification of road topography features that can be used to distinguish one feature from another, e.g., a “stop sign” may be categorized as such.

Distinguishing features may be identifiable via a camera system such as the one described in FIG. 2A-E in conjunction with image analysis. For example, distinguishing features of road topography features may include one or more of a shape, size, color, quantity, aspect ratio, edge contrast, material composition, and reflectance. Examples of feature types include, but are not limited to, a lane marking, a road edge, a traffic sign, a traffic light, a lamp post, a building, a road barrier, a speed bump, a tree, an off-ramp, etc. According to some embodiments the features may be stationary, but in some cases may be transitory (e.g., during periods of road construction) and hence evolving along a road segment.

The indicators associated with these feature types may include position information, which, in some embodiments, includes a three-dimensional, real-world position, which may be determined using absolute coordinates obtained from a GPS device associated with the vehicle capturing the drive information, for example. Alternatively, or additionally, the position may be determined as a relative position, where each indicator may be assigned a position relative to a position of other detected road topography features.

Furthermore, consistent with some embodiments, relative position information may be identified as a two-dimensional position relative to, for example, an image frame. The relative position may include pixel coordinates within one image frame, or pixel coordinates for a tracked object between consecutive or any subsequent image frames in a sequence. Such a relative position may be determined based on GPS coordinates relative to the host vehicle or any object within an image frame, for example. According to some embodiments, an image frame may include a point of reference that may be used to determine an absolute position or real-world coordinates in time and/or space.

Indicators of road topography features may be aggregated for purposes of generating an image representation of road topography for a corresponding road segment (step 2712). Aggregating indicators may facilitate summarizing characteristics of features and organizing of features into logical groups using statistical or computational methods, for example.

According to some embodiments, aggregation may include extracting certain data features by combining multiple data features from a collection of different datasets. For example, data aggregation can include in-network aggregation, tree-based approach, cluster-based approach, and multi-path approach and may involve time aggregation, spatial aggregation, or a combination thereof. Aggregating the indicators may include combining some or all of the indicators having information associated with a particular road segment or a common event, among others. For example, aggregating may include one or more of assessing, classifying, categorizing, scoring, labeling, and/or combining indicators into a single aggregate indicator vector. According to such embodiments, each image may contain a road topography feature that is assigned an indicator including time, position, and characteristic information, and the subsequent image frames may have a matching indicator. In this example, the indicator detected in multiple image frames may be recognized during aggregation and assigned to a new road topography feature, or matched to a pre-existing road topography feature or indicators in a map, database, or image representation of road topography of the road segment.

Consistent with some embodiments, the aggregation of the indicators may include alignment of the drive information received from one or more of a plurality of vehicles. Alignment of the received drive information may be performed in a manner consistent with the alignment described previously herein.

Alignment may include positioning indicator location and orientation in time and space relative to a host vehicle, and/or positioning drive information from a plurality of vehicles traversing a road segment, relative to the positions of any previously aggregated indicators, for example. By acquiring drive information from a plurality of vehicles, similar or identical indicators can be detected repeatedly to provide an updated aggregation, such that confidence in the aggregation of indicators reflecting a road segment can be increased, thereby reducing errors between road topography features in the real-world road segment and the aggregated indicators. For example, a first host vehicle may transmit new indicator information to a server, a second host vehicle may also transmit information associated with the same indicator to the server, and this may be recognized by the server to increase confidence during aggregation to achieve an accurate representation of a road topography feature in a road segment.

The aggregation of the indicators may include determining refined positions associated with each of the road topography features. Refined positions as described previously, may be determined based on the aggregation of the road topology indicators. For example, refined positions of indicators may be <10 cm from the real-world positions of the associated road topography features. Availability of refined positions may be useful for navigation, for example, where novel target trajectories may be generated based on these aggregated indicators having refined positions.

Aggregating indicators of a road segment may facilitate generation of an image representation of road topography of the road segment that may be constantly updated (e.g., real-time) using data provided by one or more host vehicles traversing the road segment (step 2714). The image representation may refer, for example, to a map generated based on the indicators, the map being matched to physical coordinates or other known information about a road segment in the real world.

Image representation may also refer to, for example, a group of mapped indicators that are used to construct an artificial representation of a road segment without having any direct imaging or physical coordinate information from absolute coordinates (e.g., GPS coordinates). In this case, the image representation may contain indicators having relative coordinates in which the position of each indicator is assigned coordinates relative to one another, or relative to some point of reference, such as the host vehicle. For example, according to such embodiments, one or more points of reference for each indicator may be stored with each corresponding indicator, such that an appropriate point of reference may be determined when an indicator is accessed. Image representations prepared in this way may consume substantially less data storage for a map of road segments, and bandwidth for transfer to target vehicles, than transferring image or more detailed data for use in navigation.

Image representations prepared according to embodiments of the present disclosure may, therefore, not appear as images per se, but rather as datasets, for example, of coordinates and feature metadata (e.g., descriptions, categorizations, identifiers, etc.) Such datasets may, for example, represent at least the minimum information necessary to allow for identifying road topology features and locations thereof, to facilitate navigation of a road segment.

Consistent with some embodiments, the indicators may be input into one or more trained neural networks, and the one or more trained neural networks may be updated based on the aggregated indicators. Trained neural networks implemented in conjunction with embodiments of the present disclosure have been described above and may include the use of labeled or pre-labeled training data sets, e.g., for training. Trained neural networks may include models such as deep learning, feedforward artificial neural networks, perception and multilayer perceptron neural networks, radial basis function artificial neural networks, recurrent neural networks, and modular neural networks, among others. The use of neural networks is not limited to the list provided herein, and other types of machine learning, neural network, and artificial intelligence approaches may be used in conjunction with any of the embodiments discussed herein.

According to some embodiments, the aggregated indicators of road topography features may be used to continuously update the trained neural network models, as new or modified indicators are input into the models. For example, a trained neural network may include the classification and aggregation of indicators for a road segment, and a new indicator in the road segment may be identified based thereon and used to update the neural network.

Consistent with some embodiments, the one or more trained neural networks may be configured to output an updated image representation of road topography associated with the road segment based on the aggregated indicators. According to some embodiments, an updated image representation may be generated from the output of one or more trained neural networks by inputting feature information of the aggregated indicators into the one or more trained neural networks. Feature information may refer to any aspect of the aggregated indicators which may be useful for identification or characterization. For example, feature information may include one or more of size, shape, color, position in time, position in space, relative position to other indicators, and neighborhood information. While an aggregation of feature information may provide the greatest accuracy for navigation, in some cases, an image representation could include at least one indicator from a single harvest vehicle or single datum for use in navigation.

In some cases, an image representation may already exist based on previously aggregated indicators for a road segment, based on the input from one or more host vehicles. Additional information regarding the indicators may, for example, be continuously added to or integrated with the previously aggregated indicators, based on, for example, input from any further host vehicles traversing the road segment. The newly aggregated indicators may be fed as input to a trained neural network to provide an updated image representation of the road topography of the road segment based on that new information.

Consistent with some embodiments, the output of the one or more trained neural networks may include representations of the indicators, for example, polygonal representations. Polygonal representations may include, for example, a series of points in two or three dimensions arranged into a shape of any number of edges or corners. For example, a polygonal representation may include a rectangular shape indicative of the two-dimensional projection of a three-dimensional box over a road segment. In another example, a polygonal representation may include a series of positional coordinates linked together in some way to indicate a particular geometry associated with an object or set of objects in a road segment.

Alternatively, or additionally, consistent with some embodiments, the output of the one or more trained neural networks may include point information and metadata representing the indicators. The metadata may be quantitative or qualitative and may refer to any information that helps to identify or describe data. For example, a traffic sign may be represented as a point indicative of the midline of the sign, with spatial coordinates locating the point in a road segment, and with metadata identifying the type and purpose of the traffic sign (e.g., a “stop” sign.) These representations correspond to a form of digital compression of real-world information, for example. In other words, by representing a real-world object as, for example, a type, location, and description, a digital representation may be readily generated absent image data.

Consistent with some embodiments, the image representation of road topography of the road segment may include, for example, a two-dimensional top view of a corresponding road segment and a road topography of the road segment. While in some cases it may be useful to generate a three-dimensional image representation of road topography features in a road segment, frequently, a two-dimensional top-down view of the road segment is sufficient to enable effective navigation through the road segment, and both data and processing bandwidth can be reduced thereby. An example of a top-down view is shown in FIG. 25B, and as shown may include points, lines, polygons, or other information from aggregated indicators.

A target trajectory may be generated from the image representation (step 2716). In some embodiments, the image representation of road topography of the road segment may be provided as input to at least one trained model configured to generate, in response to the provided input, an output including at least one target trajectory for the road segment. Furthermore, consistent with some embodiments, the at least one trained model may include one or more trained neural networks, as described previously. The trained model may be configured to operate in combination with, or independently from the previously described trained models, including the trained model used to aggregate the indicators of road topography features.

According to some embodiments, all or part of the image representation, including individual indicators, may be used as input to the trained model. For example, the aggregated indicators may include an assortment of road topography features in a road segment, and an output target trajectory from the trained model may include a calculated path for steering a target vehicle through the road segment, without any previous actual driven path information. In this case, the system may enable a target vehicle to navigate through the road segment along a novel path over which no previous harvesting vehicle had driven, for example.

Consistent with some embodiments, the road segment may be an arbitrary road segment over which a host vehicle has not driven. An arbitrary road segment may refer to any road segment not previously driven, or one recognized as a drivable path but for which no previous drive information exists. For example, an arbitrary road segment may include a new intersection, new side road, new on/off ramp, or any other new or altered road segment. According to another example, an arbitrary road segment may include a road segment for which navigation would otherwise not be possible absent a sufficient number of harvesting host vehicles traversing the road segment, and/or aggregated indicators being provided the server. According to such embodiments, a desired number of aggregated indicators may be provided by, for example, host vehicles traveling along adjacent or nearby road segments. In this case, the aggregated indicators may be collected to allow for generation of a target trajectory without a host vehicle previously traveling along the actual trajectory.

The arbitrary road segment may include a road segment over which the host vehicle previously did not have the target trajectory generated by the at least one trained model, for example, where a novel target trajectory is being generated by the trained model.

Consistent with some embodiments, at least one target trajectory may include a plurality of target trajectories, wherein each of the plurality of target trajectories is associated with a different lane of travel of the road segment. For example, if a new highway ramp with two lanes is developed and indicators from host vehicle images showing two lanes merging into the highway are aggregated, a target trajectory for the highway ramp may include at least two target trajectories representing the two lanes of the ramp. Generation of such target trajectories may be possible from aggregated indicators even without host vehicles actually having traversed the ramp. For example, the ramp may still be under construction and not open to drive, but the target trajectories may still be determined based on the presence of the road topographic features associated with the ramp. According to some embodiments, the plurality of target trajectories may be representative of all lanes of travel associated with the road segment.

A road segment may include, for example, a junction and at least one target trajectory associated therewith may include a plurality of target trajectories each representative of a different navigable path through the junction. A junction, or intersection, may include, for example, any intersecting paths or road segments, as described previously herein. The intersecting paths may, for example, be identified by yield signs, yield markers, stop lines, stop signs, or traffic lights. Alternatively, in some cases, no identifiable marker or sign may be present, and the intersecting paths or trajectories may be the only indication of the junction.

Aggregated indicators may enable determination of a plurality of navigable paths through a junction, and, in some cases, may not rely on any paths actually driven by host vehicles. The resulting plurality of target trajectories may be representative of all navigable paths through the junction, with some of the paths being otherwise inaccessible absent traversal by a harvesting host vehicle, which may or may not transpire in a reasonable period time (e.g., less than 1 week). Providing such options to navigation may aid in improving the flow of traffic or even help in emergency situations, for example.

Consistent with some embodiments, a road segment may include, for example, a roundabout and the at least one target trajectory may include a plurality of target trajectories each representative of a different navigable path through the roundabout. Navigation of a roundabout may be complicated in that some roundabouts are multi-lane with certain lanes being well-marked, while others have no lane markings and may even comprise open road space to be navigated. Furthermore, a roundabout may have a variety of entries and exits at a variety of angles. Aggregated indicators, which may include representations of any available lane markers and other road topology features, may allow for generation of one or more target trajectories using embodiments of the present disclosure such that a vehicle may traverse a roundabout using at least one of a plurality of navigable paths. Consistent with some embodiments, target trajectories may be representative of all navigable paths through the roundabout, and may be obtained based on a collection of aggregated indicators, as described herein. In some cases, a target trajectory in a road segment such as a roundabout may include, for example, a path along a line, a path with a width, etc., which may allow for lateral positional variations within the roundabout. For example, where steering adjustments are undertaken in the roundabout, such lateral positional variation may enable maintenance within a predetermined threshold (e.g., 20 cm) of a designated target trajectory.

Generating target trajectories from aggregated indicators may be useful in any number of navigational environments. For example, in addition to the above examples, a target trajectory may be associated with at least one of a highway exit lane, a highway entrance lane, a parking lot, etc. Each of these environments may include various road topography features which can be represented as indicators for use generation of target trajectories for navigating along the road segment.

Consistent with some embodiments, a target trajectory may be represented as a three-dimensional spline, as described previously. An image representation of aggregated indicators may be used to generate a novel three-dimensional spline that forms the basis for a target trajectory. For example, the aggregated indicators may be determined to include road edge information and centerline information, and a least-squares calculation may be used to determine a three-dimensional spline for a target trajectory along that road segment.

In some embodiments, target trajectories may be stored with, map information corresponding to a road segment for which a respective target trajectory applies. The map may include representations of an environment or area, as described previously, and may be formed from any combination of aggregated indicators, image representations, images from host vehicles, actual driven paths, or other information associated with road segments.

Map information may be continuously updated, as new or modified image representations are added or replaced. For example, target trajectories determined from the image representation of aggregated indicators may be stored relative to other indicators or paths stored in a map.

The map may be comprised of a plurality of tiles, each of which may represent a road segment. Consistent with some embodiments, the map may be stored as a plurality of tiles, each of which may be edited and updated independently. During navigation, these tiles may be provided individually, or in any combination, for example. For example, where a host vehicle is navigating in a particular region, only tiles relating to that region may be provided to the host vehicle. As the host vehicle proceeds to navigate, tiles may be downloaded in anticipation of the host vehicle navigating in any of the available paths.

In some embodiments, map information (e.g., a map) may be provided to at least one host vehicle navigation system for use in navigating the host vehicle relative to road segment, based on, for example, one or more target trajectories stored in the map information in a manner similar to that described previously. For example, the map may have updated information representing a new road segment connected to a previously navigated road segment, where the new road segment was characterized from the image representation of aggregated indicators of road topography features in a road segment. Target trajectories determined from the image representation may then be added to the map for future navigation of host vehicles along the new road segment.

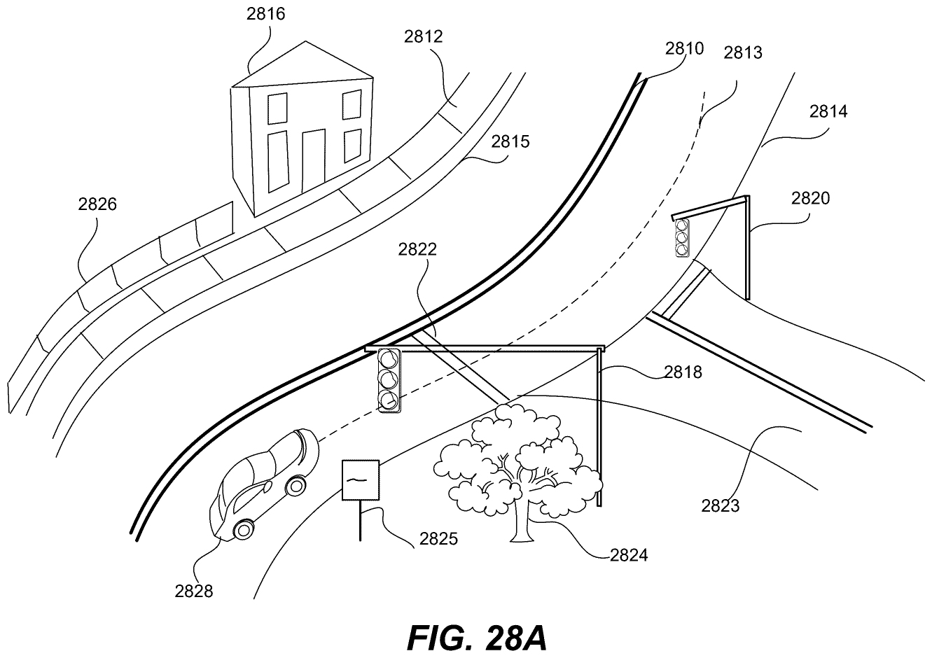

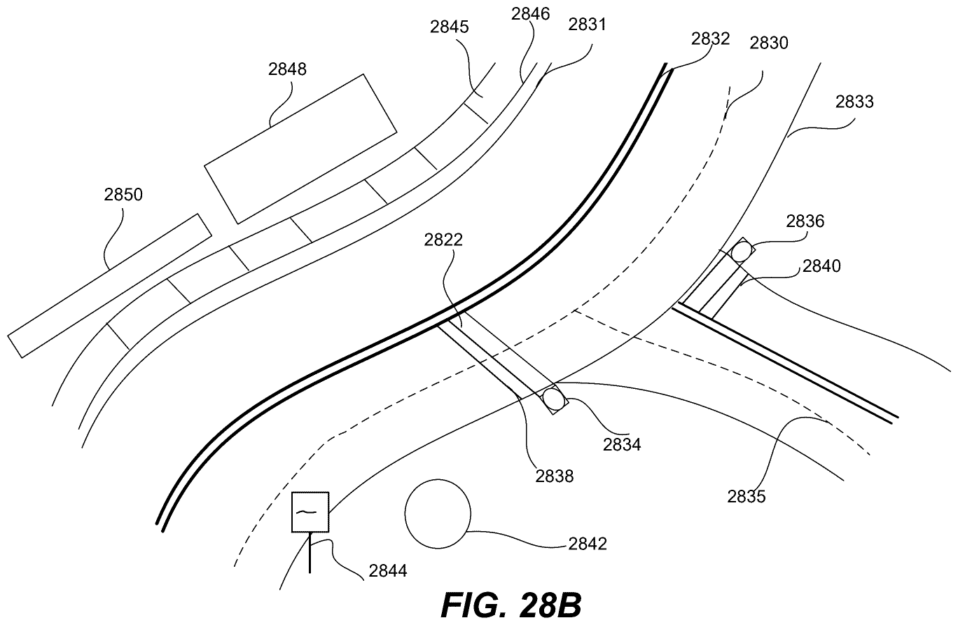

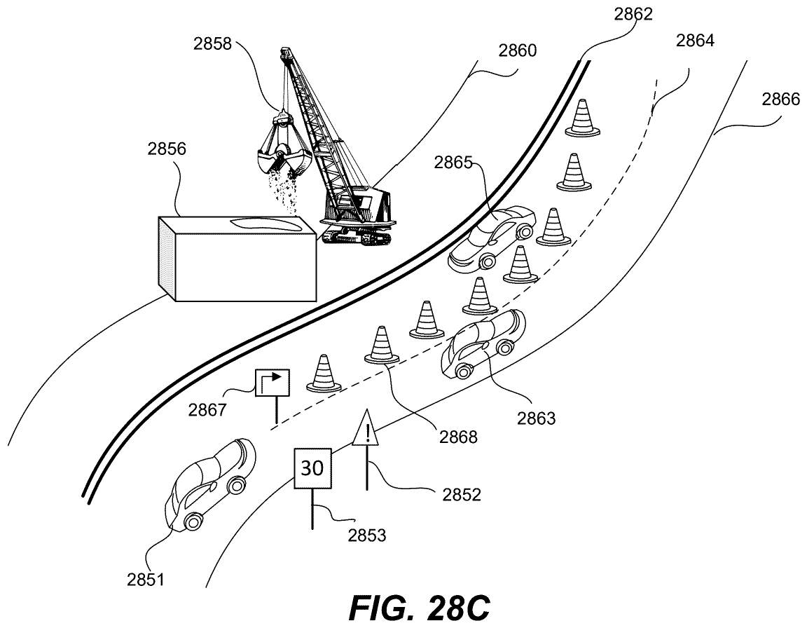

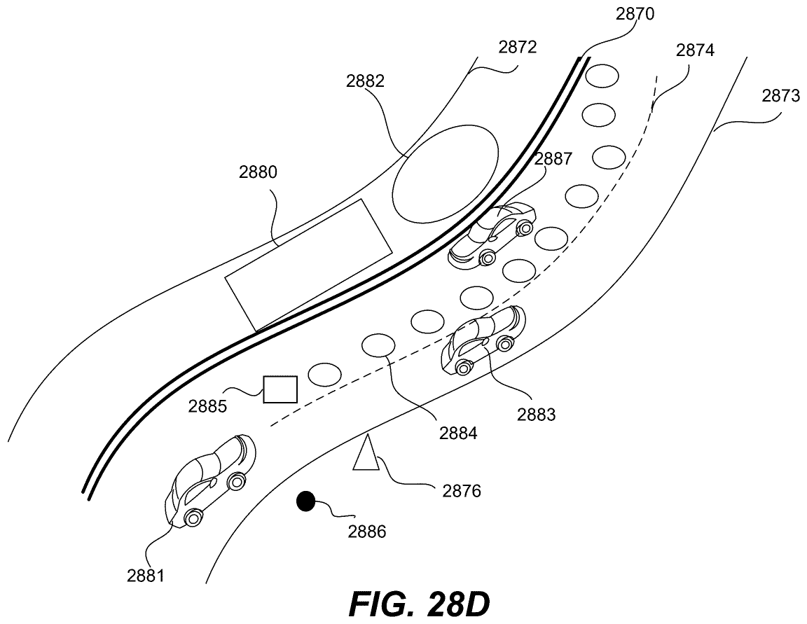

FIG. 28A-D show illustrations of new or altered road segments to be navigated based on target trajectories generated using aggregated indicators as described above. FIGS. 28A and 28C illustrate navigation of host vehicles through road segments having new information where generation of new target trajectories is desirable. FIGS. 28B and 28D illustrate image representations of indicators of road topography features in two-dimensional top-down views of the road segments of FIGS. 28A and 28C, respectively.

FIG. 28A illustrates road topography features associated with a road segment for which a target trajectory is not available, consistent with the disclosed embodiments. According to FIG. 28A a curved road segment with centerline 2810, right road edge 2814, left road edge 2815, and a host vehicle 2828 traversing the road segment along known target trajectory 2813 is shown. Known indicators of road topography features along the road segment may include, for example, a wall 2826, a building 2816, a sidewalk 2812, a tree 2824, and a sign 2825, among others. A new intersection (i.e., previously unknown in map information associated with the curved road segment under consideration) is shown with a new road 2823, new traffic lights 2818 2820 and new stop lines 2822. Navigation through the intersection may be altered, and new navigable paths may be produced.

To increase the efficiency and accuracy of navigation through the intersection of FIG. 28A, an aggregation of indicators, both new and pre-existing, may occur based on, for example, road topography features detected by host vehicle 2828.

FIG. 28B illustrates at least one new target trajectory 2835 generated based on indicators of road topography features, consistent with the disclosed embodiments. As shown at FIG. 28B an image representation may be updated based on the aggregation of indicators, both new and pre-existing, shown in FIG. 28A. Indicators of road topography features in this illustrative image representation are shown as points, lines, polygons, and other closed shapes, for example. These geometric representations, i.e., indicators, may also include additional information or representations such as colors, size, location, etc. Centerline 2832, right road edge 2833, left road edge 2831, known target trajectory 2830, wall 2850, building 2848, sidewalk edges 2845 2846, tree 2842, and sign 2844 are also shown.

New indicators in the image representation of FIG. 28B have been placed along the pre-existing and new roads, including stop lines 2838 2840, and traffic lights 2834 2836. Based on this new image representation, a new target trajectory 2835 has been generated. In this case, the target trajectory has been generated based on drive information provided by at least one host vehicle traveling along a different, known target trajectory 2830, nearby to the new road, enabling the new road topology features to be captured and stored with the map information. Accuracy of the aggregated indicators, and hence the generated target trajectory, may be increased as additional host vehicle data is obtained over time. Furthermore, trajectories actually navigated by one or more harvesting vehicles may also be used to further improve the accuracy of the target trajectories generated based solely on the aggregated indicators over time.

FIG. 28C illustrates new road topography features associated with a road segment for which a target trajectory based on those features is not available, consistent with the disclosed embodiments. As shown in FIG. 28C, a construction site is present along a road segment, for example, for creating a new intersection or bridge. The road 2864 has centerline 2862, right edge 2866, and left edge 2860. In this situation, host vehicles 2851 2863 2865 may be unable to navigate any previous target trajectory that may follow the normal lanes in the road segment, for example. The vehicles, each having a different perspective, may capture images relating to the road topography features, which include box 2856, excavator 2858, construction sign 2867, warning sign 2852, speed limit sign 2853, and traffic cones 2868. Aggregating these indicators may include matching the like-for-like indicators detected from the host vehicles and creating an image representation of the aggregated indicators for updating a map or map tile.

FIG. 28D illustrates a target trajectory based on indicators of new road topography features associated with a road segment, consistent with the disclosed embodiments. As shown at FIG. 28D, after aggregating the indicators of road topography features shown in FIG. 28C, an image representation may be generated. The indicators may appear similar to those shown in FIG. 28B in that they are represented as points, lines, polygons, and other closed shapes. In this case, a change to the road segment, with centerline 2870, right edge 2873, and left edge 2872, has rendered one or more previous target trajectories invalid or at least unnavigable, during at least some phases of the construction. For the sake of illustration, the indicators have been represented as rectangles for the box 2880, an elliptical shape for the excavator 2882, a diamond for the construction sign 2885, a triangle for the warning sign 2876, a point for the speed limit sign 2886, and circles for traffic cones 2884. In practice, any point, line, polygon, or closed shape may be used to represent any type of indicator, as desired. Furthermore, a polygon may be also represented by a series of points, lines, colors, and the like.

The image representation shown at FIG. 28D may be used to generate a target trajectory 2874 that may be implemented by a vehicle to navigate between the traffic cones 2884 and the right edge 2873. While actual driven paths by host vehicles may also be used, there may be advantages to relying on aggregated indicators in situations such as that represented in FIGS. 28C and 28D. For example, the traffic cones may be moved regularly to adjust for construction needs, or construction vehicles may move, making new target trajectories desirable. By using aggregated indicators, the determination of these new target trajectories may facilitated with greater accuracy, for example, when host vehicles may have outdated information for actual driven paths. Additionally, by using the indicators of road topography features, vehicles from any position or orientation can contribute to the aggregation of data, reducing the number of host vehicles used to produce confident target trajectories.

While generation of target trajectories may be performed based on a plurality of host vehicles providing data for aggregated indicators, in some cases, a single host vehicle 2863 may be able to provide sufficient information for a target trajectory to be generated for a following host vehicle 2851, or even for the host vehicle 2863 itself. This may be done, for example, where host vehicle imaging detects road topography features sufficiently ahead of the host vehicle, and if wireless communication and neural network speeds are sufficient to enable the host vehicle to send information, allow the server to process the information, and send the updated map to the host vehicle (e.g., using a 5G wireless connection).

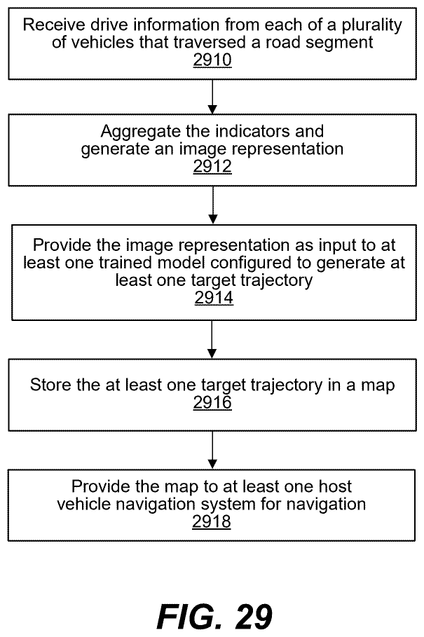

FIG. 29 depicts a block diagram for an exemplary process 2900 for providing target trajectories calculated from aggregated indicators to a host vehicle for navigation. Process 2900 shares a number of steps in common with process 2700 described above, and those steps will not be described in detail here to avoid redundancy.

A host vehicle 100 may traverse a road segment, and onboard cameras 122 124 126 of the host vehicle 100 may detect road topography features. In step 2910, process 2900 includes receiving drive information including one or more representations of road topography features from each of a plurality of vehicles that traversed the road segment. This drive information may be converted to indicators in the form of points, lines, polygons, or other closed shapes, for example, as described above. In step 2912, process 2900 includes aggregating the indicators to generate an image representation of a road segment. In step 2914, process 2900 includes providing the image representation as input to at least one trained model configured to generate at least one target trajectory. After this calculation, in step 2916, process 2900 includes storing at least one target trajectory in a map. In step 2918, process 2900 includes providing the map to at least one host vehicle navigation system for navigation. For example, map information may be transmitted to the at least one host vehicle navigation system during navigation using, for example, mobile communication protocols and/or during a stationary period of the vehicle (during a service visit) using network communications (e.g., WiFi, ethernet, etc.)

A host vehicle may then implement the transmitted map information (including one or more target trajectories) for navigating a road segment.

The steps presented in process 2900, occurring in the sequence presented herein, serve as an illustration for at least one combination consistent with some embodiments. Alternatively, process 2900 could include any combination of the steps, including an exclusion or modification of any step.

### Routeless AV Driving Based on Tagged Drivable Paths

As noted above, a map for use in navigating a host vehicle (e.g., a REM map) may include stored representations of various navigational aids relative to a road segment. For example, the map may include longitudinal polynomials (e.g., splines, function representations, etc.) representative of road edges, lane marks, etc. The map may also include object type indicators (e.g., speed limit sign, stop sign, yield sign, traffic light, light pole, among many others) along with crowdsourced, refined position information for each of a plurality of objects located relative to the road segment. Additionally, the map may store indicators of drivable paths (e.g., target trajectories) for each lane of travel of the road segment. During navigation, a host vehicle can select a drivable path to navigate and follow the drivable path using, for example, the localization techniques described above.

Such drivable paths may be stored in the map for every type of navigable road feature present along road segments to be mapped. Such road features may include, among others, intersections/junctions, roundabouts, straight road sections, curved road sections, lane merge regions, lane split regions, etc.

In some cases, mapped drivable paths (or drivable paths to be stored in the map) intersect. That is, two or more drivable paths meet at an intersection point, and one or more drivable paths extend from the intersection point. Such situations may occur, for example, at lane split regions, lane merge regions, roundabouts, junctions, etc.

In cases where a host vehicle has a specified route planned, the host vehicle may use the specified route to determine which drivable paths to follow. Therefore, in situations where two or more drivable paths intersect, and two or more exit paths are possible, the host vehicle navigation system will select the exit drivable path that is consistent with the planned route.

In other cases, however, it may be more of a challenge for a host vehicle to determine which of two or more exit paths from an intersection of two or more drivable paths the host vehicle should follow. For example, such a situation may occur where the host vehicle is operated in a “routeless” mode where no predetermined route is specified. Such a situation may also occur, for example, where a destination has been selected and none of the two or more exit paths from a drivable path intersection is substantially preferred over one or more other exit paths from the drivable path intersection. In such cases, it may be ambiguous which of two or more exit paths the host vehicle should follow. The disclosed system is aimed at addressing at least this challenge. For example, the disclosed system may include a priority indicator stored in the map to indicate a stand-on priority for each exit path extending from a drivable path intersection. Such priority indicators can be used by a navigating host vehicle to resolve potential path ambiguities and select a particular exit path extending from a drivable path intersection. The disclosed systems also include the use of one or more trained models to automatically generate drivable paths (and exit paths) based on road topography associated with road features such as junctions, roundabouts, lane splits, lane merges, etc. Such automatic generation of drivable paths based on road topography may be preferred over other techniques, such as crowdsourcing, which for some types of road features (e.g., junctions, roundabouts, merges, splits, etc.) can be associated with relatively large actual trajectory distributions, which can skew or bias crowdsourced drivable paths.

In some embodiments, a system is configured to generate a map for use in navigating a host vehicle along a road segment having at least one intersection with a plurality of target and/or exit trajectories. As noted in the sections above, such a map representative of a road segment may be generated using various techniques. In some cases, drive information may be collected from one or more harvesting vehicles that previously traversed the road segment. The drive information may include indicators associated with detected road features and may also include indicators of actual trajectories followed by the harvesting vehicles. These indicators may be aggregated (and aligned) to provide crowdsourced target trajectories for lanes of travel associated with the road segment, crowdsourced object locations, etc., as discussed above. The determined crowdsourced trajectories, object types and locations, etc. may be stored in the map and used by host vehicles that later traverse the road segment.

In other cases, as described above, drivable paths for a road segment may be generated not based on crowd behavior, but rather based on road topography of the road segment. For example, using detected geometry of a road segment (e.g., road edge locations, lane mark locations, etc.) drivable paths for lanes of travel/navigable paths of the road segment (whether or not such lanes of travel are marked by lane marks) may be automatically generated (e.g., using one or more trained models, etc.). Such drivable paths, for example, may be generated by supplying a trained model with a representation of road geometry/topography information associated with a road segment. In some cases, this representation may include a top-view image representation of the road topography features.

Whether drivable paths (e.g., target trajectories) are determined based on crowdsourcing, topography, or another technique, the disclosed system can identify an intersection between two or more drivable paths. Such a determination may be made relative to drivable paths already stored in a map or based on drivable paths newly generated and prior to storing those drivable paths in a map. The drivable path intersection may occur between a plurality of two or more target trajectories, and one or more exit trajectories may be associated with each drivable path intersection. For example, in a typical lane merge situation, two drivable paths will intersect, and one drivable path will extend away from the intersection as an exit trajectory. In a typical lane split situation, one drivable path will extend to an intersection point between two or more available exit drivable paths extending from the intersection point exit trajectories. For situations where more than one exit trajectory extends away from a drivable path intersection, the disclosed system may automatically determine a “stand-on” trajectory. A stand-on trajectory refers to a preferred exit trajectory from among a plurality of available exit trajectories that extend away from a drivable path intersection. In some cases, a single stand-on trajectory may be determined, and an indicator identifying the stand-on trajectory may be stored in the map. For those cases, where a host vehicle navigating relative to the map encounters a drivable path intersection with multiple available exit drivable paths extending from the drivable path intersection, the host vehicle navigation system may rely upon the stored stand-on trajectory indicator to determine which exit drivable path to follow.

In other cases, rather than determining a single stand-on trajectory among a plurality of drivable trajectories, the disclosed system may automatically determine priority indicators for any or all of the available exit trajectories and store the priority indicators in the map. Such priority indicators may enable a navigation system of a host vehicle to determine an appropriate exit trajectory to follow based on relative priorities between the available exit trajectories. For example, in a situation where three exit trajectories extend away from a drivable path intersection, up to three priority indicators (e.g., high, med, low; 0, 0.5, 1.0; etc.) may be generated and assigned to the available exit trajectories. In such a case, a host vehicle navigation system may determine that exit trajectory A with the highest priority is the default stand-on trajectory, but may also determine that exit trajectory B, with a higher priority than exit trajectory C, is the stand-on trajectory relative to exit trajectory C. Thus, in situations where exit A may be unsuitable for reaching a particular goal destination, but exit trajectory B and C are roughly equally suitable for reaching the goal destination, the host vehicle navigation system may rely upon the priority indicators stored in the map for exit trajectories B and C to select exit trajectory B as the stand-on trajectory. These identifiers (e.g., a stand-on indicator, priority indicator(s), etc.) may be stored in a map, e.g., with map information, to be provided to host vehicles for use in navigation relative to a mapped road segment.

In some embodiments, a system may receive a map that may include map information including, for example, an identifier as described above to facilitate determination of a navigational action for a host vehicle to follow the stand-on trajectory. In such a case, the system may cause the host vehicle to perform the determined navigational action, e.g., travel relative to the stand-on trajectory (e.g., using the localization and steering actuation techniques described above). For example, when navigating autonomous vehicles, it may be desirable to direct the host vehicle to follow the stand-on trajectory at a drivable path intersection, rather than having the vehicle navigation system randomly choose a path or requiring a user to provide input in order to select among available exit drivable paths and continue navigation. Navigating a vehicle in this manner may allow the vehicle to navigate through drivable path intersections, while, for example, not having a predetermined or clearly specified route to a desired destination.

In some embodiments, at least one processor with circuitry and memory may be used to generate a map for use in navigating a host vehicle relative to a road segment, in a manner consistent with that described above. The at least one processor may include, for example, any of the EyeQ™ series of processors or any aftermarket processor available, such as Intel or AMD processors, and the at least one processor may operate with a memory with instructions that are configured to allow for navigation of a host vehicle using map information.

As described in the sections above, drivable paths for storage in the map may be generated using a variety of different techniques. For example, the drivable paths may be generated by crowdsourcing actual trajectories (e.g., aggregating, aligning, and curve fitting or averaging, etc.) followed by a plurality of harvesting vehicles that previously traversed a road segment. The drivable paths may also be automatically generated by a trained model, for example, using topographic features detected (and aggregated, aligned to arrive at a refined real world position) by harvesting vehicles that previously traversed the road segment. And as described above, both types of trajectories (crowdsourced and topography-based) may be stored in the map for each available lane of travel along a road segment. Or, a hybrid trajectory may be stored in the map for one or more lanes of travel along the road segment, where the hybrid trajectory is generated as a combination of a crowdsourced and a topography-based trajectory. In still other cases, the drivable paths represented in the map may be designating using only crowdsourced or only topography-based trajectories. It is also possible to form the mapped drivable paths using crowdsourced trajectories for some regions of the drivable path (e.g., through straight or curved road segments) and using topography-based trajectories for other regions of a drivable path (e.g., through junctions, roundabouts, lane merge regions, lane split regions, etc.). As noted above, because of the complexity of certain types of road segment features and the large path distributions that may be associated with crowdsourcing for those road features, in some cases and for some road features, it may be preferred to generate mapped drivable paths solely using topography-based trajectories rather than crowdsourced trajectories (or at least weight topography-based trajectories more heavily than crowdsourced trajectories when generating a hybrid trajectories for storage in the map as drivable paths). Any of junctions, lane merges, lane splits, roundabouts etc. (e.g., places where drivable path intersections likely occur) may be mapped by relying more heavily on topography-based trajectories rather than crowdsourced trajectories.

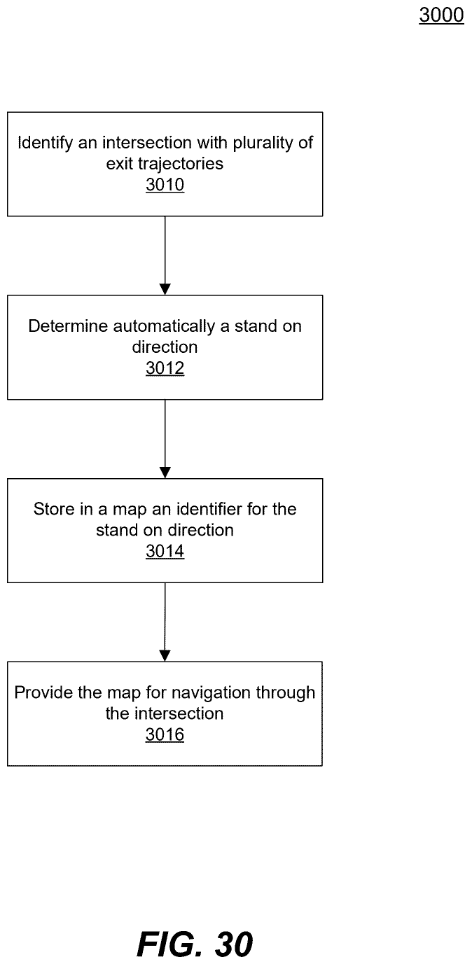

FIG. 30 is a flowchart of an exemplary process 3000 for a system configured to generate a map for navigating a host vehicle. Step 3010 of process 3000 includes identifying a drivable path intersection that includes a plurality of exit drivable path trajectories (whether the trajectories are already stored in a map or whether they are to be stored in a map). Step 3012 of process 3000 includes automatically determining a stand-on trajectory among the available exit trajectories. Step 3014 of process 3000 includes storing in a map an identifier for the identified stand-on trajectory. An identifier may take a variety of forms, including, for example, a simple label, semantic label, positional information of a target trajectory, number, code, etc. Step 3016 of process 3000 includes providing the map to one or more host vehicles for navigation relative to a feature of a road segment where the drivable path intersection occurs. The description of the steps in process 3000 are intended only for explanatory purposes. The steps of process 3000 may occur independently or in any combination or order, and greater detail thereof follows.

In step 3010 of FIG. 30, a mapping server or other type of map generation system is configured to identify an intersection in two or more drivable paths, either already stored in a map or generated to be stored in a map. In some embodiments, an intersection may be identified between at least a first target trajectory and a second target trajectory associated with the road segment. In some cases, only a single exit trajectory extends from a drivable path intersection between the first and second target trajectories. In other cases, however, at least a first exit trajectory and a second exit trajectory extend from the intersection along respective directions of travel.

A drivable path intersection as used herein may describe any intersection between two or more drivable paths stored or to be stored in a map. The intersection may occur where two or more drivable paths cross (e.g., at a typical junction where one road crosses another road) or may occur anywhere two or more drivable paths share a common point (e.g., at a lane split, lane merge, etc.). Drivable path intersections may be associated with various types of road features, such as roundabouts, road junctions, lane merges, lane splits, etc.

A target trajectory may include any drivable path stored in a map relative to a lane of travel of a road segment. As noted above, two or more drivable paths, or target trajectories, may intersect at a point. In such cases, the two or more target trajectories may be referred to as extending toward/into the drivable path intersection. An exit trajectory may include any drivable path that extends away from an intersection of two or more drivable paths. In some cases, an intersection of two drivable paths will include a first target trajectory and a second target trajectory that extend into a drivable path intersection. In some cases, such as a lane merge, only a single target trajectory will extend away from the drivable path intersection as an exit trajectory. In other cases, such as a lane split, at least one target trajectory will extend into a drivable path intersection. In this example, two or more target trajectories will extend away from the drivable path intersection as exit trajectories. In this particular example, the drivable path intersection is formed at a common point between the target trajectory extending toward the drivable path intersection and the two or more exit target trajectories extending away from the drivable path intersection.

In some embodiments, each of a first exit trajectory and a second exit trajectory may be associated with lanes of travel along the road segment, for example, along different directions of a road junction, beginning at different exit points of a roundabout, etc. identified intersection. Similarly, the target trajectories extending toward a drivable path intersection may correspond with different lanes of travel associated with a road segment. For example, in a lane merge situation, there will be at least two target trajectories extending toward a drivable path intersection, where one target trajectory corresponds with a first lane of travel/navigable path of the road segment (e.g., a lane of a highway) and another target trajectory corresponds with a second lane of travel/navigable path of the road segment (e.g., a lane of an entrance ramp to the highway).

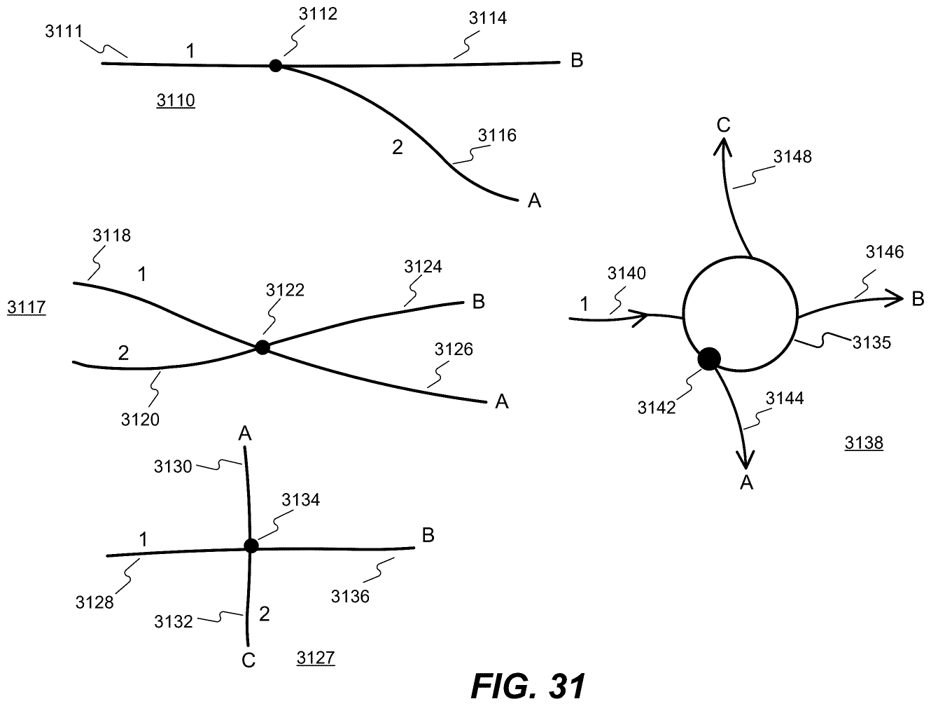

FIG. 31 provides a set of diagrams depicting illustrative drivable path intersection types that may occur in a map of a road segment. In FIG. 31, each drivable path intersection is represented by a black circle, but this icon serves merely for explanatory purposes, and is not intended as limiting in any way.

Each intersection type may include a first target trajectory 1 and a second target trajectory 2. Additionally, each intersection type may include possible exit trajectories A, B, C, etc. For example, the first target trajectory 1 may include a drivable path a host vehicle may follow to enter various types of road features (e.g., an exit lane situation 3110, a road crossing situation 3117 or 3127, or a roundabout situation 3138). In some cases, an exit trajectory extending from a drivable path intersection may be referred to as corresponding to one of the target trajectories that extend toward the drivable path intersection. For example, in the exit lane example of 3110, one of the exit trajectories 3114 may represent a drivable path corresponding to the same lane of a highway to which the target trajectory 3111 corresponds. Such a situation may also be described as having one or more target trajectories (e.g., trajectory 3111) that overlaps with one or more exit trajectories (e.g., exit trajectory 3114). In a similar manner, a second target trajectory extending toward a drivable path intersection may coincide with or overlap with one of a first exit trajectory or a second exit trajectory extending away from the drivable path intersection.

Returning to FIG. 31, exit lane scenario 3110 includes a first target trajectory 3111 via which a host vehicle may follow toward a drivable path intersection 3112, at which a lane split occurs. In this example, two exit trajectories 3114 and 3116 are available to the host vehicle for navigation. In this case, as noted, the target trajectory 3111 may be described as overlapping with exit trajectory 3114. This example may also be described as having a target trajectory 3111 that extends to a drivable path intersection 3112 and ends at that drivable path intersection. At drivable path intersection 3112, two exit trajectories 3114 and 3116 begin and extend away from the drivable path intersection.

Continuing with FIG. 31, a crossing intersection 3127 may include a first target trajectory 3128 entering into the drivable path intersection 3134, which may correspond to a real-world location at or near a traffic light, stop sign, stop line, etc. From the drivable path intersection in scenario 3127, a host vehicle may be directed to follow any of the available exit trajectories 3130 (left turn), 3132 (right turn), or 3136 (proceeding straight).

In another example, the drivable path intersection is associated with a crossing junction as represented by scenario 3117. In this example a host vehicle may be navigated relative to a target trajectory 3118 or another target trajectory 3120 toward a drivable path intersection 3122. At a junction corresponding to drivable path intersection 3122, the host vehicle may be navigated relative to either exit trajectory 3124 or exit trajectory 3126.

Other types of crossing junctions may include any number of entering and exiting drivable paths or target trajectories. For example, traveling from a first target trajectory to an exit trajectory may require a left turn, a right turn, or continuing straight. There may be one or more left turn lanes, one or more right turn lanes, one or more straight lanes, or any combination and number thereof. Each may be associated with a corresponding drivable path/target trajectory stored in the map.

Returning to FIG. 31, a roundabout road structure may be represented by a series of drivable paths as shown in scenario 3138. For example, the roundabout scenario 3138 may include a first target trajectory 3140 corresponding to a lane of travel along which a host vehicle may enter the roundabout and continue in a direction consistent with traffic flow of the roundabout. The host vehicle may continue through the roundabout until reaching a location in the roundabout that corresponds to an intersection 3142 in available drivable paths. From drivable intersection 3142, the host vehicle may continue along a trajectory 3135 maintaining the host vehicle on the roundabout 3138. Alternatively, the host vehicle may follow a second target trajectory 3144 (e.g., an exit trajectory) along an exit A from the roundabout. If the host vehicle continues on the roundabout past intersection 3142 along trajectory 3135, then further intersections may be reached where the host vehicle may optionally exit the roundabout by following, for example, exit trajectory 3146 along exit B or exit trajectory 3148 along exit C of the roundabout. Additionally, the host vehicle may further continue around the roundabout and exit the roundabout at exit 1. In this case, the host vehicle may follow an exit trajectory (not shown) representative of a drivable path corresponding to a lane of travel that in some cases is substantially parallel to a lane of travel corresponding to trajectory 3140.

One example of drivable paths corresponding to a roundabout road structure is shown in FIG. 31, but this is not intended to be limiting, and roundabouts according to the present disclosure may have any shape, size, number of exits, etc. As used herein, a roundabout, also known as a rotary, a traffic circle, etc., may correspond to any combination or intersection of roads, connected for example, by a loop of road, allowing at least one entering drivable path and at least one exit drivable paths from the loop. A roundabout may allow traffic to flow only in one direction along the loop around a non-drivable or otherwise restricted portion within the loop.

Consistent with some embodiments, the intersection between a first target trajectory and a second target trajectory may be associated with a roundabout, and the first exit trajectory and the second exit trajectory may include at least one exit trajectory (e.g., three exit trajectories as shown in FIG. 31) extending from the intersection. For example, roundabout scenario 3138 in FIG. 31 shows first target trajectory 3140 and there are at least three exit trajectories, 3144, 3146, and 3148 extending from intersection 3142. Scenario 3138 may also be described as including four drivable path intersections (including intersection 3142). As shown in FIG. 31, each intersection includes a target trajectory that extends towards the intersection and two exit trajectories extending away from the drivable path intersection (e.g., trajectory 3144 and trajectory 3145 extending away from intersection 3142).

Returning to FIG. 30, a stand-on direction at a drivable path intersection may be automatically determined (step 3012). In some embodiments, a stand-on trajectory may be automatically determined between a first exit trajectory and a second exit trajectory, extending from the drivable path intersection between the first target trajectory and the second target trajectory. A stand-on trajectory may be described as a second target trajectory or an exit trajectory for a host vehicle to follow when navigating away from a real world point corresponding to the drivable path intersection. For example, as noted above, a stand-on trajectory may correspond to a trajectory whereby the navigating host vehicle has right of way throughout the trajectory. A stand-on trajectory may also correspond to a preferred drivable path among a plurality of available paths that extend away from a drivable path intersection. In some cases, such a preferred drivable path may correspond to an exit trajectory that allows a host vehicle to maintain course along a current lane of travel, rather than exiting from a highway, exiting from a roundabout, turning left or right at a junction, turning onto a minor crossing road from a larger road, etc. In other cases, such a preferred drivable path may correspond to an exit trajectory that allows the host vehicle to navigate relative to one lane in a lane split versus another lane of a lane split, that allows the host vehicle to exit a roundabout onto a main road extending from a roundabout rather than causing the host vehicle to continue around the roundabout, etc. Various other scenarios may be associated with one exit trajectory from a drivable path intersection being automatically identified (e.g., using a trained model, based on user input, etc.) as a stand-on trajectory (or otherwise having priority) over another available exit trajectory.

Any of a plurality of available exit trajectories extending from a drivable path intersection may serve as a stand-on trajectory, and a stand-on trajectory may be selected based on any suitable criteria. For example, a stand-on trajectory may be chosen at random or may be selected by a user. According to further embodiments, the stand-on trajectory may be determined based on, for example, a weighted average of characteristics of the exit trajectories (e.g., fastest, shortest, etc.) and/or data from a database or server (e.g., map information). Furthermore, for any particular intersection there may be a plurality of stand-on trajectories that may be weighted based on different situations, vehicles, or users. For example, a first stand-on trajectory may be more heavily weighted for situations where the roundabout is saturated (e.g., due to traffic density) while another stand-on trajectory may be more heavily weighted for situations where the roundabout is free flowing (e.g., at night with little to no traffic). The system may thus select one stand-on trajectory that enables successful navigation through the intersection.

Consistent with some embodiments, a stand-on trajectory may be determined from among a first exit trajectory and a second exit trajectory based on, for example, aggregation of drive information collected from a plurality of vehicles having previously traversed the road segment, and more particularly, a road feature associated with the drivable path intersection under consideration. As discussed above, crowdsourced behavior may be used to generate, for example, an aggregation of drive information for a road segment or portion thereof, e.g., an intersection. Such an aggregation may facilitate a selection of the stand-on trajectory. For example, a plurality of actual driven paths may be aggregated on one particular exit trajectory for an intersection. Where the number of actual driven paths meets or exceeds a threshold value (e.g., greater than 10, 20, 50, 100 vehicles, etc.), that exit trajectory may be chosen as the stand-on trajectory for the intersection for a host vehicle entering the intersection from a corresponding target trajectory. In other words, an exit trajectory selected as the stand-on trajectory may correspond to a determination of a percentage of vehicles (from among a plurality of vehicles that previously traversed a road segment) that followed each of the available exit trajectories extending from a drivable path intersection. The exit trajectory associated with the highest percentage of actual drives may be identified as the stand-on trajectory.

Consistent with some embodiments, the stand-on trajectory may be determined from among a first exit trajectory and a second exit trajectory based on, for example, one or more geometric characteristics associated with the road segment. In such embodiments, the geometric characteristics may be consistent with those described above, and may include, for example, road shape, road width, curves in the road, splits of the road, road merges, and diverging lanes relative to an original straight path, among others.

The geometric characteristics may be determined by a trained model, such as a neural network, as described in other sections of the present disclosure. For example, a trained model may be configured to receive as input a representation of road structure/features associated with a road segment. In some cases, the representation may include a top-view image representation of features (e.g., road edges, lane markings, road signs, traffic lights, etc. and their relative locations). In some cases, input to the trained model may also include indicators of numbers/percentages of vehicles that traveled one available lane of travel versus other available lanes of travel. As output, the trained model may generate an indicator of which exit trajectory extending from a drivable path intersection is the stand-on trajectory, indicators of relative priority between available exit trajectories, etc. In some cases, the trained model may be configured to generate target trajectories corresponding to a road segment based on geometry/road topography (as discussed elsewhere in the present disclosure) in addition to outputting an indicator of a stand-on exit trajectory and/or relative priority indicators between available trajectories stored or to be stored in a map.

Consistent with some embodiments, the stand-on trajectory may be determined from among a first exit trajectory and a second exit trajectory based on, for example, the one or more geometric characteristics associated with any of the trajectories either extending toward a drivable path intersection and/or associated with any of the exit trajectories extending a war from the drivable path intersection. The geometric characteristics of the target and exit trajectories relative to a drivable path intersection may facilitate determination of which exit trajectory is designated the stand-on trajectory for navigation through the intersection. For example, in a continuous driving mode without a destination (i.e., “routeless mode”), a host vehicle on a first target trajectory may enter a roundabout with one exit trajectory having a most geometrically similar configuration to the first target trajectory (e.g., where the exit trajectory represents a “straight” path through the roundabout junction based on geometry). In such a case, the exit trajectory may be selected as the stand-on trajectory for the host vehicle. In another example, at a crossing junction, a host vehicle may be traveling along a highway having a higher traffic density than crossing road segments. In such a case, the stand-on trajectory may be chosen to be straight through a crossing junction (e.g., an exit trajectory that allows a host vehicle to maintain a path along a lane of travel of the highway). Any geometric characteristics may be used as a basis for determining a stand-on trajectory, and a stand-on trajectory may be changed based on further input from the system, e.g., aggregated data from one or more host vehicles and/or input received from one or more users, etc.

Consistent with some embodiments, determination of the stand-on trajectory from among a first exit trajectory and a second exit trajectory may be determined based on aggregation of drive information collected from a plurality of host vehicles that previously traversed the road segment and a corresponding drivable path intersection for which a stand-on trajectory indicator is being determined. The aggregation of such data may be performed, for example, as described above. The actual driven paths of host vehicles may indicate a preferred trajectory for navigating through a road junction (or other road feature) represented by a drivable path intersection. For example, a plurality of host vehicles may travel along one particular exit trajectory, and this may, therefore, be determined as a preferred option for designation as a stand-on trajectory.

In some cases, aggregation of drive information may include a combination of mapped objects/features in an intersection and actual driven paths influenced by the mapped objects/features. For example, a stand-on trajectory may be selected based not just on the actual driven paths, but also based on detected mapped objects/features (e.g., signs, road markings, lamp posts, etc.) and the potential influence of those objects on path selected. For example, when traveling along a route and encountering a road junction, one or more mapped objects/features in proximity to the road junction may include a sign indicating a direction of a current route relative to the junction. In such cases, a trajectory representative of the lane of travel along which a current route continues may be selected as the stand-on (or highest priority) trajectory. In such cases, the confidence of the decision may be improved based on crowdsourced information demonstrating a large majority of vehicles having travelled the specific exit trajectory, for example.

Consistent with some embodiments, the stand-on trajectory may be determined based on an output of at least one trained model. The trained model may be consistent with those described herein. The trained model may employ any suitable method for modeling intersections and facilitating predictions based on input data related to determination of stand-on trajectories for an intersection. For example, machine learning, a neural network, and/or deep learning may be used to determine the stand-on trajectory based on a variety of input drive information, such as, for example, a mapped or image representation of drivable paths, mapped objects/features relative to an intersection, and/or any of the additional considerations discussed above with regard to determination of a stand-on trajectory. The trained model may be configured to output a selected exit trajectory as the stand-on trajectory based on the inputs.

An identifier may be assigned to each stand-on trajectory for an intersection and stored along with map information (step 3014). In some embodiments, an identifier associated with the determined stand-on trajectory may refer to any label, semantic or non-semantic, that may be used to reference to a stand-on trajectory. For example, an identifier may include, for example, a unique identifier (e.g., a universally unique identifier “UUID”), location information, descriptive information, etc. The identifier may be stored in a database (e.g., on a server) for later use by navigating vehicles and/or determinations of other relevant information. For example, a stand-on trajectory may be labeled and assigned to the intersection to which it applies, in a map or map tile for a road segment, and stored in a map database.

According to some embodiments, the identifier may be a label without additional information, which may reduce the space required for storage or transmission. Consistent with some embodiments, the identifier may include a stand-on tag associated with the stand-on trajectory. A stand-on tag may be, for example information that associates an exit trajectory with a stand-on trajectory in the map, for example.

The identifier and/or tag may also include a variety of information including one or more characterizations and bases leading to selection of the stand-on trajectory, for example.

According to some embodiments, the map may be updated with new identifiers, modified identifiers, and/or to remove identifiers, as desired. For example, the map and map information may be updated to include identifiers associated with newly determined stand-on trajectories (e.g., based on newly developed map segments, newly mapped road segments, re-mapping of previously mapped segments, periodic map reviews, etc.), while, for example, certain preexisting stand-on indicators/exit trajectory priority indicators may be deleted if no longer accurate (e.g., based on crowdsourced drive information, based on detected changes in road geometry, etc.).

Additionally, stand-on or priority identifiers may be associated with a host vehicle, the system, user preferences, and/or different driving situations. For example, additional driving modes may be added for which identification of separate stand-on or priority identifiers may be desirable. One driving mode may have a first stand-on trajectory, while another driving mode may have a second stand-on trajectory different from the first. Weather conditions may also present another stand-on trajectory and an identifier may be used for each type of weather condition, for example. Varying traffic based on the time of day, school zones, rush hour, and the like, may also lead to creation of additional stand-on trajectories associated with each traffic situation.

Consistent with some embodiments, each of a first target trajectory and a second target trajectory associated with a drivable path intersection may be stored in the map as three-dimensional splines, for example, along with an associated stand-on or priority identifier. Furthermore, in some embodiments, each of a first exit trajectory and a second exit trajectory associated with a drivable path intersection may be stored in the map as three-dimensional splines.

Stand-on trajectories may be adaptable and/or modifiable based on, for example, newly received information. For example, in some cases, navigation may occur through a road junction with a non-functioning or mal-functioning traffic light or where one or more traffic signs are missing. For example, a police officer may be used to aid in navigation through a crossing junction with a non-functioning or mal-functioning traffic light. In another example, one or more lanes of travel associated with corresponding exit trajectories may be temporarily closed, such as for construction. Additional examples may include traffic accidents, special events, sporting events, or anything else that may affect the decision to follow a particular route. In such cases, stand-on trajectories along a route may be determined, for example, one-by-one or as a set of intersections for a given area or distance.

According to some embodiments, a stand-on trajectory may be determined based on user input. For example, the system may receive information from a user indicating a preference to drive particular road types (e.g., curvy roads, hilly roads, straight roads, etc.) In another example, the system may receive input from a user about the amount of time the user wishes to drive. In such an example, traffic information such as from a GPS system, and/or aggregated drive information, may be used to determine a stand-on trajectory for each intersection to account for the desired driving time (e.g., to shorten time to destination.)

According to some embodiments, a default stand-on trajectory may be determined for each intersection, with backup or secondary stand-on trajectories based on additional information also being stored with the map information in the map.

A map including the identifiers and/or stand-on trajectory information, among others, may be provided for navigation through an intersection (step 3016). In some embodiments, the map may be provided to at least one host vehicle navigation system for use in navigating the host vehicle along the road segment and relative to the intersection between the at least a first target trajectory and the second target trajectory. This navigation may be based on, for example, one or more stand-on trajectories determined and identified as above as well as other factors described with regard to the present embodiments (e.g., user preferences.)

The map may be stored on a server (e.g., in a database) to be made available to any host vehicle requesting the map and/or map tiles of the map. When driving in a “routeless mode,” such as driving without a predetermined route to a particular destination or such as driving without a designated destination, the map may store one or more stand-on trajectory indicators relative to one or more road segments, for a host vehicle to use in navigating relative to the one or more road segments.

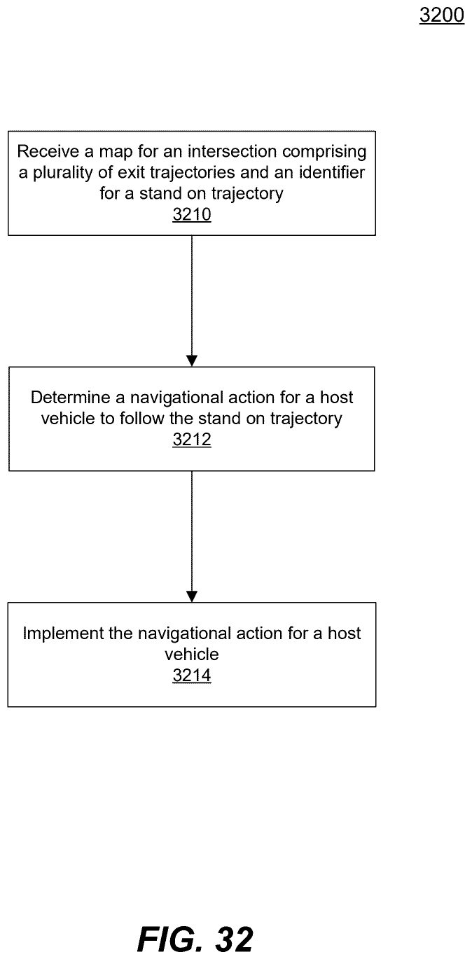

FIG. 32 shows a block diagram for a process 3200 of navigating a host vehicle relative to a road segment associated with mapped drivable paths that comprise one or more intersections. In step 3210, a map is received including a drivable path intersection with a plurality of exit trajectories and an identifier associated with a stand-on trajectory, as described above. In step 3212, a navigational action for a host vehicle to follow the stand-on trajectory is determined. In step 3214, the navigational action is implemented. These steps are for explanatory purposes and may occur independently or in any combination. Furthermore, the steps may be consistent with any of the embodiments described above.

In step 3210 of FIG. 32, a map may be received by a host vehicle for navigation along a road segment. For example, the map may be received by any suitable wireless communication method and/or may be provided during wired connection of the vehicle to a network (e.g., during a service stop.)

In some embodiments, the map associated with the road segment may be may include a drivable path intersection between at least a first target trajectory and a second target trajectory associated with corresponding lanes of travel along the road segment, wherein at least a first exit trajectory and a second exit trajectory extend from the drivable path intersection along respective directions of travel, and wherein an identifier stored in the map designates one of the at least a first exit trajectory and the second exit trajectory as a stand-on trajectory. This may be done in a manner as described above.

A navigational action may be determined for the host vehicle based on the stored identifier and the corresponding stand-on trajectory (step 3212). The navigational action may be configured to cause the host vehicle to follow the stand-on trajectory while navigating the drivable path intersection between the at least a first target trajectory and the second target trajectory. A navigational action may include, for example, any maneuver performed by a host vehicle to traverse a road segment, as described above, such as, for example, braking modifications, steering modifications, straight line navigation, etc.

The navigational action may be implemented by causing at least one actuator associated with host vehicle to activate (step 3214). An actuator may refer to any aspect of the host vehicle that enables a maneuver, as described above, such as for example, steering system actuators, braking system actuators, etc. By actuating the steering system and or the braking system, the host vehicle may be directed to follow the stand-on trajectory automatically. For example, this navigational action may be desirable for operating an autonomous vehicle to navigate one or more intersections of a road segment.

Drivable Paths Augmented with Crowd Drive Profile

The present disclosure relates generally to vehicle navigation and, more specifically, to methods and techniques for navigating an autonomous vehicle (AV), where the host vehicle may be navigated along a target trajectory based on analysis of road topography alone, actual crowdsourced trajectory derived from real driving paths, or along a trajectory that constitutes a combination of both target and crowdsourced trajectories with possibility of dynamic adjustment of individual contributions of each of the constituent trajectories.

Prior navigation systems for autonomous vehicles relied solely on generating mapped drivable paths derived from actual drive paths uploaded by a plurality of vehicles traversing a road segment. Whilst this technique provides highly accurate target trajectories, less frequented segments presented significant challenges for generation of accurate and reliable mapped drivable paths. In addition, further complications in employing purely crowdsourced target drivable trajectories arise from factors such as driver bias effects, multiple lane changes, forbidden maneuvers by statistically significant numbers of drivers etc. Proposed solution to such non-trivial problem involves development of a system capable of generating drivable target trajectories based on topological features of a segment, such as line markings, road edges, traffic signs, traffic lights etc. Such system offers a marked improvement in delivery of safe and legal drivable target trajectories to cover the shortcomings of generating mapped drivable trajectories purely from actual crowdsource trajectories taken by different vehicles.

Moreover, the availability of two potential streams for generation of drivable target trajectories creates a unique opportunity to deliver a more robust and complementary solution. In more remote and less well travelled locations, target trajectories generated based on road topography may offer a safer solution, whilst following the more commonly chosen actual driving trajectories may result in smoother progress when encountering poorly designed junctions, slip roads and other such road features. The dynamically adjustable contributions from individual components of the combined trajectories allow high level of adaptability that may account for variable road and environmental conditions, as well as user preference. Combination of crowdsource drive trajectories with target trajectories generated based on road topography for navigation of host vehicle offers an overall safer and more comfortable driving experience.

Embodiments of the current disclosure involve a navigation system. As used herein, navigation system may refer to any suitable systems for generating a map for use in navigating a host vehicle relative to a road segment and any suitable systems for using a generated map for navigating a host vehicle. In some embodiments, navigation system may include at least one processor comprising circuitry and a memory, wherein the memory includes instructions that when executed by the circuitry cause the at least one processor to perform at least one specific predefined action for implementing embodiments of the present disclosure.

In some embodiments, the at least one processor may include application processor and image processor, however any other suitable processing device may be also included. Both image processor and applications processor may include various types of processing devices. Either one of applications and image processors or both may include processing devices such as, but not limited to, microprocessor, preprocessors (such as an image preprocessor), a graphics processing unit (GPU), a central processing unit (CPU), support circuits, digital signal processors, integrated circuits, memory, or any other types of devices suitable for running applications and for image processing and analysis. In some embodiments at least on of the processors included in the navigation system may include any of the EyeQ series of processor chips available from Mobileye®, such as EyeQ2®, EyeQ3®, EyeQ4®, EyeQ5® and/or other present/future EyeQ processing devices. Each of these processors may include units with local memory and instruction sets, as well as video inputs for receiving image data from multiple image sensors.

In some embodiments the tasks of image processor and applications processor may be accomplished by a single processing device, while other embodiments may include two or more processing devices to fulfill the functions of image and applications processors. The collection of processing devices working together to perform the functions of image processor and applications processor may be referred to as the processing unit.

The memory may comprise any number of various memory units such as random access memories, read only memories, flash memories, disk drives, optical storage, tape storage, removable storage and other types of storage. The memory may or may not be separated from the processing unit. The memory may store software that, when executed by the processor, controls the operation of various aspects of the host vehicle. The instructions contained within the memory units may relate to at least one of information transfer between the host vehicle and the server and/or other vehicles, information aggregation, processing and storage, drivable trajectory generation, drivable trajectory distribution and other tasks necessary for navigation of the host vehicle.

The delivery of such instructions as well as information (e.g., map information) to the memory may take place via a wireless transceiver installed in the host vehicle, for example. Such a wireless transceiver may include devices configured to exchange transmission over an air interface to one or more networks via various electromagnetic mode of wireless communication, such as radio frequency, infrared frequency, magnetic fields, electric fields etc. In addition, wireless transceiver may use any known standard to transmit and/or receive data, such as e.g. Wi-Fi, Bluetooth®, Bluetooth Smart, 802.15.4, ZigBee, etc. Host vehicle may thus communicate via wireless means with one of the remotely located servers to receive sufficient drive information for generation of drivable target trajectories.

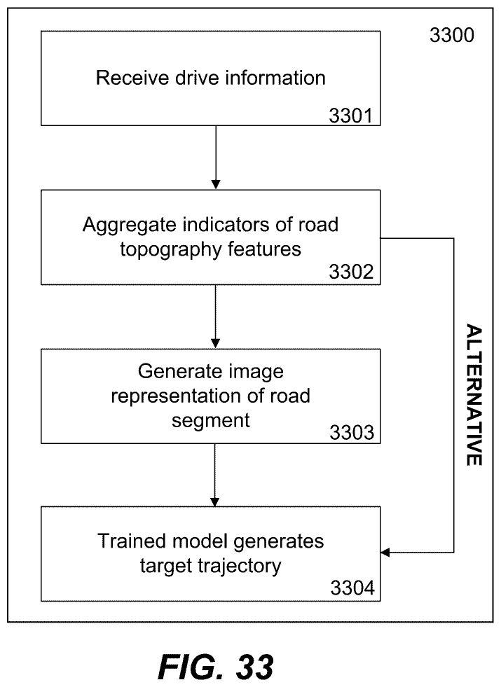

FIG. 33 shows a schematic diagram illustrating a process 3300 associated with the disclosed embodiments. Wireless communication between vehicles and one or more of the remotely located servers may enable transmission of information between vehicles and server(s). In a harvesting mode, drive information is collected from vehicles that traverse a road segment. This drive information may be aggregated by a mapping server and used to generate maps based on the collected and aggregated drive information. Such a map may be generated based on drive information received from a single vehicle. In many cases, however, the map may be generated based on drive information received from a plurality of vehicles that traversed a road segment.

The drive information may include indicators representative of road topography features associated with the road segment, among other things (step 3301). In the present disclosure, the indicators representative of road topography features may include information associated with, for example, a feature type and a position associated with each of the road topography features. Road topography features may include, for example, lane markings, road edges, traffic signs, traffic lights, lamp posts, buildings, road barriers, speed bumps, etc. The indicators of road topography features detected by harvesting vehicles may be communicated to a mapping server in any suitable format. In some cases, these indicators may identify a certain type of feature detected, for example, by transferring to the mapping server data packets that identify one or more detected topography features using predetermined representative codes (e.g., from a list of enumerated feature types). And, as noted, the drive information may also include location information associated with detected road topography features. In this way, the mapping server can interpret what types of road topography features were detected by each harvesting vehicle and the associated positions (e.g., detected real world positions) of those features.

The indicators representative of road topography features may be collected, for example, by a plurality of harvesting vehicles that travel along roadways, each vehicle being equipped with an image capture system comprising, for example, at least one camera. Each harvesting vehicle that traverses a road segment can be equipped with one or more cameras to capture images representative of their respective environments as they navigate the road segment. The images may be collected at any suitable frame capture rate (e.g., 9 Hz, etc.). The images collected by harvesting vehicles may be analyzed (e.g., using image analysis techniques, trained models, etc.) to identify road topography features. Based on captured images, position information for the detected road topography features can be determined. In some cases, this can be accomplished using structure in motion techniques applied to a series of captured images. In other cases, position information may be determined using one or more trained models configured to infer 3D location information relative to road features (or points associated with those road features, especially in the case of road edges, lane markings, etc.) represented in a captured image. Such models can mimic the type of range information provided by LIDAR systems and may be configured to provide point clouds with range (distance) information for each pixel in a captured image. Such an approach may also include fusing the 3D image depth information with actual LIDAR information, as available. In some cases, the position information may also include 2D image locations associated with certain road topography features represented in a captured image. The map server can use the 2D coordinates, a location of the camera when the image frame was captured, etc. to determine 3D locations of objects or portions of objects represented in captured image frames.

In some cases, image analysis processor(s) aboard each harvesting vehicle may analyze the captured images to detect the presence of semantic and/or non-semantic features/objects. In the present disclosure, semantic features/objects may include, for example, objects associated with a predetermined type classification (e.g. speed limit signs, yield signs, merge signs, stop signs, traffic lights, directional arrows on a roadway, manhole covers, or any other type of object that may be described as part of a class of objects with one or more known characteristics (e.g., dimensions, etc.). Information relating to non-semantic features/objects may also be acquired. Such features/objects may include any detectable objects or features that fall outside of a recognized category or type, but that still may provide valuable information in map generation (e.g. corner of a building or a corner of a detected window of a building, a unique stone or object near a roadway, a unique road sign, a concrete splatter in a roadway shoulder, a pothole, or any other detectable object or feature).

As noted, the harvesting vehicles may transmit indications of detections of the semantic and/or non-semantic objects/features along with positions associated with those objects/features based on the images captured enroute to a server (e.g., a mapping server). Indicators of road topography features may be transmitted together with position information, where the position is identified, for example, as a two-dimensional position relative to an image frame, determined 3D points, etc. The position information may include any suitable information for enabling the server to aggregate the detected objects/features with map information (e.g., a sparse map) based on the position information. In some cases, the position information may include one or more two-dimensional (2D) image positions (e.g., X-Y pixel locations) in a captured image where the semantic or non-semantic features/objects were detected. Such image positions may correspond to a center of the feature/object, a corner, etc. In this scenario, to aid the server in reconstructing the drive information and aligning the drive information from multiple harvesting vehicles, each harvesting vehicle may also provide the server with a location (e.g., a GPS location) where each image was captured, based on for example, a determined position of the harvesting vehicle at each point in time of image capture.

Although the position of topography features may be identified as two-dimensional relative to the image frame, the position information may be determined as a three-dimensional, real-world position. Thus, in some cases, the harvesting vehicle may provide to the server one or more real world, three-dimensional (3D) points associated with the detected objects/features. Such 3D points may be relative to a predetermined origin (such as an origin of a drive segment) and may be determined through any suitable technique, for example. In some cases, a structure in motion technique may be used to determine the 3D real world position of a detected object/feature. For example, a certain object such as a particular speed limit sign may be detected in two or more captured images. Using information such as the known ego motion (speed, trajectory, GPS position, etc.) of the harvesting vehicle between the captured images, along with observed changes of the speed limit sign in the captured images (change in X-Y pixel location, change in size, etc.), the real-world position of one or more points associated with the speed limit sign may be determined and provided to the mapping server. Such an approach is optional, and is not intended to be limiting. For example, as noted above, 3D position information may be obtained using one or more trained models configured to infer 3D depth information, for example, for pixels of a captured image (e.g., either corresponding to one or more features of interest or for an entire captured image).

As described, for example, in sections above, the drive information collected from one or more harvesting vehicles can be used to generate a map representative of the road segment traversed by the one or more harvesting vehicles. Where drive information is available from a single vehicle, a mapping server may store in the map indicators of object types detected by the harvesting vehicle along with position information for the features/objects. The position information may include 3D real world point(s) associated with the detected features/objects. In some cases, where a certain object class (e.g., a particular type of speed limit sign, etc.) has known dimensions, it may be sufficient to store in the map a single point associated with the object (e.g., a point associated with a center or a corner of the object), and from that point and the known characteristics (and potentially an indicator of a facing direction (e.g., a line normal to a sign face), a host vehicle navigation system could determine other 3D real world points associated with the object. Where drive information is available from a plurality of harvesting vehicles, a mapping server can aggregate the information and generate the map using crowdsourcing techniques. For example, position information received from a plurality of vehicles relating to a particular object or feature can be aggregated to provide a refined position (e.g., a mean, average, etc.) position within a distribution associated with the crowdsourced positions for a particular object/feature.

In some cases, the drive information received from one or more harvesting vehicles may be used to automatically generate drivable paths, which represent intended trajectories for vehicles to follow as they traverse a road segment. Each lane of travel (whether delineated by lane markings or not, whether extending through a junction or along a straight road section, etc.) may be associated with a corresponding drivable path. In some cases, discussed in more detail below, these drivable paths may be generated by crowdsourcing and aggregating (and aligning) the actual trajectories traveled by one or more harvesting vehicles that previously traversed a road segment. In other cases, such drivable paths can be automatically generated by a trained model based on observed road topography features (e.g., road geometry, road edge paths, lane marking paths, lane width, radii of curvature, roundabout geometry, junction geometry, traffic flow directions, etc.).

Returning to FIG. 33, the processor may be configured to aggregate the indicators representative of road topography features (step 3302). Such aggregated indicators may include object type indicators (road signs, light poles, traffic lights, etc.) and position information for each. The aggregated indicators may also include path representations (e.g., splines or other functions) for longitudinal features such as road edges, lane markings, etc. This information, which can be stored in the map (e.g., a REM map) may be used as a basis for automatically determining drivable paths. For example, a processor may be configured to generate a representation (e.g., an image representation, point cloud, or any other suitable representation of road topography features stored in the map or to be stored in the map) of road topography associated with the road segment based on the aggregated indicators (step 3303). In some embodiments, the generated representation of road topography of the road segment may include a two-dimensional top view image representation of the road segment and road topography associated with the road segment.

As noted above, to improve accuracy and reliability of the image representation of the road topography, the aggregation of the indicators may include determining refined positions associated with each of the road topography features. The information relating to road topography features provided by a harvesting vehicle may be based on, for example, Global Positioning System (GPS) data or other localization information. For example, in addition to the techniques described above, a vehicle passing an identified landmark corresponding to one or more road topography features may determine a location of the identified landmark using GPS position information associated with the vehicle and a determination of a location of the identified landmark relative to the vehicle (e.g., based on image analysis of data collected from one or more cameras on board the vehicle). Such location determinations of an identified landmark (or any other road topography feature) may be repeated as additional vehicles pass the location of the identified landmark. Some or all of the additional location determinations may be used to refine the location information relative to the identified landmark. As a non-limiting example, multiple position measurements relative to a particular feature may be averaged together. Any other mathematical operations, however, may also be used to refine stored location information of a map element based on a plurality of determined locations for the map element.

The processing unit may be configured to process the top view image representation of the road topography features and to provide the image representation of road topography of the road segment as input to at least one trained model. The trained model may be configured to automatically generate, in response to the provided input, an output including at least one target trajectory for the road segment (step 3304) or a portion of the road segment, among other things. According to some embodiments, the trained model may include one or more trained neural networks, for example, a recurrent neural network. The training of the neural network may be achieved, for example, by employing known training schemes aimed at minimization of an error function (e.g., determined based on an observed difference between a generated target trajectory and a predetermined desired output target trajectory for a particular representation of road topography). Such minimization of the error function may include methods based on gradient and/or curvature optimization.

One or more of the indicators of road topography features may be aggregated into a 2D top view map. The 2D top view map or image representation may contain representations of features such as lane markings, traffic lights, road edges etc. and may serve as an input to the trained model. The model may attempt to generate a geometric representation of the road topography features by applying appropriate fitting algorithms to the data and/or making certain types of inferences based on the represented features associated with a particular road segment. Based on represented road topography, the trained model generates an output that includes at least one target trajectory. A target trajectory represents a desired or recommended drivable path that can be stored in a map and used by a host vehicle as a navigation guide for a particular road segment or portion of a road segment. For example, a target trajectory may be automatically generated by the trained model for each lane of a road segment (whether or not such a lane is marked or delineated by lane markings), for one or more paths through a junction or turning left or right at a junction, for one or more paths around a roundabout, for paths associated with lane merges, for paths associated with lane splits, etc. Target trajectories generated by the trained model may be expressed in form of three-dimensional polynomials, or splines, which may be stored in the map. In general, generation of representations of the local environment of the host vehicle may allow for significant reduction in necessary data usage relating to storage and distribution. The system may store in the map the generated at least one target trajectory, the storage location comprising, for example, the on-board memory available to the processing unit (e.g., in a database).

Alternatively, in some embodiments the process of target trajectory generation based on aggregated road topography features may be performed while omitting the step of generating image representation of a road segment. Instead, aggregated indicators representative of road topography features may be passed as input directly to at least one trained model (e.g., as a list of data elements, a point cloud representation, etc.). The at least one trained model may generate, in response to the provided input, an output including at least one target trajectory for the road segment which may be stored in the map.

In addition to the use of a trained model to directly output target trajectories (drivable paths) for a road segment based on topography, geometry, etc. associated with the road segment, drivable paths for a road segment can also be generated based on crowdsourcing actual drive/trajectory information, as described in the sections above. For example, generation of crowdsourced trajectories may include obtaining “crowdsourced” data, e.g., data received from various vehicles (which may or may not be autonomous vehicles) that previously traveled a road segment. In such cases, the processor may be instructed to aggregate actual vehicle trajectory information, which is included in the drive information transmitted to a map server by each of a plurality of harvesting vehicles that previously traversed the road segment. The actual trajectories may be based on or designated by, for example, GPS data points marking the individual 3D paths followed by the plurality of harvesting vehicles as they traversed the road segment.

Vehicles travelling on a road segment may also collect other data using various sensors, such as, for example, cameras, accelerometers, steering angle sensors, braking force sensors, etc. The vehicles may transmit data relating to a trajectory (e.g., a curve in an arbitrary reference frame), landmarks data, and lane assignment along a traveling path to one of the remotely located servers. In some cases, the actual trajectory information collected from a harvesting vehicle may be captured as points or distance values relative to a detected feature, such as a road edge or one or more lane marks. Various vehicles travelling along the same road segment at multiple drives may have different trajectories based on, for example, driver habits and preferences, weather conditions, time of day, etc. It may therefore be desirable that the aggregation of the indicators includes alignment of the drive information received from the plurality of vehicles. The server may identify routes or trajectories associated with each lane from the trajectories received from vehicles through, for example, a clustering process, which may involve trajectory classification for extraction of drive trajectories for a common road segment. The clustering process may allow for alignment of drive information received from the plurality of vehicles that traversed a given road segment. Such alignment can help ensure that any averaging of the actual trajectories is less susceptible to spatial biases that may result from averaging non-normalized trajectory data that does not share at least one common reference.

In each cluster, trajectories may be averaged to obtain a trajectory associated with the specific cluster. For example, the trajectories from multiple drives associated with the same lane cluster may be averaged. The averaged trajectory may be a target trajectory associate with a specific lane. To average a cluster of trajectories, a server may select a reference frame of an arbitrary trajectory C0. For all other trajectories (C1, . . . , Cn), the server may find a rigid transformation that maps Ci to C0, where i=1, 2, . . . , n, where n is a positive integer number, corresponding to the total number of trajectories included in the cluster. The server may compute a mean curve or trajectory in the C0 reference frame, and the resultant average crowdsource drive trajectory may be stored in map as a three-dimensional polynomial for use in navigation of host vehicles. As opposed to the target trajectories generated by the trained model based on road topography/geometric features associated with the road segment, the trajectories generated using these techniques are based on crowdsourced actual drive information collected from a plurality of harvesting vehicles. Therefore, these trajectories may be referred to as crowdsourced trajectories. Like the trained model target trajectories, a crowdsourced trajectory may be generated for each navigable path (e.g., lane, etc.) associated with a road segment, including paths through junctions, roundabouts, lane splits, lane merges, etc.

The process of clustering may facilitate extraction of an average crowdsourced drive trajectory, allowing the processor to generate at least one crowdsourced trajectory for the road segment based on the aggregated actual trajectory information, and store the at least one crowdsourced trajectory in the map. The map may, therefore, contain averaged trajectories derived from the plurality of vehicles that traversed a road segment. Creation of crowdsourced trajectories for a segment by means of clustering or any suitable technique may reduce the amount of data stored or transmitted and increase system's efficiency of operation.

Based on the operation of the trained model(s), which outputs one or more target trajectories determined based on road topography, and the process for aggregating crowdsourced actual trajectory information, which results in one or more crowdsourced trajectories, a mapping server may store in the map various combinations of the one or more target trajectories and the one or more crowdsourced trajectories. The map and mapped trajectories can then be delivered to one or more host vehicles and used to navigate the host vehicles relative to the road segment.

Because crowdsourced trajectories and topography-based target trajectories can be independently generated, both a crowdsourced trajectory and a topography-based target trajectory may be generated for each lane of travel or each navigable path relative to a road segment. In some cases, both a crowdsourced trajectory and a topography-based target trajectory may be stored in a map for a common length of a single lane of travel associated with the road segment. In such cases, a host vehicle would have the option of navigating relative to the crowdsourced trajectory, relative to the topography-based target trajectory, or based on a blended combination of both.

In some cases, a map server may generate a hybrid trajectory based on a combination of the crowdsourced trajectory and the topography-based target trajectory generated for a particular lane of travel along the road segment. It should be noted that a lane of travel refers to any navigable path associated with a road segment, including paths extending through junctions, roundabouts, lane splits, lane merges, unmarked sections of a road surface, inter-junction sections of road between junctions, etc. The combination may include a blended combination such that the hybrid trajectory does not fully match either the crowdsourced trajectory or the topography-based target trajectory for a lane of travel, but rather constitutes a separate path generated based on blending of the crowdsourced and topography-based trajectories.

This blending to form a hybrid trajectory can be accomplished using any suitable techniques. In some cases, the hybrid trajectory may be generated as a weighted combination of both the crowdsourced trajectory and the topography-based target trajectory. The weightings applied to the crowdsourced trajectory and the topography-based target trajectory in generating the hybrid trajectory can vary between 0% and 100% and can include any mix of values therebetween. The predetermined selected weights can be applied uniformly across an entire road segment or even across the entire map. In other cases, the selected weights may be varied over the road segment or within different regions of the map. The selected weights can also be varied based on features present along a road segment. For example, a straight road portion of a road segment may be associated with weighting values different from a junction, a roundabout, a lane split region, a lane merge region, etc. along a road segment.

In some cases, crowdsourced trajectories and/or topography-based target trajectories may be generated not for full lengths of lanes of travel of a road segment, but only for portions of a lane of travel of a road segment. Those portions may fully overlap (as in the examples above), they may partially overlap, or there may be no overlap between the portions. For example, in one embodiment crowdsourced trajectories may be generated for portions of a road segment corresponding to straight or relatively straight sections of road, but not for one or more of curved road sections, junctions, roundabouts, lane splits, lane merges, etc. Topography-based target trajectories may be generated for those road features for which crowdsourced trajectories are not generated. In some cases, however, both crowdsourced trajectories and topography-based target trajectories may be generated for a subset of road feature types, while for other road feature types only crowdsourced trajectories or topography-based target trajectories may be generated.

For road features and lanes of travel (or portions of lanes of travel) relative to those road features where both crowdsourced trajectories and topography-based target trajectories, hybrid trajectories may be generated by combining the crowdsourced trajectories and topography-based target trajectories, as described above. Where portions of a road segment for which only crowdsourced trajectories are generated either partially overlap or do not overlap with portions of a road segment for which only topography-based target trajectories are generated, hybrid trajectories may be generated by stitching together crowdsourced trajectories and topography-based target trajectories to form one or more corresponding hybrid trajectories.

In one example, a hybrid trajectory may be generated by stitching together or otherwise combining a portion of a topography-based target trajectory that extends through or corresponds with a junction with a portion of a crowdsourced trajectory that extends through or corresponds with a non-junction region of the road segment (e.g., an inter-junction section of road, a curve in a road, a straight portion of a road, etc.). In another example, a hybrid trajectory may be generated by stitching together or otherwise combining a portion of a crowdsourced trajectory that extends through or corresponds with a junction with a portion of a topography-based target trajectory that extends through or corresponds with a non-junction region of the road segment. In another example, a hybrid trajectory may be generated by blending together at least one portion of the target trajectory and at least one portion of the crowdsourced trajectory, the at least one portion of the target trajectory and the at least one portion of the crowdsourced trajectory both corresponding to a common sub-segment of the road segment.

As noted, for road features where both crowdsourced trajectories and topography-based target trajectories are available, generation of a hybrid trajectory may be accomplished by applying weights to full portions or sub-portions of crowdsourced and topography-based trajectories to blend the trajectories together. In one example, the blending includes applying a first predetermined weight relative to at least one portion of the topography-based target trajectory and applying a second predetermined weight relative to at least one portion of the crowdsourced trajectory. In some examples, the first predetermined weight and the second predetermined weight may be selected based on a structural feature associated with the road segment. For example, the structural feature on which a predetermined set of weighting values depends may include a junction, a roundabout, a curved road section, a straight road section, a lane merge zone, or a lane split zone, etc. In one particular example, the structural feature corresponds to a junction, and the first predetermined weight applied to the topography-based target trajectory is greater than the second predetermined weight applied to the crowdsourced trajectory. In another example, the structural feature corresponds to a junction, and the first predetermined weight applied to the topography-based target trajectory is less than the second predetermined weight applied to the crowdsourced trajectory. In another example, the structural feature corresponds to a lane split, and the first predetermined weight applied to the topography-based target trajectory is less than the second predetermined weight applied to the crowdsourced trajectory.

In operation, a host vehicle navigating a road segment or preparing to navigate a particular road segment may receive from a map server (e.g., in response to a request) a map representative of the road segment. As noted above, in some cases, the map may include both crowdsourced trajectories and topography-based target trajectories corresponding to a common lane of travel/navigable path, etc. In such cases, the processor may provide the map to at least one host vehicle navigation system for use in navigating the host vehicle relative to one or more of the topographic-based target trajectory or the crowdsourced trajectory available for a common path or region of the road segment. For example, the processor may receive a request for map information related to a particular road segment, and in response, provide the map to the requesting vehicle. The map, consisting of multiple road segments, may contain target trajectories generated from road topography features and crowdsourced trajectories associated with each of the road segments making up the map. According to such embodiments, the map may include a plurality of target trajectories and a plurality of crowdsourced trajectories, such that each mapped lane of travel or navigational path of a road segment may be associated with a corresponding topography-based target trajectory and a crowdsourced trajectory.

According to embodiments of the present disclosure, the road segment may include a plurality of lanes of travel (along a straight section of road, along a curved section of road, through a junction, through a lane merge region, through a lane split region, etc.), and each lane of travel of the road segment may be associated with one of the plurality of topography-based target trajectories and a corresponding one of the plurality of crowdsourced trajectories. Each of the navigable paths above may correspond to a different lane of traffic with respect to a general road segment that may also include roundabouts, junctions and any other road designs and geometries.

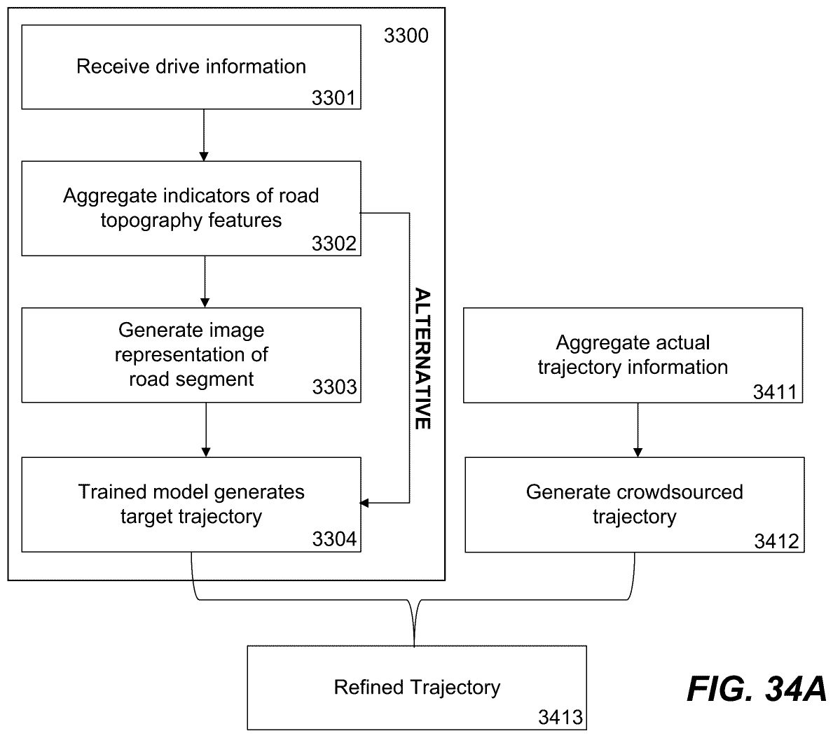

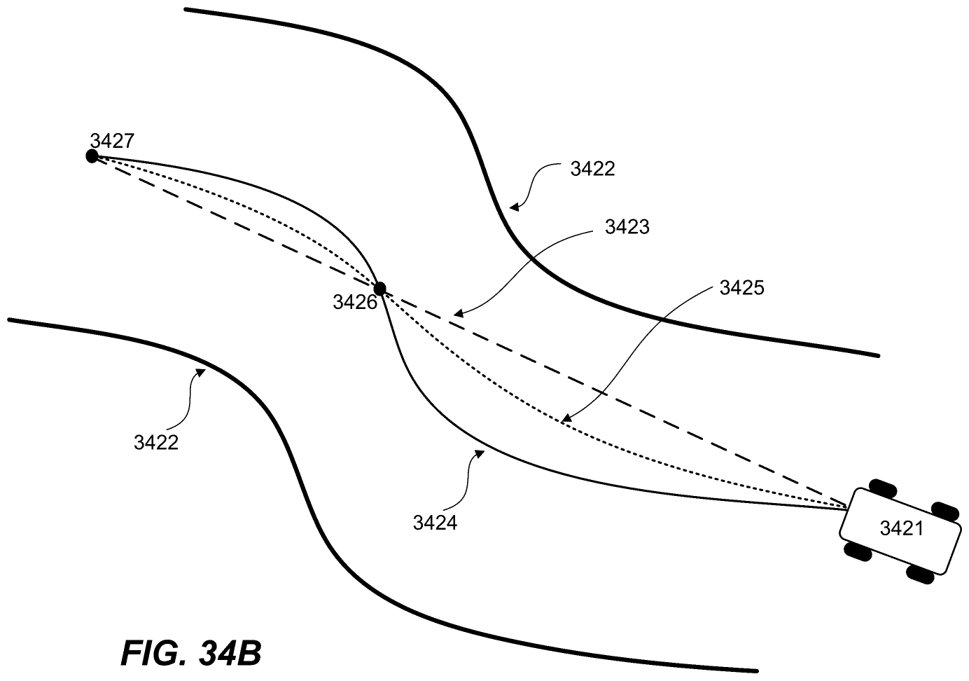

FIG. 34A shows a flowchart summarizing an illustrative target trajectory refinement process, according to some embodiments. As described above, the system may generate target trajectories based on road topography features, which may comprise multiple steps, as outlined in FIG. 33. The drive information from a plurality of vehicles that traversed a road segment is received (step 3301), followed by the process of aggregation of road topography features (step 3302) to determine accurate location information for each detected feature. This information may be used to generate the image representation of the road segment (step 3303) that may subsequently be passed on to at least one trained model capable of generating topography-based target trajectories (step 3304). Alternatively, in some embodiments indicators of road topography features may be aggregated (step 3302) in a format directly suitable for generation of target trajectories by at least one trained model (step 3304), thereby skipping the intermediate step 3303.

Moreover, alongside topography-based target trajectory generation, the system may also be configured to collect actual drive trajectory information from plurality of vehicles traversing or having traversed a road segment (3411) and use this information to generate crowdsourced trajectories (3412). Such crowdsourced trajectories generated at step 3412 may be used, for example to generate a refined trajectory (e.g., the hybrid trajectory described above) in step 3413.

FIG. 34B shows an example of a refined/hybrid target trajectory as described above and relative to FIG. 34A. The example represented by FIG. 34B corresponds to a scenario where a vehicle 3421 approaches a one-way road segment defined by road edges 3422. Based on the road topography features detected and identified in drive information transmitted to a map server by a plurality of vehicles traversing or having traversed this road segment, a topography-based target trajectory 3424 may be generated according to the processes described above and with regard to FIG. 33. This trajectory may follow edges of the road closely, for example, maintaining roughly an equivalent distance of the vehicle 3421 from each road edge 3422. Additionally, a crowdsourced trajectory 3423 based on aggregation of actual trajectories of the plurality of vehicles that previously traversed the road segment may also be generated. Notably, the crowdsourced trajectory 3423 shows significant deviations from the topography-based target trajectory 3423, indicating driver preference to maintain a more convenient straight driving path through this curved section of road. The map supplied to the host vehicle, in some cases, may store both the topography-based target trajectory 3424 and the crowdsourced trajectory 3423 corresponding to the one-way road segment of FIG. 34B. In other cases, however, the map may store a refined/hybrid trajectory generated by combining the topography-based target trajectory 3424 and the crowdsourced trajectory 3423. For example, as shown in FIG. 34B, a hybrid trajectory 3425 may be stored in the map. This hybrid trajectory represents a blending of the topography-based target trajectory 3424 and the crowdsourced trajectory 3423 (e.g., based on a predetermined set of applied weights). And, in this example, vehicle 3421 would navigate the road segment by following the hybrid trajectory 3425 stored in the map.

Hybrid trajectory 3425 is similar to both the topography-based target trajectory 3424 and the crowdsourced trajectory 3423 at and near point 3426 and 3427. As these trajectories deviate from one another between these two points, however, the hybrid trajectory follows a path between the topography-based target trajectory 3424 and the crowdsourced trajectory 3423. As noted above, a host vehicle may navigate relative to a hybrid trajectory through various types of road features, including a junction, roundabout, lane merge region, lane split region, curved road section, etc.

According to some embodiments a navigation system for navigating a host vehicle relative to a road segment is disclosed. The navigation system here described may comprise at least one processor comprising circuitry and a memory, wherein the memory includes instructions that when executed by the circuitry cause the at least one processor to perform a at least one specific predefined action. As noted above, a host vehicle may be navigated autonomously or semi-autonomously based on a map transmitted to the host vehicle from a map server. In some cases, the map may be stored locally at the host vehicle.

The map delivered to the host vehicle may include a hybrid trajectory for each of one or more lanes of travel of a road segment. In such cases, the host vehicle may navigate relative to the road segment by, for example, actuating a steering system of the host vehicle to follow the hybrid trajectory. Using captured images and comparing image locations of objects represented in the captured images to expected image locations of the same objects stored in the map (e.g., based on the mapped position of those objects), the host vehicle navigation system can localize itself relative to the stored trajectory. If the host vehicle location has drifted from the stored trajectory or if there is a curve in the stored trajectory to follow, the host vehicle can actuate one or more vehicle systems, such as a steering system, to change a heading direction of the host vehicle. Such a process continues in a feedback loop, where the host vehicle's steering is updated with each localization event and/or any dead reckoning navigation occurring between localization events based on speed sensor and/or accelerometer outputs, etc. to follow a stored trajectory.

Where a particular lane of travel along a road segment includes only a single corresponding trajectory (e.g., a hybrid trajectory, a topography-based target trajectory, or a crowdsourced trajectory) stored in the map, the host vehicle navigation system will navigate relative to the available, single trajectory. In other cases, however, as described above, more than one trajectory may be stored in the map for one or more lanes of travel along a road segment. For example, a navigation map may include both a stored topography-based target trajectory and a crowdsourced trajectory corresponding to a common lane of travel or single navigational path along the road segment. In the example of FIG. 34B, both the topography-based target trajectory 3424 and the crowdsourced trajectory 3423 may be stored in a map representative of the one-way, single lane road segment illustrated. In other words, for a given lane of traffic (whether or not marked by lane markings), there may be stored in the map one generated topography-based target trajectory and one crowdsourced trajectory that may differ from one another. In such cases, a host vehicle navigation system may have options in how to rely upon the two (or potentially more) available trajectories for a lane or path on which the host vehicle is navigating or plans to navigate.

In some cases, a host vehicle navigation system may navigate exclusively with respect to one of the two or more available trajectories for a lane of travel of a road segment. For example, a navigation system of host vehicle 3421, shown in FIG. 34B, could opt to navigate solely with respect to topography-based target trajectory 3424 or solely with respect to crowdsourced trajectory 3423. In other cases, however, the host vehicle navigation system may navigate relative a combination of an available topography-based target trajectory and an available crowdsourced trajectory.

Such a combination may be accomplished using any suitable technique. In some examples, a combination of available trajectories may be generated using a set of weights applied to the trajectories. For example, a first weight may be applied to a topography-based target trajectory and a second weight may be applied to the crowdsourced trajectory to arrive at a combined trajectory. The weights applied may vary, for example, between 0 to 1 (or any other suitable range or percentage). In some cases, however, both the first weight and the second weight applied to respective trajectories to arrive at the combination are non-zero (meaning both trajectories contributed to the resultant combination trajectory). The combination of a trajectory generated based on the road topography features with a crowdsourced trajectory may be performed in a manner such that the contribution of each trajectory to the resultant trajectory may be unequal. In other words, the contributions of each trajectory may be based on the assigned weight, which may express the numerical contribution of a given trajectory to the final drivable trajectory.

According to some embodiments, the values of weighting factors may vary from zero to unity (or from 0 to 100%), excluding the lower and upper limit. In any case the sum total of the weighting factors typically will not exceed 1 or 100%. The weighting factors may be applied in a uniform matter that is invariant over time, such that when the target and crowdsourced trajectories are close to convergent, the resultant driving path also corresponds to such convergence. In cases where the two types of trajectories show distinct divergence, the resultant trajectory may combine the contributions from each in a manner corresponding to designated weighting factors. For examples, if a topography-based target trajectory derived from road topography feature and crowdsourced trajectories are assigned weighting factors of 0.2 and 0.8 respectively, the resultant drive trajectory may lie in between the two, yet significantly closer to the crowdsourced trajectory.

In addition, the system may allow variation in the weighting such that the magnitude of at least one of the first weight or the second weight is made to vary over time. The system described in the present disclosure may offer dynamic characteristics, where the weight associated with at least one of the target trajectory generated based on road topography features and/or the crowdsource trajectory may vary over time. The variation in individual weights may be a response to a variety of factors, which may also change over the course of the journey, for example weather or road conditions. For example, during periods of adverse weather (e.g., rain, snow, ice, etc.) the target trajectory based on road topography features may be more heavily weighted than the crowdsourced trajectory. Similarly, during periods of normal weather (e.g., dry roads), the target trajectory based on the crowdsourced trajectory may be more heavily weighted.

Furthermore, according to some embodiments the magnitude of at least one of the first weight or the second weight is made to vary relative to a distance along the road segment. The navigation system may respond to the changes in the environment and surroundings over the distance travelled by the host vehicle. Such adaptive response may involve altering magnitude of the weights associated with at least one of the individual constituents of the combined drive trajectory.

The weights may also vary based on road feature. For example, a road segment may include various types of features, such as straight sections, curved sections, junctions, roundabouts, lane splits, lane merges, among others. In some cases, a host vehicle navigation system may apply different sets of weights to different types of road features. For example, in a junction or a roundabout, the host vehicle navigation system may weight an available topography-based target trajectory more heavily than an available crowdsourced trajectory (or vice versa). In other words, in some cases, a magnitude of a first weight and/or a second weight may be predetermined based on road feature type. In some examples, a first road feature type (e.g., a junction, roundabout, road sub-segment leading to or extending away from a lane merge, etc.) may be associated with a first weight applied to a topography-based target trajectory that is higher than a second weight applied to a crowdsourced trajectory. In such cases, a second road feature type (e.g., an inter-junction road section leading to or extending away from a junction, a lane merge, etc.) may be associated with a first weight applied to the topography-based target trajectory that is less than a second weight applied to a crowdsourced trajectory.

A host vehicle navigation system may choose any combination of weights to be applied to available trajectories stored in a map. The weights chosen may depend on dynamic conditions (e.g., weather, road surface conditions, etc.), road features (e.g., junctions, merges, etc.), or any other characteristic associated with a road segment. Such an approach allows a host vehicle navigation system to rely upon crowdsourced trajectories more heavily in certain situations (curves, off ramps, straight segments, etc.), as compared to topography-based target trajectories. In other cases, a host vehicle system may rely upon topography-based target trajectories more heavily in certain situations (junctions, roundabouts, etc.), as compared to crowdsourced trajectories. Of course, depending on the circumstances and/or navigation goals, a host vehicle navigation system may take an opposite weighting approach relative to any of the examples described above.

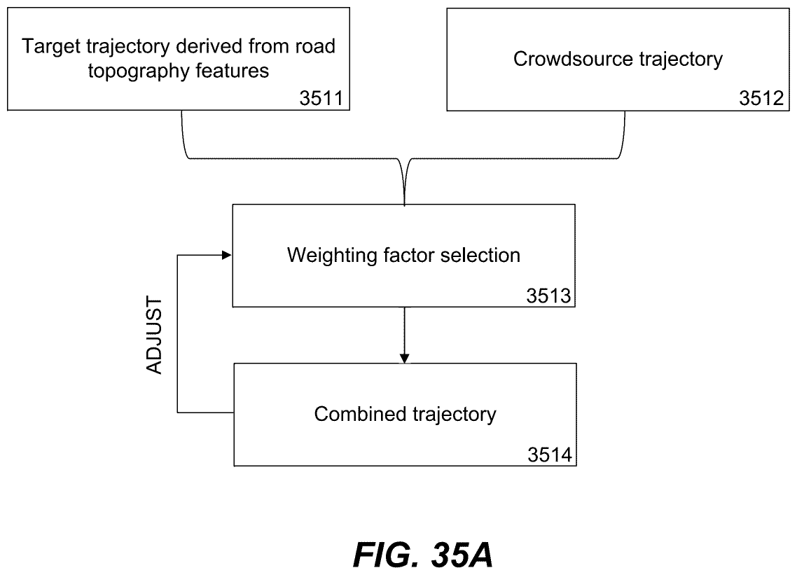

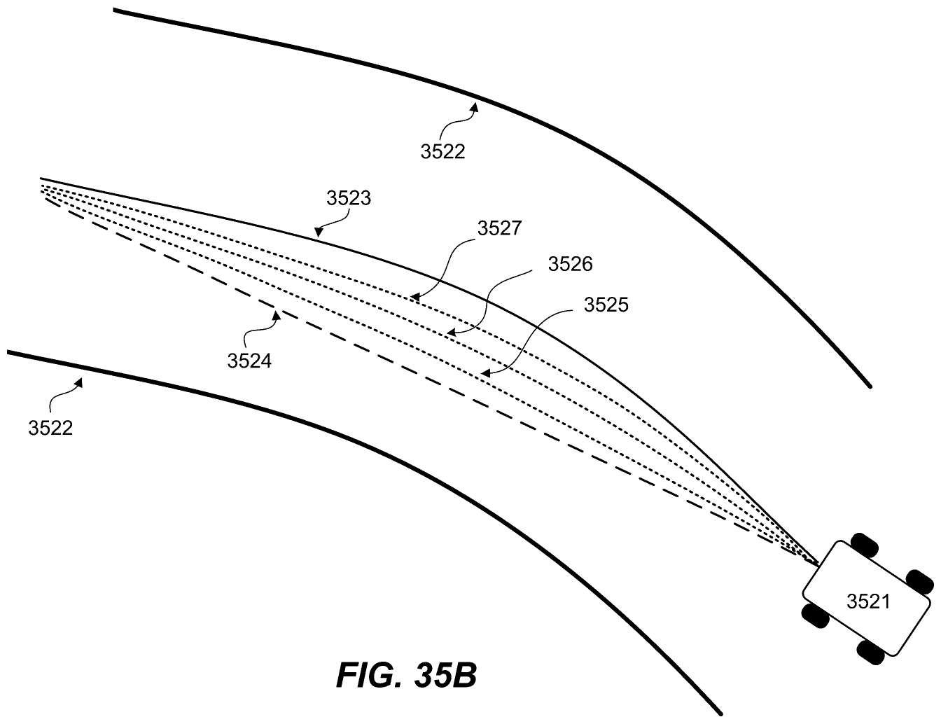

FIG. 35A shows a diagram of steps for creating a combined drive trajectory as described above. An available target trajectory generated based on road topography features 3511 and a crowdsource trajectory 3512 corresponding to a road segment may be combined by applying a weighting factor 3513 to each trajectory. The resultant combined trajectory 3514 may remain constant over time and/or distance travelled, or the weighting factor(s) 3513 may be adjusted and changed over the course of time and/or distance travelled, as described above.

FIG. 35B shows effects of illustrative weighting factors on the combined drive trajectory of a vehicle 3521 for a road segment. In this example, one of the contributions to determination of a target trajectory may be derived from, for example, road edges 3522, such that target trajectory 3523 is located halfway in between the road edges. Crowdsource data collected from plurality of vehicles that traversed the road, may however indicate driver preference for a straighter path, as indicated by the crowdsourced trajectory 3524. The combined target trajectories may be derived by applying a weight of 0.25, 0.5, and 0.75 to crowdsource trajectories (with equivalent contributions of 0.75, 0.5, and 0.25 for respective target trajectories), as depicted by the resultant combined drive trajectories 3525, 3526, and 3527 respectively.

In another example, a road segment may include a manhole cover, resulting in a discrepancy between the target and crowdsourced trajectories. The crowdsourced data may indicate drivers' preference to avoid such a road feature, while the calculated target trajectory may involve driving over that feature. In case of weighting factor heavily favoring the target trajectory, the system or the user may decide to adjust the weighting factors in the most suitable manner such that the actual drive trajectory is closer to the crowdsource trajectory, avoiding the manhole cover, thereby improving passenger comfort. Similarly, in bad weather conditions the weighting factors may be adjusted appropriately in a way to avoid obstacles such as large puddles that may accumulate in mapped road surface depressions, which may pose a risk of aquaplaning.

The road topography and topology may also influence the weighting system for determination of a desired target trajectory of the host vehicle. For example, the system may adjust the weighting system such that a magnitude of at least one of the first weight or the second weight is varied in response to an upcoming curved portion of the road segment. In other words, road layout may contribute to the variation in weight of at least one of the target trajectories generated from road topography features and/or crowdsourced trajectory used for generation of the combined trajectory. Depending on the features such as road topology, layout, design etc. the system may adaptively adjust the weighting to best traverse a given road segment.

In addition to the above dynamic features, the system may be further configured such that the magnitude of at least one of the first weight or the second weight is determined based on user input. The user of the host vehicle may have a preference regarding the route choice, style of driving or any other aspect associated with the journey. Therefore, the system may provide an interface allowing the user to input user preferences and subsequently incorporate user input preferences that may dictate priorities for the navigation system to implement. According to some embodiments, the system may respond by appropriately adjusting the combined drivable trajectory to best accommodate user input. One step in such adjustment may involve adapting the weight associated with a topography-based target trajectory generated from road topography features and/or a crowdsourced trajectory combined into the final drivable trajectory. As above, the magnitude of at least one weight may vary over time, over distance or adapt in any other way to generate an appropriate response to features such as road topography, local topology, weather conditions etc. Alternatively, or in addition, the system may be configured to disregard or modify user preferences where safety considerations are apparent to the system, but where the user has failed to consider such safety issues.

User input may result in variation of weighting factors over time or in response to a road segment. As described above the user may indicate preferences which align with crowdsourced trajectories. In such case, the user input may be interpreted to assign higher weight to crowdsource trajectories when combining them with target trajectories derived based on road topography features. Consequently, for road segments including junctions, roundabouts etc., the deviation between the two types of trajectories may be combined in a way, such that the final drive trajectory resembles the crowdsourced trajectory more closely.

In such examples, two (or more) available trajectories stored in a map relative to a particular lane of travel/navigable path may be blended according to user selectable weights such that the user can control the navigational response of the host vehicle. For example, based on user input, the host vehicle may drive fully according to an available topography-based target trajectory, fully based on an available crowdsourced trajectory, or according to any user-desired combination of the two. Such user input may be apply universally to an entire map, or a user may input desired weights for each of a plurality of road feature types, weather conditions, etc.

To follow an available trajectory in a map, a hybrid trajectory from a map, or a combination trajectory determined by weighting and combining two or more available trajectories, a processing unit of a host vehicle may be configured to determine a navigational action for the host vehicle intended to cause the host vehicle to follow the determined trajectory. In some cases, as described herein, the navigational action may be based on a combination of the at least one target trajectory and the at least one crowdsourced trajectory—that is, a planned navigational action for the host vehicle may be designed to allow the host vehicle to follow a combined trajectory derived from at least an available crowdsourced trajectory and an available topography-based target trajectory. Examples of navigational actions may include actions that affect steering, braking or acceleration of the host vehicle.

In addition, the processor may implement the navigational action by causing at least one actuator associated with host vehicle to activate. For example, the at least one actuator may be associated with a steering system and/or a braking system of the host vehicle. Examples of actuators may include subsystems that may be capable of causing the host vehicle to perform at least one navigational action. For example, upon updating the drivable trajectory of the host vehicle, an actuator associated with the steering system may promote a steering response resulting in a change in the lateral position of the host vehicle to align the host vehicle with a target trajectory.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer-readable media, such as secondary storage devices, for example, hard disks or CD ROM, or other forms of RAM or ROM, USB media, DVD, Blu-ray, 4K Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

The following clauses provide a description of various embodiments of the present disclosure:

Clause 1. A system for generating a map for use in navigating a host vehicle relative to a road segment, the system comprising: at least one processor comprising circuitry and a memory, wherein the memory includes instructions that when executed by the circuitry cause the at least one processor to: receive drive information from each of a plurality of vehicles that traversed the road segment, wherein the drive information includes indicators representative of road topography features associated with the road segment, and wherein the drive information also includes actual trajectory information including one or more indicators of an actual trajectory traveled by one or more of the plurality of vehicles; aggregate the indicators representative of road topography features and generate a representation of road topography of the road segment based on the aggregated indicators; provide the representation of road topography of the road segment as input to at least one trained model configured to generate, in response to the provided input, an output including a target trajectory for at least a first portion of the road segment; aggregate the actual trajectory information included in the drive information received from the plurality of vehicles that traversed the road segment; generate a crowdsourced trajectory for at least a second portion of the road segment based on the aggregated actual trajectory information; combine the target trajectory and the crowdsourced trajectory to generate a hybrid trajectory associated with the road segment; store the hybrid trajectory in the map; and provide the map to at least one host vehicle navigation system for use in navigating the host vehicle relative to the hybrid trajectory associated with the road segment.

Clause 2. The system of clause 1, wherein the first portion of the road segment and the second portion of the road segment overlap.

Clause 3. The system of clause 1, wherein the first portion of the road segment and the second portion of the road segment do not overlap.

Clause 4. The system of clause 1, wherein the first portion of the road segment and the second portion of the road segment both extend over a full length of the road segment.

Clause 5. The system of clause 1, wherein the hybrid trajectory maps a drivable path for a lane of travel associated with the road segment.

Clause 6. The system of clause 1, wherein the hybrid trajectory is generated by stitching together at least one portion of the target trajectory and at least one portion of the crowdsourced trajectory.

Clause 7. The system of clause 6, wherein the at least one portion of the target trajectory corresponds to a junction associated with the road segment, and the at least one portion of the crowdsourced trajectory corresponds to a non-junction region associated with the road segment.

Clause 8. The system of clause 6, wherein the at least one portion of the crowdsourced trajectory corresponds to a junction associated with the road segment, and the at least one portion of the target trajectory corresponds to a non-junction region associated with the road segment.

Clause 9. The system of clause 1, wherein the hybrid trajectory is generated by blending together at least one portion of the target trajectory and at least one portion of the crowdsourced trajectory, the at least one portion of the target trajectory and the at least one portion of the crowdsource trajectory both corresponding to a common sub-segment of the road segment.

Clause 10. The system of clause 9, wherein the blending includes applying a first predetermined weight relative to the at least one portion of the target trajectory and applying a second predetermined weight relative to the at least one portion of the crowdsourced trajectory.

Clause 11. The system of clause 10, wherein the first predetermined weight and the second predetermined weight are selected based on a structural feature associated with the road segment.

Clause 12. The system of clause 11, wherein the structural feature includes a junction, a roundabout, a curved road section, a straight road section, a lane merge zone, or a lane split zone.

Clause 13. The system of clause 11, wherein the structural feature corresponds to a junction, and wherein the first predetermined weight is greater than the second predetermined weight.

Clause 14. The system of clause 11, wherein the structural feature corresponds to a junction, and wherein the first predetermined weight is less than the second predetermined weight.

Clause 15. The system of clause 11, wherein the structural feature corresponds to a lane split, and wherein the first predetermined weight is less than the second predetermined weight.

Clause 16. The system of clause 1, wherein the representation of road topography of the road segment includes a top-view image representation of the road topography features.

Clause 17. A system for generating a map for use in navigating a host vehicle relative to a road segment, the system comprising: at least one processor comprising circuitry and a memory, wherein the memory includes instructions that when executed by the circuitry cause the at least one processor to: receive drive information from each of a plurality of vehicles that traversed a road segment, wherein the drive information includes indicators representative of road topography features associated with the road segment; aggregate the indicators representative of road topography features and generate a representation of road topography of the road segment based on the aggregated indicators; provide the representation of road topography of the road segment as input to at least one trained model configured to generate, in response to the provided input, an output including a target trajectory for the road segment; aggregate actual trajectory information included in the drive information received from each of the plurality of vehicles that traversed the road segment; generate a crowdsourced trajectory for the feature of road segment based on the aggregated actual trajectory information; store both the crowdsourced trajectory and target trajectory in in the map; and provide the map to at least one host vehicle navigation system for use in navigating the host vehicle relative to one or more of the target trajectory or the crowdsourced trajectory of the road segment.

Clause 18. The system of clause 17, wherein the crowdsourced trajectory and the target trajectory are both associated with a common length of a single lane of travel associated with the road segment.

Clause 19. The system of clause 18, wherein the single lane of travel extends within a junction.

Clause 20. The system of clause 18, wherein the single lane of travel extends within a roundabout.

Clause 21. The system of clause 18, wherein the single lane of travel extends within an inter-junction section of the road segment.

Clause 22. The system of clause 17, wherein the indicators representative of road topography features identify a feature type and a position associated with each of the road topography features.

Clause 23. The system of clause 22, wherein the feature type includes a lane marking.

Clause 24. The system of clause 22, wherein the feature type includes a road edge.

Clause 25. The system of clause 22, wherein the feature type includes at least one of a traffic sign, a traffic light, a lamp post, a building, a road barrier, or a speed bump.

Clause 26. The system of clause 22, wherein the position is identified as a three-dimensional, real-world position.

Clause 27. The system of clause 22, wherein the position is identified as a two-dimensional position relative to an image frame.

Clause 28. The system of clause 17, wherein the at least one trained model includes one or more trained neural networks.

Clause 29. The system of clause 17, wherein the road segment includes a plurality of lanes of travel, and wherein each lane of travel of the road segment is associated with a corresponding target trajectory and a corresponding crowdsourced trajectory.

Clause 30. The system of clause 17, wherein the road segment includes a junction associated with a plurality of navigable paths, and wherein each of the plurality of navigable paths is associated with a corresponding target trajectory and a corresponding crowdsourced trajectory.

Clause 31. The system of clause 17, wherein the aggregation of the indicators includes alignment of the received drive information received from the plurality of vehicles.

Clause 32. The system of clause 17, wherein the aggregation of the indicators includes determining refined positions associated with each of the road topography features.

Clause 33. The system of clause 17, wherein the representation of road topography of the road segment includes an image representation including a two-dimensional top view representation of the road topography of the road segment.

Clause 34. A navigation system for navigating a host vehicle relative to a road segment, the system comprising: at least one processor comprising circuitry and a memory, wherein the memory includes instructions that when executed by the circuitry cause the at least one processor to: receive a map associated with the road segment, wherein the map includes at least one target trajectory automatically generated based on analysis of at least one road topography feature associated with the road segment, and the map also includes at least one crowdsourced trajectory generated by aggregating actual trajectory information received from a plurality of vehicles that previously traversed the road segment; determine a navigational action for the host vehicle based on a combination of the at least one target trajectory and the at least one crowdsourced trajectory; and implement the navigational action by causing at least one actuator associated with host vehicle to activate.

Clause 35. The system of clause 34, wherein the at least one target trajectory and the at least one crowdsourced trajectory both correspond to a common section of a lane of travel along the road segment.

Clause 36. The system of clause 34, wherein the common section of the lane of travel extends within a roundabout.

Clause 37. The system of clause 34, wherein the common section of the lane of travel extends within a junction.

Clause 38. The system of clause 34, wherein the common section of the lane of travel extends within a lane split region.

Clause 39. The system of clause 34, wherein the common section of the lane of travel extends within a lane merge region.

Clause 40. The system of clause 34, wherein the at least one actuator is associated with a steering system of the host vehicle.

Clause 41. The system of clause 34, wherein determining the navigational action for the host vehicle based on a combination of the at least one target trajectory and the at least one crowdsourced trajectory includes applying a first weight to the at least one target trajectory and applying a second weight to the at least one crowdsourced trajectory.

Clause 42. The system of clause 41, wherein both the first weight and the second weight are non-zero.

Clause 43. The system of clause 41, wherein a magnitude of at least one of the first weight or the second weight is made to vary over time.

Clause 44. The system of clause 41, wherein a magnitude of at least one of the first weight or the second weight is made to vary relative to a distance along the road segment.

Clause 45. The system of clause 41, wherein a magnitude of at least one of the first weight or the second weight is determined based on user input.

Clause 46. The system of clause 41, wherein a magnitude of at least one of the first weight or the second weight is predetermined based on road feature type, and wherein a first road feature type is associated with a first weight that is higher than the second weight, and a second road feature type is associated with a first weight that is less than the second weight.

Clause 47. The system of clause 46, wherein the first road feature type is associated with a junction, and the second road feature type is associated with a road sub-segment leading to or extending away from the junction.

Clause 48. The system of clause 46, wherein the first road feature type is associated with a road sub-segment leading to or extending away from a lane merge, and the second road feature type is associated with the lane merge.

Clause 49. A system for generating a map for use in navigating a host vehicle relative to a road segment, the system comprising: at least one processor comprising circuitry and a memory, wherein the memory includes instructions that when executed by the circuitry cause the at least one processor to: identify an intersection between at least a first target trajectory and a second target trajectory associated with the road segment, wherein at least a first exit trajectory and a second exit trajectory extend from the intersection along respective directions of travel; automatically determine which of the at least a first exit trajectory and the second exit trajectory represents a stand-on trajectory relative to the intersection between the at least a first target trajectory and the second target trajectory; store in the map an identifier associated with the determined stand-on trajectory; provide the map to at least one host vehicle navigation system for use in navigating the host vehicle along the road segment and relative to the intersection between the at least a first target trajectory and the second target trajectory.

Clause 50. The system of clause 49, wherein the second target trajectory coincides with one of the at least a first exit trajectory and the second exit trajectory.

Clause 51. The system of clause 49, wherein the intersection between the at least a first target trajectory and the second target trajectory is associated with a roundabout, and the at least a first exit trajectory and a second exit trajectory include three or more exit trajectories extending from the intersection.

Clause 52. The system of clause 49, wherein each of the at least a first target trajectory and the second target trajectory are stored in the map as three-dimensional splines.

Clause 53. The system of clause 49, wherein each of the at least a first exit trajectory and the second exit trajectory are stored in the map as three-dimensional splines.

Clause 54. The system of clause 49, wherein each of the at least a first target trajectory and the second target trajectory are associated with lanes of travel along the road segment.

Clause 55. The system of clause 49, wherein each of the at least a first exit trajectory and the second exit trajectory are associated with lanes of travel along the road segment.

Clause 56. The system of clause 49, wherein the intersection between the at least a first target trajectory and the second target trajectory is associated with an exit lane junction associated with the road segment.

Clause 57. The system of clause 49, wherein the intersection between the at least a first target trajectory and the second target trajectory is associated with a lane split junction associated with the road segment.

Clause 58. The system of clause 49, wherein the intersection between the at least a first target trajectory and the second target trajectory is associated with a crossing junction associated with the road segment.

Clause 59. The system of clause 49, wherein the stand-on trajectory is determined based on aggregation of drive information collected from a plurality of vehicles that previously traversed the road segment.

Clause 60. The system of clause 49, wherein the stand-on trajectory is determined based on one or more geometric characteristics associated with the road segment.

Clause 61. The system of clause 49, wherein the stand-on trajectory is determined based on one or more geometric characteristics associated with the at least a first target trajectory and the second target trajectory.

Clause 62. The system of clause 49, wherein the stand-on trajectory is determined based on one or more geometric characteristics associated with the at least a first exit trajectory and the second exit trajectory.

Clause 63. The system of clause 49, wherein the stand-on trajectory is determined based on aggregation of drive information collected from a plurality of host vehicles that previously traversed the road segment.

Clause 64. The system of clause 49, wherein the identifier includes a stand-on tag associated with the stand-on trajectory.

Clause 65. The system of clause 49, wherein the stand-on trajectory is determined based on an output of at least one trained model.

Clause 66. The system of clause 49, wherein the memory includes instructions that when executed by the circuitry cause the at least one processor to: receive drive information from each of a plurality of vehicles that traversed the road segment, wherein the drive information includes indicators representative of road topography features associated with the road segment; aggregate the indicators representative of road topography features and generate a representation of road topography of the road segment based on the aggregated indicators; provide the representation of road topography of the road segment as input to at least one trained model configured to generate, in response to the provided input, an output including at least the first target trajectory, the second target trajectory, the first exit trajectory, and the second exit trajectory associated with the road segment; and store in the map at least the first target trajectory, the second target trajectory, the first exit trajectory, and the second exit trajectory associated with the road segment.

Clause 67. The system of clause 66, wherein the representation of road topography of the road segment includes a top-view image representation of the road topography features.

Clause 68. A navigation system for navigating a host vehicle relative to a road segment, the system comprising: at least one processor comprising circuitry and a memory, wherein the memory includes instructions that when executed by the circuitry cause the at least one processor to: receive a map associated with the road segment, wherein the map includes an intersection between at least a first target trajectory and a second target trajectory associated with the road segment, wherein at least a first exit trajectory and a second exit trajectory extend from the intersection along respective directions of travel, and wherein an identifier stored in the map designates one of the at least a first exit trajectory and the second exit trajectory as a stand-on trajectory; determine a navigational action for the host vehicle based on the stored identifier, wherein the navigational action is configured to cause the host vehicle to follow the stand-on trajectory after passing the intersection between the at least a first target trajectory and the second target trajectory; and implement the navigational action by causing at least one actuator associated with host vehicle to activate.

Clause 69. The system of clause 68, wherein the at least one actuator is associated with a steering system and/or a braking system of the host vehicle.

Clause 70. The system of clause 68, wherein each of the at least a first exit trajectory and the second exit trajectory are stored in the map as three-dimensional splines.

Clause 71. The system of clause 68, wherein at least the first target trajectory, the second target trajectory, the first exit trajectory, and the second exit trajectory associated with the road segment are generated by a trained model configured to receive a representation of road topography of the road segment as input and, in response, automatically generate at least the first target trajectory, the second target trajectory, the first exit trajectory, and the second exit trajectory associated with the road segment.

Clause 72. The system of clause 71, wherein the representation of road topography of the road segment is generated based on drive information received by a map server from each of a plurality of vehicles that previously traversed the road segment, wherein the drive information includes indicators representative of road topography features associated with the road segment and wherein the indicators representative of road topography features are aggregated to generate the representation of road topography of the road segment.

Clause 73. The system of clause 71, wherein the representation of road topography of the road segment includes a top-view image representation of the road topography features.

What is claimed is:

1. A system for generating a map for use in navigating a host vehicle relative to a road segment, the system comprising:
at least one processor comprising circuitry and a memory, wherein the memory includes instructions that when executed by the circuitry cause the at least one processor to:
receive drive information from each of a plurality of vehicles that traversed the road segment, wherein the drive information includes indicators representative of road topography features associated with the road segment, and wherein the drive information also includes actual trajectory information including one or more indicators of an actual trajectory traveled by one or more of the plurality of vehicles;
aggregate the indicators representative of road topography features and generate a representation of road topography of the road segment based on the aggregated indicators;
provide the representation of road topography of the road segment as input to at least one trained model configured to generate, in response to the provided input, an output including a target trajectory for at least a first portion of the road segment;
aggregate the actual trajectory information included in the drive information received from the plurality of vehicles that traversed the road segment;
generate a crowdsourced trajectory for at least a second portion of the road segment based on the aggregated actual trajectory information;
combine the target trajectory and the crowdsourced trajectory to generate a hybrid trajectory associated with the road segment;
store the hybrid trajectory in the map; and
provide the map to at least one host vehicle navigation system for use in navigating the host vehicle relative to the hybrid trajectory associated with the road segment.

2. The system of claim 1, wherein the hybrid trajectory maps a drivable path for a lane of travel associated with the road segment.

3. The system of claim 1, wherein the hybrid trajectory is generated by stitching together at least one portion of the target trajectory and at least one portion of the crowdsourced trajectory.

4. The system of claim 3, wherein the at least one portion of the target trajectory corresponds to a junction associated with the road segment, and the at least one portion of the crowdsourced trajectory corresponds to a non-junction region associated with the road segment.

5. The system of claim 3, wherein the at least one portion of the crowdsourced trajectory corresponds to a junction associated with the road segment, and the at least one portion of the target trajectory corresponds to a non-junction region associated with the road segment.

6. The system of claim 1, wherein the hybrid trajectory is generated by blending together at least one portion of the target trajectory and at least one portion of the crowdsourced trajectory, the at least one portion of the target trajectory and the at least one portion of the crowdsource trajectory both corresponding to a common sub-segment of the road segment.

7. The system of claim 6, wherein the blending includes applying a first predetermined weight relative to the at least one portion of the target trajectory and applying a second predetermined weight relative to the at least one portion of the crowdsourced trajectory.

8. The system of claim 7, wherein the first predetermined weight and the second predetermined weight are selected based on a structural feature associated with the road segment.

9. The system of claim 1, wherein the representation of road topography of the road segment includes a top-view image representation of the road topography features.

10. A system for generating a map for use in navigating a host vehicle relative to a road segment, the system comprising:
at least one processor comprising circuitry and a memory, wherein the memory includes instructions that when executed by the circuitry cause the at least one processor to:
receive drive information from each of a plurality of vehicles that traversed a road segment, wherein the drive information includes indicators representative of road topography features associated with the road segment;
aggregate the indicators representative of road topography features and generate a representation of road topography of the road segment based on the aggregated indicators;
provide the representation of road topography of the road segment as input to at least one trained model configured to generate, in response to the provided input, an output including a target trajectory for the road segment;
aggregate actual trajectory information included in the drive information received from each of the plurality of vehicles that traversed the road segment;
generate a crowdsourced trajectory for the feature of road segment based on the aggregated actual trajectory information;
store both the crowdsourced trajectory and target trajectory in in the map; and
provide the map to at least one host vehicle navigation system for use in navigating the host vehicle relative to one or more of the target trajectory or the crowdsourced trajectory of the road segment.

11. The system of claim 10, wherein the indicators representative of road topography features identify a feature type and a position associated with each of the road topography features.

12. The system of claim 11, wherein the feature type includes a lane marking or a road edge.

13. The system of claim 10, wherein the road segment includes a plurality of lanes of travel, and wherein each lane of travel of the road segment is associated with a corresponding target trajectory and a corresponding crowdsourced trajectory.

14. The system of claim 10, wherein the road segment includes a junction associated with a plurality of navigable paths, and wherein each of the plurality of navigable paths is associated with a corresponding target trajectory and a corresponding crowdsourced trajectory.

15. A navigation system for navigating a host vehicle relative to a road segment, the system comprising:
at least one processor comprising circuitry and a memory, wherein the memory includes instructions that when executed by the circuitry cause the at least one processor to:
receive a map associated with the road segment, wherein the map includes at least one target trajectory automatically generated based on analysis of at least one road topography feature associated with the road segment, and the map also includes at least one crowdsourced trajectory generated by aggregating actual trajectory information received from a plurality of vehicles that previously traversed the road segment;
determine a navigational action for the host vehicle based on a combination of the at least one target trajectory and the at least one crowdsourced trajectory; and
implement the navigational action by causing at least one actuator associated with host vehicle to activate.

16. The system of claim 15, wherein the at least one target trajectory and the at least one crowdsourced trajectory both correspond to a common section of a lane of travel along the road segment.

17. The system of claim 15, wherein determining the navigational action for the host vehicle based on a combination of the at least one target trajectory and the at least one crowdsourced trajectory includes applying a first weight to the at least one target trajectory and applying a second weight to the at least one crowdsourced trajectory.

18. The system of claim 17, wherein both the first weight and the second weight are non-zero.

19. The system of claim 17, wherein a magnitude of at least one of the first weight or the second weight is made to vary relative to a distance along the road segment.

20. The system of claim 17, wherein a magnitude of at least one of the first weight or the second weight is predetermined based on road feature type, and wherein a first road feature type is associated with a first weight that is higher than the second weight, and a second road feature type is associated with a first weight that is less than the second weight.
